(19) United States
(12) Patent Application Publication
(10) Pub. No.: US 2017/0103537 A1
(43) Pub. Date: Apr. 13, 2017

(54) DETERMINING IMAGE FEATURES FOR ANALYTICAL MODELS USING S-TRANSFORM

(71) Applicant: Mayo Foundation for Medical Education and Research, Rochester, MN (US)

(72) Inventors: Chun Hing Cheng, Calgary (CA); Joseph Ross Mitchell, Scottsdale, AZ (US)

(21) Appl. No.: 15/276,569

(22) Filed: Sep. 26, 2016

Related U.S. Application Data
(63) Continuation-in-part of application No. 14/360,299, filed on May 22, 2014.
(60) Provisional application No. 61/562,516, filed on Nov. 22, 2011.
(60) Provisional application No. 61/562,486, filed on Nov. 22, 2011.
(60) Provisional application No. 61/562,498, filed on Nov. 22, 2011.

(51) Int. Cl. G06T 7/11

(52) U.S. Cl. CPC G06T 7/11; G06T 5/10

(57) ABSTRACT

An image processing device and methods for performing an S-transform (ST) are provided herein. An example method of generating a compressed form of values of a one-dimensional ST for a time series and generating an approximate form of ST is provided herein. Additionally, an example method of determining local spectrum at a pixel is provided herein. Further, an example method of determining ST magnitudes and statistics in a region of interest (ROI) is provided herein.

### CROSS-REFERENCE TO RELATED APPLICATIONS

This application is a continuation-in-part of U.S. application Ser. No. 14/360,299, filed May 22, 2014, which is a National Stage application under 35 U.S.C. §371 of International Application No. PCT/US2012/066403, filed Nov. 21, 2012, which claims the benefit of U.S. Provisional Patent Application No. 61/562,516, filed on Nov. 22, 2011, entitled “FTFT-1D Patent Detailed Description,” and U.S. Provisional Patent Application No. 61/562,486, filed on Nov. 22, 2011, entitled “FTFT-2D Patent Detailed Description,” and U.S. Provisional Patent Application No. 61/562,498, filed on Nov. 22, 2011, entitled “FTFT-2D Patent Detailed Description,” the disclosures of which are expressly incorporated herein by reference in their entireties.

### BACKGROUND

The S-transform (ST) can be regarded as a hybrid of Gabor and continuous wavelet transforms, providing a “Time Frequency Representation” (TFR) of a signal by localizing with a Gaussian window that depends on the frequency. It has advantages over other TFR transforms, and its discrete 1D version has applications in signal processing, such as analysis of climatic, atmospheric and geophysical data, fault detection and diagnostics, exploration seismology, power system disturbance, as well as medical signals like ECG and EEG. In addition, its 2D extension is useful in image processing, such as analysis of medical images for differential diagnosis, also known as virtual biopsy.

Regarding 1D ST, there is a fast frequency-domain formula with complexity O(N² log N) that finds the entire set of discrete ST, but it is inefficient if only a single ST value (called “local spectrum”) at some selected time-point, or a set of local spectra over a time interval, is needed. Also, the storage complexity is O(N²), which is impractical when N is large.

There have been attempts for faster ST, but the attempts are mainly approximations or simplifications, finding a subset of ST values (usually with frequency being a negative power of 2 like ½, ¼, ⅛, . . . ), and interpolating for the missing ones. The interpolation, by spline or other ways, is time-consuming. Moreover, these attempts may incur large error for a time series whose prominent frequency does not belong to the subset, for example, a sinusoidal signal of frequency 0.3.

Similarly, regarding the 2D ST, in an Nₓ×N_{y} monochrome image, each pixel has a totality of NₓN_{y}/4 complex ST values. A fast frequency-domain formula takes O(NₓN_{y} log NₓN_{y}) time to find these values for a pixel. The time taken to find all ST values over a region of interest in a 256×256 medical image is very long, for example. There have been attempts of speeding it up but these attempts are mainly approximations or simplifications.

### SUMMARY

An image processing device and methods for performing an ST are provided herein. The ST is a TFR that is popularly used in a variety of applications, but prohibitive in both storage and computation for large data size. Provided herein are methods for performing a Fast Time Frequency Transform for 1-dimensional data (i.e., FTFT-1D), and 2-dimensional data (FTFT-2D). These can then used to construct Time Frequency Transforms that provide local spectra for a single pixel in an image (FTFT-2D pixel) and local spectra for an image region-of-interest (FTFT-2D ROI).

The 1D and 2D STs have been employed across multiple disciplines to solve technical problems in signal and image processing. Despite this, some STs have suffered from drawbacks that have limited their broader application, including: 1) significant storage requirements and 2) significant computation time. In some implementations, the techniques described herein can, in certain instances, allow for significant reductions in ST compute and storage requirements, with only a small (<1%) loss of accuracy.

For example, the ST is often used to analyze 1D time series data. The standard STs of 1,000 1D signals, each with 65536 samples, can, in some examples, consume upwards of 15 terabytes of storage. Calculation of a single local spectrum can take approximately 5 minutes per sample, or approximately 5,000 minutes (83 hours) in total. In some implementations, the techniques discussed herein, may in certain instances reduce the storage requirements of transformed signals relative to the conventional techniques. In one example, the storage requirements for the 1,000 transformed signals was reduced to just 139 gigabytes in some examples. Calculating a local spectrum can involve a one-time upfront calculation of a ‘basis’ function. After the basis function has been computed, each local spectrum may take, for example, 0.63 seconds to compute. Accordingly, computing the local spectrum for each of the 1,000 signals would take just 630 seconds.

For example, provided herein is a fast and accurate method to generate a highly compressed form of the values of ST directly, when N is so large that it is prohibitive to find and store the ST values first. For example, the method encodes the TRF information uniformly and so can then be used for analyzing the TRF correctly and processing the data efficiently and effectively. The compression can help storage, transmission and visualization of ST. Also provided herein is a method to find the values of ST at individual points, called local spectra, instantaneously and accurately. This is useful for real-time monitoring, control, manipulation and filtering. The methods provided herein are memory-efficient, robust and adaptive.

Also provided herein are fast and highly accurate methods to find the 2D ST magnitudes at each pixel in an image, called 2D Fast Time Frequency Transform (i.e., FTFT-2D Pixel). These methods do not strain memory requirements much and are robust for different medical images.

Additionally, provided herein are fast and highly accurate methods to compute the 2D ST magnitudes and their statistics for a region of interest (ROI) in an image or for the entire image, called 2D Fast Time Frequency Transform (i.e., FTFT-2D ROI). With the FTFT-2D Pixel algorithm above, it is possible to find the magnitude of the 2D ST, also called local spectrum, at each pixel in the image. In many applications, a user may not be interested in the spectral content at a single pixel, as it varies from one pixel to the next especially for high frequencies. Instead, the user may be more concerned with the spectral distribution and statistics over an ROI in the image. To obtain the spectral distribution and statistics over an ROI, the local spectrum is individually found for each pixel in the image and then accumulated to obtain the statistics. The FTFT-2D ROI methods discussed herein make this computation more efficient. For example, the matrix multiplication for the pixels in the ROI is made more efficient by first computing a set of left matrices for the x coordinates or a set of right matrices for the y coordinates. Additionally, the ST magnitudes at low frequencies measure the global spectral information and so do not change much, especially where the high frequency content is small.

An example method of generating a compressed form of values of a one-dimensional S-transform (ST) for a time series in an image processing device and generating an approximate form of ST is provided herein (i.e., FTFT-1D). For example, the method can include setting primary parameters, setting a data size N, determining basis values for the data size N and inputting a time series of data size N. The method can also include determining a set of prominent frequency indexes, expanding and accumulating the basis values for pure complex sinusoids (PCS) with frequencies in the set of prominent frequency indexes to form compressed ST values using the primary parameters, decompressing accumulated basis values for a high set and copying the ST values for a low set.

An example method of determining local spectrum at a pixel in an image processing device is provided herein (i.e., FTFT-2D Pixel). The method can include setting parameters, receiving an input image, determining a low band, a medium band and a high band of frequency components and preparing basis values for each of the low band, the medium band and the high band. The method can further include determining a two-dimensional Fourier Transform (FT) of the image as a matrix H, receiving an input coordinate of the pixel and determining S-transform (ST) magnitudes at the input coordinate of the pixel using the matrix H and the basis values. The ST magnitudes of an image are useful for multiple practical applications across many fields, including analysis of faults in seismograms and analysis of texture in medical images.

An example method of determining S-transform (ST) magnitudes and statistics in a region of interest (ROI) in an image processing device is provided herein (FTFT-2D ROI). The method can include setting parameters, receiving an input image, determining a low band, a medium band and a high band of frequency components and preparing basis values for each of the low band, the medium band and the high band. The method can further include determining a two-dimensional Fourier Transform (FT) of the image as a matrix H, receiving an indication of the region on interest (ROI) and determining the S-transform (ST) magnitudes and the statistics in the ROI using the matrix H and the basis values.

Some implementations of the subject matter described herein include a computer-implemented method. The method may be performed by a system of one or more computers in one or more locations. The method includes obtaining a first digital image; determining values for a set of features of the first digital image; generating a sample of training data that associates the determined values for the set of features in the first digital image with an observed condition of a subject of the first digital image; training, based on the sample of training data and one or more other samples of training data, a model that is configured to estimate a condition of a subject of a digital image; and using the model to estimate the condition of a subject of a second digital image that is different from the first digital image.

These and other implementations can optionally include one or more of the following features.

The system can determine the values for the set of features of the first digital image by performing a first image processing procedure, a second image processing procedure, or a third image processing procedure. The first, second, and third image processing procedures, and variants thereof, are described in further detail in this document in following paragraphs.

Using the model to estimate the condition of the subject of the second digital image can include determining values for a set of features of the first digital image and processing the determined values for the set of features of the second digital image with the model.

The subject of the first digital image can be a lesion and the condition of the subject can be its clinical status, for example, malignant or benign. Thus, a model could be trained to estimate the clinical status of a lesion shown in an image by creating training samples that associate image features derived using the image processing techniques discussed herein with the observed clinical statuses of lesions shown in the images. The observed clinical status may be labelled by a user and is accepted as a true condition of the lesion for purpose of training the model. In another example, the condition of the subject (e.g., lesion) could be, for example, the relative abundance of tumor cells in the subject (e.g., lesion). Furthermore, the condition of the subject could be its relationship to a clinical variable with prognostic value. For example, the subject shown in an image could be an anatomical structure such as the hippocampus. The clinical variable could be the patient's cognitive status as measured using a neurological scale such as the Clinical Dementia Rating scale. The features of the digital images could be used to correlate the imaging aspects of the subject with scores on the clinical scale, to provide a non-invasive assessment of cognitive status.

The model can be a machine-learning model (e.g., a neural network), a classifier, a Hidden Markov Model (HMM), a support vector machine (SVM), a diagonal linear discriminate analyzer (DLDA), a diagonal quadratic discriminate analyzer (DQDA), or a combination of these.

One or more computer-readable media may store instructions thereon that, when executed by one or more processors, cause the one or more processors to perform any of the computer-implemented methods described herein.

Some implementations of the subject matter described herein include a computer-implemented method. The method may be performed by a system of one or more computers in one or more locations. The method includes obtaining a first digital image; determining values for a set of features of the first digital image; providing, to a model, the determined values for the set of features of the first digital image to estimate a condition of a subject shown in the image; and presenting an indication of the estimated condition of the subject shown in the image.

These and other implementations can optionally include one or more of the following features.

The system can determine the values for the set of features of the first digital image by performing a first image processing procedure, a second image processing procedure, or a third image processing procedure. The first, second, and third image processing procedures, and variants thereof, are described in further detail in this document in following paragraphs.

Presenting the indication of the estimated condition of the subject shown in the image can include displaying the indication visually on an electronic screen, playing the indication aurally via one or more speakers, or both.

Some implementations of the subject matter described herein include a computer-implemented method. The method may be performed by a system of one or more computers in one or more locations. The method can include displaying, on a terminal of the system, a first digital image; receiving a selection of a pixel or a region of interest comprising multiple pixels in the first digital image; determining one or more values that characterize the selected pixel or region of interest; and providing an indication of the determined values that characterize the selected pixel or region of interest.

These and other implementations can optionally include one or more of the following features.

The system can determine the values that characterize the selected pixel or region of interest by performing a first image processing procedure, a second image processing procedure, or a third image processing procedure. The first, second, and third image processing procedures, and variants thereof, are described in further detail in this document in following paragraphs.

The system may receive the selection of the pixel or the region of interest based on input provided by a user of the system, e.g., a selection of the pixel with a mouse or other pointing device from the display of the first digital image.

Providing the indication of the estimated condition of the subject shown in the image can include displaying the indication visually on the terminal, playing the indication aurally via one or more speakers, or both.

First Image Processing Procedure

In some implementations, the first image processing procedure includes generating a compressed form of values of a one-dimensional S-transform (ST) for a time series and generating an approximate form of ST. The procedure can include setting primary parameters, setting a data size N, determining basis values for the data size N, inputting a time series of data size N, determining a set of prominent frequency indexes, expanding and accumulating the basis values for pure complex sinusoids (PCS) with frequencies in the set of prominent frequency indexes to form compressed ST values using the primary parameters, decompressing the accumulated basis values for a high set, and copying the ST values for a low set. In some implementations, all or some of the ST values for the low set can be selected as feature values for training or evaluating a model.

The first image processing procedure can optionally include one or more of the following features.

The procedure can further include retrieving essential basis values from a basis file.

The procedure can further include preparing the essential basis values for the data size N; and saving the essential basis values in the basis file.

Determining the basis values can further include determining support intervals for each pure complex sinusoid; determining a range of PCS, the range being for ST values for values of frequency index k=0 through N/2−1; identifying a low set of PCS with a relatively small frequency index q, wherein the ST are copied into the basis; identifying a high set of PCS with a relatively large frequency index q, wherein the Offset TT-Transform (OTT) are used in the basis; determining crop limits for each pure complex sinusoid in the high set; identifying basis nodes for each pure complex sinusoid in the high set; subsampling along a time axis; and determining basis values for each pure complex sinusoid in the high set and the low set.

Subsampling along the time axis can further include subsampling by a time interval; subsampling by symmetry, only determining the ST and OTT values for n≦N/2; and subsampling by periodicity, wherein the OTT values are periodic in n with period N/q for the frequency index q in the high set.

The procedure can further include setting secondary parameters for the time series.

The procedure can further include expanding and accumulating the basis values for each time index n.

The procedure can further include determining basis values for each time series; and accumulating basis values for each time series.

The procedure can further include expanding and accumulating the basis values for a predetermined time index n.

The procedure can further include determining the basis values at the time index n; and accumulating basis values at the time index n.

Second Image Processing Procedure

In some implementations, the second image processing procedure includes determining local spectrum at a pixel of an input image. The input image can be a first digital image whose features are derived for training a model or a second input image whose features are derived to estimate a condition of a subject. The procedure can include setting parameters; receiving the input image; determining a low band, a medium band and a high band of frequency components; preparing basis values for each of the low band, the medium band and the high band; determining a two-dimensional Fourier Transform (FT) of the image as a matrix H; receiving an input coordinate of the pixel; and determining S-transform (ST) magnitudes at the input coordinate of the pixel using the matrix H and the basis values. In some implementations, all or some of the ST magnitudes at the input coordinate of the pixel can be selected as feature values for training or evaluating a model. In some implementations, ST magnitudes derived according to the second image processing procedure for one or more additional pixels of the input image can also be used as feature values for training or evaluating the model. In some implementations, ST magnitudes derived for multiple pixels may be combined to generate feature values for training or evaluating the model.

The second image processing procedure can optionally include one or more of the following features.

The procedure can include, if the width Nx and height Ny of the input image are not both equal to N, wherein N is a power of 2, then determine a smallest integer M such that Nx≦2M and Ny≦2M; set N=2M; and adjust a size of the input image by expanding the input image into an N×N image by optimized Hanning window.

Preparing basis values for each of the low band, the medium band, and the high band can further include determining support intervals for each pure complex sinusoid; determining a range of PCS, the range being for ST values for values of frequency index k=0 through N/2−1; identifying a low set of PCS with a relatively small frequency index q, wherein the ST are copied into the basis; identifying a medium set of PCS with a frequency index between the relatively small frequency index q of the low set of PCS and a relatively large frequency index q, wherein the Offset TT-Transform (OTT) are used in the basis; determining crop limits for each pure complex sinusoid in the medium set; identifying basis nodes for each pure complex sinusoid in the medium set; identifying a high set of PCS with the relatively large frequency index q, wherein the Offset TT-Transform (OTT) are used in the basis; determining crop limits for each pure complex sinusoid in the high set; identifying basis nodes for each pure complex sinusoid in the high set; subsampling along a time axis; and determining basis values for each pure complex sinusoid in the high set, the medium set and the low set.

Determining the ST magnitudes can further include multiplying a matrix of basis values for N to the matrix H on the left to form an intermediate matrix product; and multiplying a transpose of matrix of basis values for N to the intermediate matrix on the right to form a matrix product of compressed ST magnitudes for the pixel.

Determining the ST magnitudes can further include interpolating the matrix of compressed ST values along an x direction; and interpolating a result along a y direction to obtain a matrix of semi-compressed ST values for the pixel.

Determining the ST magnitudes can further include decompressing the matrix of semi-compressed ST values for the pixel along the x direction; and decompressing a result along the y direction to obtain a matrix of the ST values at the input coordinate.

The procedure can further include performing a 2D Fourier Transform for the medium band and the high band; and copying ST values for the low band.

Third Image Processing Procedure

In some implementations, the third image processing procedure includes determining S-transform (ST) magnitudes and statistics in a region-of-interest (ROI). The procedure can include setting parameters; receiving an input image; determining a low band, a medium band and a high band of frequency components; preparing basis values for each of the low band, the medium band and the high band; determining a two-dimensional Fourier Transform (FT) of the image as a matrix H; receiving an indication of the region on interest (ROI); and determining the S-transform (ST) magnitudes and the statistics in the ROI using the matrix H and the basis values. In some implementations, the ST magnitudes, the statistics in the ROI, or both can be selected as the feature values for training or evaluating a model. In some implementations, ST magnitudes and/or statistics from multiple ROIs in the same or different images can be selected as the feature values for training or evaluating the model.

The third image processing procedure can optionally include one or more of the following features.

The procedure can further include, if the width Nx and height Ny of the input image are not both equal to N, wherein N is a power of 2, then: determine a smallest integer M such that Nx≦2M and Ny≦2M; set N=2M; and adjust a size of the input image by expanding the input image into an N×N image by optimized Hanning window.

Determining the ST magnitudes can further include determining a bounding rectangle of the ROI.

If an x-length of the ROI is greater than a y-length, then the procedure can further include: forming an intermediate matrix product for all ix in an x-projection of the ROI; traversing a pixel tree; and for each node P(ix, iy), if it is in the ROI and not computed before, then multiplying a matrix of basis values for iy to the intermediate matrix product on the right to form a matrix of compressed ST values for the pixel.

If an x-length of the ROI is not greater than a y-length, then the procedure can further include: forming an intermediate matrix product for all iy in a y-projection of the ROI; traversing a pixel tree; and for each node P(ix, iy), if it is in the ROI and not computed before, then multiplying a matrix basis values for iy to the intermediate matrix product on the left to form a matrix of compressed ST values for the pixel.

Determining ST in the ROI further can further include determining a local spectrum at each pixel (ix, iy) in the ROI.

Determining ST in the ROI further can include augmenting weights and updating statistics.

The procedure can further include selecting a skipping strategy to skip computing predetermined ones of the ST values. The procedure can further include building a forest of quad-trees with two levels; selecting pixels at every other x position and every other y position; for a first two leaves of each tree, corresponding to a pair of diagonally opposite pixels, computing ST values for the low band, the medium band and the high band; determining an upper-difference between ST values of these two pixels at each (kx, ky) in an upper quadrant of a 2D frequency index space; and if the upper-difference is less than a predetermined threshold, skipping computing ST values in the low band, the medium band and the high band for other two leaves in that tree.

The procedure can further include determining low band ST values for each 2×2 square of the ROI; and skipping determining the ST values for the medium band and the high band if a predetermined selection of high band ST magnitude is less than a threshold.

The procedure can further include determining low band ST values for each 4×4 square of the ROI; determining medium band ST values for each 2×2 square of the ROI; building a forest of quad-trees having three levels, wherein at a top level, every fourth x position and every fourth y position is selected; traversing children from a selected x position and y position; and determining a ST value of a pixel in accordance with: if that node is the top level of the tree, then determine its ST values for the low band, the medium band and the high band; if that node is in a middle level, then determine the ST values for the medium band and the high band; and if that node is in a lower level, then determine ST values for the high band.

The procedure can further include performing an automatic selection of a skipping strategy.

The procedure can further include applying a weight to the ST values.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIGS. 1A-G are diagrams illustrating the various ST, S^{C}, TT and Offset TT-Transform (OTT) values for a multi-sinusoid example;

FIGS. 2A-2B are flow diagrams illustrating example operations for generating a compressed form of values of a one-dimensional ST for a time series and generating an approximate form of ST (i.e., FTFT-1D methods for ST);

FIG. 3 illustrates exact and decompressed compressed ST values according to experimental results;

FIGS. 4A-G are graphs illustrating accuracy (for magnitude and phases) for ST by FTFT-1D methods provided herein as compared to exact ST;

FIGS. 4H-K are graphs illustrating accuracy for ST by FTFT-1D methods provided herein as compared to exact ST;

FIGS. 5A-G are diagrams illustrating the various ST, TT and OTT values for a random time series or signal h[n];

FIGS. 6A-6B are flow diagrams illustrating example operations for obtaining 2D ST magnitudes at each pixel in an image (i.e., FTFT-2D Pixel methods for ST);

FIG. 7 is a flow diagram illustrating the FTFT-2D Pixel algorithm discussed herein;

FIGS. 8A-E are graphs illustrating results of ST by FTFT-2D Pixel methods provided herein as compared to exact ST;

FIGS. 9A-9B are flow diagrams illustrating example operations for obtaining magnitudes and their statistics for a region of interest (ROI) in an image;

FIGS. 10A-B are diagrams illustrating an example general-shaped ROI for skipping strategies discussed herein;

FIGS. 11A-B are diagrams illustrating another example general-shaped ROI for skipping strategies discussed herein;

FIG. 12 is a diagram illustrating a hierarchical structure for an example skipping strategy discussed herein;

FIGS. 13-15 illustrate pseudo-code for implementing skipping strategies discussed herein;

FIGS. 16A-E are graphs illustrating results of ST by FTFT-2D ROI methods provided herein as compared to exact ST;

FIGS. 17A-E are graphs illustrating results of ST by FTFT-2D ROI methods provided herein as compared to exact ST; and

FIG. 18 is a block diagram of an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. While implementations will be described for performing an S-transform in the context of performing image processing techniques, it will become evident to those skilled in the art that the implementations are not limited thereto, but are applicable to other types of signal processing, such as analysis of climatic, atmospheric and geophysical data, fault detection and diagnostics, exploration seismology, power system disturbance, as well as medical signals like ECG and EEG.

Provided herein is a fast and accurate method to generate a highly compressed form of ST directly (without the need to find the ST values first). The compression reduces the original size of O(N²) to O(N log N). It encodes the TRF information uniformly and so can then be used for analyzing the TRF correctly and processing the data efficiently and effectively. The compression can help storage and transmission of ST.

Additionally, provided herein is a method to decompress the compressed values to generate the ST values for the entire series for visualization, analysis or process (e.g. filtering). If N is too large for all the ST values to be held in memory, the ST values can be saved in auxiliary storage as they are being generated, or discard an ST value immediately after it has been used.

Alternatively or additionally, provided herein is a method to visualize, analyze or process the local spectrum of ST at a single time. For example, it is possible to find the ST at individual points instantaneously and accurately by generating directly the compressed form of the local spectrum at the desired time only and then decompressing it to obtain the local spectrum there. This is useful for real-time monitoring, control, manipulation and filtering.

FTFT-1D

Definition of Transforms

Fourier Transform

The 1-dimensional discrete Fourier Transform (FT) of a (complex) time series h[n] of size N is a “Frequency Representation” and is shown in (1) below.

$$H [ k ] = \frac{1}{N} {\sum }_{n = 0}^{N - 1} h [ n ] {e}^{- i 2 π kn / N} , \qquad ( 1 )$$

where h[n]=h(nI) and H[k]=H(k/NI), I is the sampling interval and n, k are the time and frequency indices respectively. As used herein, [ ] denotes discrete functions of integers, while ( ) denotes continuous functions of real or complex numbers. Additionally, the term “time series” is used herein and is intended to encompass a “signal”.

The 1-dimensional Inverse discrete Fourier Transform (IFT) is shown in (2) below.

$$h [ n ] = {\sum }_{k = 0}^{N - 1} H [ k ] {e}^{i 2 π kn / N} , \qquad ( 2 )$$

where h[n]=h(nI) and H[k]=H(k/NI), I is the sampling interval and n, k are the time and frequency indices respectively. It should be understood that FT and IFT can be computed efficiently by Fast Fourier Transform (FFT), which is especially fast for the radix-2 case where N is a power of 2.

S-Transform

The 1-dimensional Continuous S-Transform of a (complex) function of time h(t) is a joint function of time t and frequency f and is shown in (3) below.

$$S ( t , f ) = {\int }_{- ∞}^{∞} h ( τ ) \frac{\vert f \vert}{\sqrt{2 π}} {e}^{- \frac{{{f}^{2} ( τ - t )}^{2}}{2}} {e}^{- i 2 π f τ} d τ \qquad ( 3 )$$

The 1-dimensional Continuous S-Transform can be regarded as a hybrid of Gabor Transform and Wavelet Transform, depending on near neighbours for high frequencies, and far ones for low frequencies.

The 1-dimensional discrete S-Transform (ST) is given by the frequency-domain formula shown in (4) below.

$$S [ n , k ] = \{ \begin{matrix}S ( nI , \frac{k}{NI} ) = {\sum }_{κ = - N / 2}^{N / 2 - 1} H [ κ + k ] {e}^{- 2 {π}^{2} {κ}^{2} / {k}^{2}} {e}^{i 2 π κ n / N} & if k \neq 0 \\ \frac{1}{N} {\sum }_{j = 0}^{N - 1} h [ j ] & if k = 0\end{matrix} , \qquad ( 4 )$$

where n and k go from 0 to N−1. This is different in the summation endpoints in the frequency-domain formula, where the summation goes from N−1. Better results can be obtained by summing from −N/2 to N/2−1. It should be understood that the upper equation in (4) is for the non-zero voice, with time complexity of O(N² log N) because the summation is actually an IFT, which can be found by FFT in O(N log N). Additionally, the lower equation in (4) provides that the zero voice S[n, 0] is simply the mean intensity.

Although FFT is relatively fast, (4) is only useful in finding all the ST for n=0, . . . , N−1. However, even using FFT, (4) is slower than the methods discussed below. Additionally, (4) is inefficient in finding a single local spectrum at some n, or a few a few local spectra. In practice, by Nyquist Theorem, it may only be necessary to find ST for frequency f from 0 to ½, i.e., for k=0, 1, . . . N/2−1. Thus, it takes O(N²) to hold the entire set of ST.

If the time series h[n] is real, then FT satisfies the conjugate symmetry property: H[N−k]=H̅[̅k̅]̅. But this does not hold for ST. Thus, a variant of ST, called the conjugate-symmetric ST and written S^{C}, which is useful in improving the storage and computation efficiencies, is shown below in (5).

$${S}^{C} [ n , k ] = \{ \begin{matrix}S [ n , k ] & if 0 \leq k < \frac{N}{2} \\ Re ( S [ n , \frac{N}{2} ] ) & if k = \frac{N}{2} \\ \overline{S [ n , N - k ]} & if \frac{N}{2} < k < N\end{matrix} , \qquad ( 5 )$$

for k=0, 1, . . . , N−1. As discussed herein, Re( ) denotes the real part and over-line (i.e., S̅[̅n̅,̅N̅−̅k̅]̅) denotes the complex conjugate. Thus, S^{C} satisfies the conjugate symmetry property, with real IFT.

TT-Transform

The TT-transform (TT) is the IFT of ST. In the continuous case, it is shown in (6) below.

T(t,τ)=∫₋₂₈ ^{∞}S(t,f)e^{i2πfτ}df (6)

One of ordinary skill would understand that there are many ways to discretize the TT. One example discrete TT, which is called T¹ herein, has summation endpoints symmetric about 0 and is shown in (7) below.

$${T}^{1} [ n , m ] = T ( nI , mI ) = {\sum }_{k = - N / 2}^{N / 2 - 1} S [ n , k ] {e}^{i 2 π k m / N} , \qquad ( 7 )$$

where each of n, m is the time index going from 0 to N−1.

Additional discretization strategies for TT-transform are discussed below. For example, T² differs from the T¹ of (7) in the summation endpoints and is shown below in (8).

$${T}^{2} [ n , m ] = {\sum }_{k = 0}^{N - 1} S [ n , k ] {e}^{i 2 π k m / N} . \qquad ( 8 )$$

T² is preferred as to T¹ because its FT will bring back the original ST values as the endpoints are the standard 0 and N−1. Additionally, as discussed below, T² actually gives more accurate results for ST than the other forms.

T³, which is shown below in (9), is the IFT of S^{C}.

$${T}^{3} [ n , m ] = {\sum }_{k = 0}^{N - 1} {S}^{C} [ n , k ] {e}^{i 2 π k m / N} . \qquad ( 9 )$$

As discussed above, S^{C} satisfies the conjugate symmetry property, hence its IFT, T³[n,m], is real for all m=0, 1, . . . , N−1.

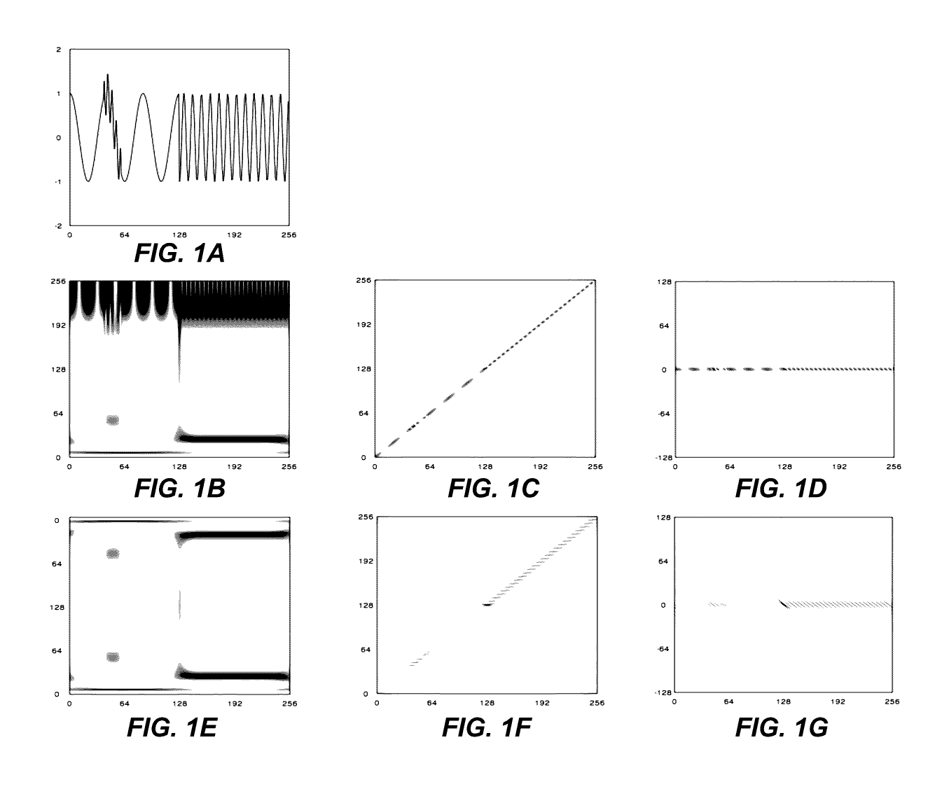

Referring now to FIGS. 1(a)-1(g), diagrams illustrating the various ST, S^{C}, TT and Offset TT-Transform (OTT) values for a multi-sinusoid example are shown. The diagrams only show the magnitude of the complex ST values, all in the same grey scaling. S^{C} is clearly symmetric about k=N/2, since the conjugate symmetry of complex number translates into symmetry of the magnitude. Additionally, only the magnitude of the complex TT and OTT values are shown. Because only T², O² and T³, O³ are discussed herein, their values are only shown. For example, FIG. 1(a) illustrates the multi-sinusoid signal h[n] given by:

$$h [ n ] = \{ \begin{matrix}cos ( 2 π \frac{6}{256} n ) & if n < 40 or 60 < n < 128 \\ cos ( 2 π \frac{25}{256} n ) & if n \geq 128 \\ cos ( 2 π \frac{6}{256} n ) + cos ( 2 π \frac{52}{256} n ) & if 40 \leq π \leq 60\end{matrix}$$

FIG. 1(b) illustrates the magnitude of the ST of the signal, with frequency index k along the vertical axis. (White=0, Black=0.5). FIGS. 1(c) and (d) show the magnitude of T², O², with m along the vertical axis. (White=0, Black=64). FIG. 1(e) illustrates the magnitude of the conjugate-symmetric ST, S^{C}, of the signal. (White=0, Black=0.5). FIGS. 1(f) and (g) illustrate the magnitude of T³, O³, (White=0, Black=25).

As shown in FIGS. 1(c) and (f), wrapping occurs in the TT of the signal. Oscillatory behaviour is also present in FIGS. 1(f) and (g), which illustrate T³, O³, respectively. For example, FIGS. 1(c) and (f) illustrate that the TT values are concentrated along the diagonal m=n, attenuating moving away from it. These characteristics are discussed in further detail below. There is also the wrapping effect, as manifested near the top left and bottom right corners. This comes from: TT[n, m+N]=TT[n, m]. The wrapping imposes some burden and overhead in the coding and execution of the methods discussed herein.

To eliminate the wrapping and to offset the vertical shift of distance n at time index n, it is possible to use the displaced forms of T² and T³, called Offset TT-transform (OTT) and denoted by O² and O³, which are shown in (10) and (11) below.

O²[n, m]=T²[n,(m+n+N)mod N], (10)

and

O³[n,m]=T³[n,(m+n+N)mod N], (11

where m goes from −N/2 to N/2−1. Then these OTT will cluster around the horizontal line m=0, without the wrapping problem, as shown in FIGS. 1(d) and (g). O³[n, m] also carries the nice property of T³[n, m], being real for all m.

Pure Complex Sinusoids

A complex sinusoid of frequency f, magnitude A and phase θ is a periodic function of time t:

u_{f,A,θ}(t)=Ae^{i(2πft+θ)}=A(cos(2πft+θ)+i sin(2πft+θ)).

If A is unity and θ is zero, it is a Pure Complex Sinusoid (PCS) of frequency f. In the discrete case, the PCS of frequency index q (with q=0, 1, . . . , N 1) is defined as a time series in time index n:

$${u}_{q} [ n ] = {e}^{i2π qn / N} = cos ( \frac{2 πqn}{N} ) + isin ( \frac{2 πqn}{N} ) ,$$

for n=0,1, . . . , N−1.

The formula for the IFT shown in (2) can be written in terms of PCS, which is shown in (12) below.

$$h [ n ] = {\sum }_{q = 0}^{N - 1} H [ q ] {u}_{q} [ n ] . \qquad ( 12 )$$

Fourier Transform of Pure Complex Sinusoid

The FT of a PCS of frequency index q is equal to the Kronecker delta, which is shown by (13) below.

$${U}_{q} [ k ] = {δ}_{q , k} = \{ \begin{matrix}1 if k = q \\ 0 if k \neq q\end{matrix} , \qquad ( 13 )$$

where q and k range from 0 to N−1. (14) below shows the case when q or k take values outside the above range.

$${U}_{q} [ k ] = \{ \begin{matrix}1 if k = q + j N for some j ∈ Z \\ 0 otherwise\end{matrix} , \qquad ( 14 )$$

where Z is the set of integers.

S-Transform of Pure Complex Sinusoid

The ST of a PCS of frequency index q, written as S_{q}[n, k], can be computed by the frequency-domain formula shown in (4) and is shown below in (15).

$${S}_{q} [ n , k ] = {\sum }_{κ = - N / 2}^{N / 2 - 1} {U}_{q} [ κ + k ] {e}^{- 2 {π}^{2} {κ}^{2} / {k}^{2}} {e}^{i2πκ n / N} \qquad ( 15 )$$

By (13), only the term with κ+k=q, i.e., κ=q−k, is non-zero in the summation. Thus, (15) becomes (16) below.

S_{q}[n,k]=e^{-2π}^{₂}^{(q-k)}^{₂}^{/k}^{₂}e^{i2π(q-k)}n/N (16)

However, there is a problem with (16) if (4) is strictly sued: κ ranges from −N/2 to N/2−1 in the summation, but in the methods discussed below, q will go from 0 to some number greater than N/2, and k from 0 to N/2−1. So, κ=q−k may not always hold, e.g. when k is N/4 and q is 3N/4. Therefore, the more general (14) can be used to get a more correct form of (16), which is shown below as (17).

$${S}_{q} [ n , k ] = \{ \begin{matrix}{e}^{- 2 {{π}^{2} ( q - k )}^{2} / {k}^{2}} {e}^{i2π ( q - k ) n / N} & if k - \frac{N}{2} \leq q \leq k + \frac{N}{2} - 1 \\ {e}^{- 2 {{π}^{2} ( q - k - N )}^{2} / {k}^{2}} {e}^{i2π ( q - k ) n / N} & if k + \frac{N}{2} \leq q \leq k + \frac{3 N}{2} - 1\end{matrix} \qquad ( 17 )$$

The second alternative of (17) sets κ=q−k−N to ensure that κ=q−k lies within the summation range. It is possible to put q as the subject of the if-clause, because q will be varied for a given k in the methods discussed below. But, (17) is inconvenient to use. However, when q≧k+N/2 in the second alternative of (17), the expressions shown in (18) and (19) below result.

(q−k)²/k²>(N/2)²/k²>1 (18)

because k is less than N/2, and

(q−k−N)²/k²=(k+N−q)²/k²>1 (19)

because q<N. Hence, the expression in (17) for the two alternatives are small, and it is possible to use (16) at all times.

ST is linear, in the sense that given a number of time series, the ST of their linear combination is equal to the linear combination of their ST. So, by (12), the ST of the IFT in terms of the PCS is shown in (20) below.

$$S [ n , k ] = ST of h [ n ] = ST of {\sum }_{q = 0}^{N - 1} H [ q ] {u}_{q} [ n ] = {\sum }_{q = 0}^{N - 1} H [ q ] ( ST of {u}_{q} [ n ] ) = {\sum }_{q = 0}^{N - 1} H [ q ] {S}_{q} [ n , k ] , \qquad ( 20 )$$

showing that the set of S _{q}[n, k] with q=0, 1, . . . , N−1 is a basis for any ST.

Properties of S-Transform of Pure Complex Sinusoid

Provided below are properties of the ST of PCS that are useful in the methods discussed below.

Periodic:

For a given k the magnitude of S_{q}[n,k], written as f[k], is: e^{-2π}^{²}^{(q-k)}^{²}^{/k}^{²}. It is independent of time index n. For fixed q and k, the phase of S_{q}[n, k] is periodic in n with period N/(q−k). Note that the period is generally a non-integer as q−k may not divide into N exactly.

Gaussian:

For a fixed q, f[k], is bell-shaped, and looks like a Gaussian with SD=q/2π. To prove it, note that f[k] has a single maximum at k=q, and is small when k is far from q. The graph of (q−k)/k against k is a hyperbola cutting the k axis at k=q with slope −1/q. So the straight-line graph of (q−k)/q is tangential to it. This implies that f[k] and e^{2π}^{²}^{(q k)}^{²}^{/q}^{²} are close to each other when k is near q. Now, the latter exponential is a Gaussian function with SD=q/2π. It is therefore possible to conclude that f[k] is close to that Gaussian function near q and is small away from q. Thus, this characteristic can be called “near-Gaussian”.

The multi-sinusoid example discussed with regard to FIGS. 1(a)-(g) includes two PCS's, one of frequency 6/256 between n=64 and n=128, and the other of frequency 25/256 from n=128 onwards. As shown in FIGS. 1(a)-(g), the ST diagrams have large ST magnitudes around a narrow band around k=6 and around a wider band around k=25, respectively.

Symmetry:

For fixed q and m, S_{q}[n, k] is conjugate-symmetric about n=N/2. This is obvious from the fact that (16) becomes its conjugate when n is replaced by N−n.

Support Interval:

Given a small positive number ε, the “support interval” for ε, defined as {k: f[k]≧ε}, is bounded below by l_{q} and above by u_{q}, where (21) below defines l_{q} and u_{q}.

l_{q}=q/(1+α)

and

u_{q}=q/(1−α) (21)

and α=\sqrt{−log ε/2π²}. This can be proved easily. For the upper bound to be positive, ε need be greater than e^{-2π}^{²}=2.7×10⁻⁹. The width of this support interval is proportional to q. This agrees with the Gaussian property discussed above, as the standard deviation (“SD”) of Gaussian measures the width of the bell.

TT-Transform of Pure Complex Sinusoid

As discussed above, T² and T³ are provided by (8) and (9). Thus, the respective TT of a PCS of frequency index q are denoted by T_{q}²[n,m] and T_{q}³[n,m]. According to (8):

$${T}_{q}^{2} [ n , m ] = {\sum }_{k = 0}^{N - 1} {S}_{q} [ n , k ] {e}^{i2π km / N} .$$

Additionally, according to (16), T_{q}²[n,m] is given by:

$$\begin{matrix}= {\sum }_{k = 0}^{N - 1} {e}^{- 2 {{π}^{2} ( q - k )}^{2} / {k}^{2}} {e}^{i2π ( q - k ) n / N} {e}^{i2π km / N} \\ = {e}^{i2π qn / N} {\sum }_{k = 0}^{N - 1} {e}^{- 2 {{π}^{2} ( q - k )}^{2} / {k}^{2}} {e}^{i2π k ( m - n ) / N} \\ = {e}^{i2π qn / N} ( IFT of f [ k ] evaluated at m - n ) .\end{matrix} \qquad ( 22 )$$

From (10), O_{q}²[n,m], the OTT of T_{q}²[n,m], is given by:

$$\begin{matrix}{O}_{q}^{2} [ n , m ] = {T}_{q}^{2} [ n , ( m + n + N ) mod N ] \\ = {e}^{i2π qn / N} {\sum }_{k = 0}^{N - 1} {e}^{- 2 {{π}^{2} ( q - k )}^{2} / {k}^{2}} {e}^{i2π k ( m ) / N} \\ = {e}^{i2π qn / N} ( IFT of f [ k ] evaluated at m ) .\end{matrix}$$

(23)

T_{q}³[n,m] and O_{q}³[n,m] are similar but using S_{q}^{C}[n,k] instead of S_{q}[n,k], where S_{q}^{C}[n,k] is derived from S_{q}[n,k] by (5).

Since ST and IFT are linear and TT is their composition, TT is also linear. Hence, from (12):

$${T}^{2} [ n , k ] = TT of h [ n ] = TT of {\sum }_{q = 0}^{N - 1} H [ q ] {u}_{q} [ n ] = {\sum }_{q = 0}^{N - 1} H [ q ] ( TT of {u}_{q} [ n ] ) = {\sum }_{q = 0}^{N - 1} H [ q ] {T}_{q}^{2} [ n , k ] \qquad ( 24 )$$

showing that the set of T_{q}²[n,m] with q=0, 1, . . . , N−1 is a basis for T²[n,m]. The same holds for T³[n,m], O²[n,m] and O³[n,m].

Properties of TT-Transform of Pure Complex Sinusoid

Periodic:

For a fixed q, T_{q}²[n,m] is periodic n and m simultaneously, with period N/q, i.e.,

$${T}_{q}^{2} [ n + \frac{N}{q} , m + \frac{N}{q} ] = {T}_{q}^{2} [ n , m ] \qquad ( 25 )$$

This can be proved easily from (22).

For O_{q}²[n,m], the summation in (23) is independent of n, so it is periodic in n only, with period N/q, i.e.,

$${O}_{q}^{2} [ n + \frac{N}{q} , m ] = {O}_{q}^{2} [ n , m ] \qquad ( 26 )$$

T_{q}³[n,m] is also periodic in n and m simultaneously, and O_{q}³[n,m] periodic in n, both with period N/q. It's because they have the same sinusoidal factors as in T_{q}²[n,m] and O_{q}²[n,m]. Note that the period is generally a non-integer as q may not divide into N exactly. As discussed below, it is possible to get around this issue by making use of the periodicity of OTT.

Gaussian:

For fixed q and fixed n, the magnitude of T_{q}²[n,m] or T_{q}³[n,m], treated as a function of m, is near-Gaussian in shape, centred at m=n with SD=N/q.

To prove it for T_{q}²[n,m], examine (22), for example. As explained above, f[k] is near-Gaussian with SD q/2π near k=q. Now, the IFT of a Gaussian is also a Gaussian with SD=N/2π (times the reciprocal of that of the original Gaussian. Therefore, the magnitude of T_{q}²[n,m] is also near-Gaussian with SD N/q. It is centred about n since the IFT is evaluated at m−n.

For T_{q}³[n,m], and using (9) and (5), it can be written as the sum of two “truncated” terms:

$$\begin{matrix}{T}_{q}^{3} [ n , m ] = {\sum }_{k = 0}^{N / 2} {S}_{q}^{*} [ n , k ] {e}^{i2π km / N} + {\sum }_{k = N / 2 - 1}^{N - 1} {S}_{q}^{\#} [ n , k ] {e}^{i2π km / N} & ( 27 ) \\ where & \\ {S}_{q}^{*} [ n , k ] = \{ \begin{matrix}S [ n , k ] & if 0 \leq k \leq \frac{N}{2} \\ 0 & if \frac{N}{2} < k < N\end{matrix} , & ( 28 ) \\ and & \\ {S}_{q}^{*} [ n , k ] = \{ \begin{matrix}0 & if 0 \leq k \leq \frac{N}{2} \\ \overline{S [ n , N - k ]} & if \frac{N}{2} < k < N\end{matrix} . & ( 29 )\end{matrix}$$

Similarly to (22), T_{q}³[n,m] is formed by the sum of the IFT of “truncated” near-Gaussian functions, which is also near-Gaussian in shape, centred at m=n, but with some oscillatory characteristics due to the abrupt jump in the truncation, (as the IFT of a rect function is a sinc function.)

Now, each T_{q}²[n,m] or T_{q}³[n,m], treated as function of m, is near-Gaussian functions centred at m=n. So, their aggregate, T_{q}²[n,m], treated as function of m and n, is concentrated about the diagonal m=n.

For fixed q and n, O_{q}²[n,m] and O_{q}³[n,m] are also near-Gaussian functions of m. Hence, when treated as function of m and n, they cluster around the horizontal line m=0 (since the IFT is evaluated at m) with SD=N/q.

The TT and OTT characteristics of PCS's are discussed above with regard to FIGS. 1(a)-(g). The PCS of frequency 6/256 between n=64 and n=128 has a wider spread, while that of frequency 25/256 from n=128 onwards is narrower. Additionally, O³ exhibits distinctive oscillatory patterns.

Symmetry:

For fixed q and m, O_{q}²[n,m] and O_{q}³[n,m] are conjugate-symmetric about n=N/2. This is obvious from the fact that (23) becomes its conjugate when n is replaced by N−n.

Properties of TT-Transform in General

From (24), the basis T_{q}²[n,m] spans all T_{q}²[n,m]. Now, each T_{q}²[n,m] is near-Gaussian centred around the diagonal, tailing off moving away from the diagonal. Therefore, T²[n,m] of a general time series, being their linear combination, should have this property. Moreover the high-frequency components of a time series contribute to the places near the diagonal, and low-frequency components take a role in far away places.

And the same holds for T³[n,m], except that it carries the oscillatory characteristic from each T_{q}³[n,m]. Likewise, O_{q}[n,m] and O_{q}[n,m] cluster about m=0, as each of O_{q}²[n,m] or O_{q}³[n,m] does.

Process Flow

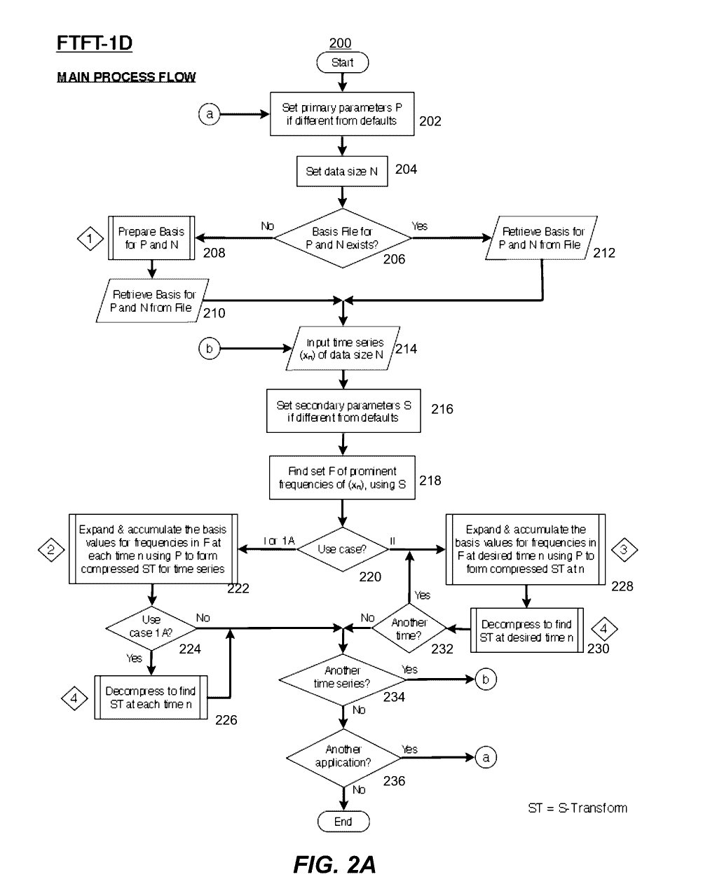

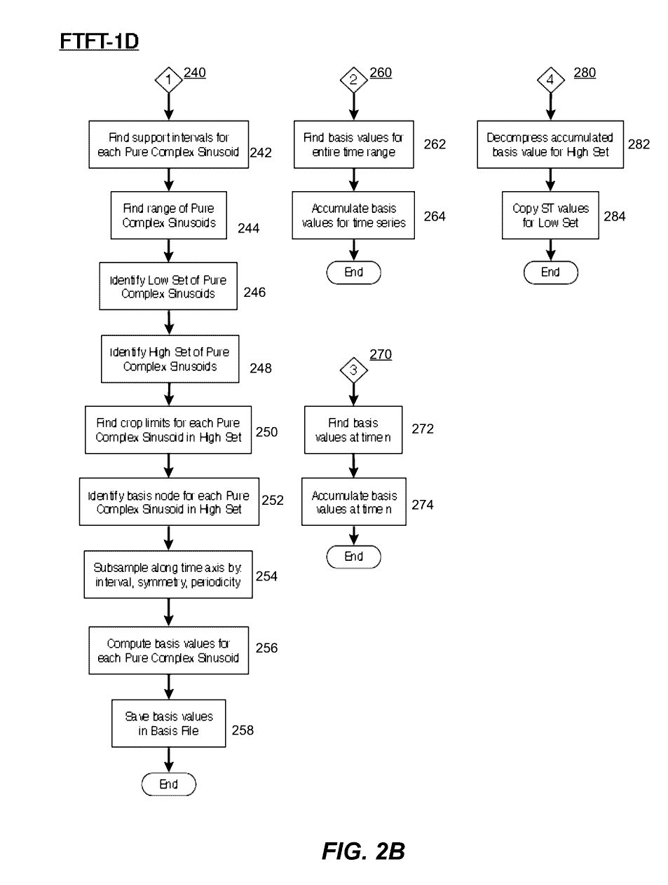

Referring now to FIGS. 2A-2B, flow diagrams illustrating example operations 200, 240, 260, 270 and 280 for generating a compressed form of values of a one-dimensional S-transform (ST) for a time series and generating an approximate form of ST are shown. The flow diagrams include example operations for processing the entire time series (“Use Case I”) to generate a highly compressed form of ST, as well as decompressing the compressed values to generate the ST values for the entire time series for visualization, analysis or processing (“Use Case IA”). Additionally, the flow diagrams include example operations for visualizing, analyzing or processing local spectrum of the ST at a single time (“Use Case II”).

At 202, the primary parameters P are optionally set, if the primary parameters P are to be different from the default values. There can be seven primary parameters, for example, which are discussed in detail below. At 204, the data size N is set. At 206, a determination is made as to whether a Basis File for the values of N and the primary parameters P already exists. If no, at 208, the essential basis values for these values of N and the primary parameters P are prepared and saved into the Basis File for future use. At 210, the essential basis values can be retrieved from the Basis File before proceeding to 214 (inputting a time series). If yes, at 212, the essential basis values can be retrieved from the Basis File before proceeding to 214 (inputting a time series).

At 214, a time series of data size N is input. At 216, the secondary parameter S for this particular time series can optionally be set, if the secondary parameter S is to be different from the default values. At 218, the time series is pre-processed to determine the set F of prominent frequency indexes, using the secondary parameter S. At 220, a determination is made as to whether the application is Use Case I, IA or II. For Use Cases I and IA, at 222, the basis values are expanded and accumulated for those PCS's with frequencies in F, for each time index n to form the compressed ST values, using the primary parameters P. If it is determined at 224 that the application is Use Case IA, then at 226, the compressed values can be decompressed to find the local spectra at each time index n. For Use Case II, at 228, the basis values can be expanded and accumulated for those PCS's with frequencies in F, for the desired time index n, to form the compressed ST values there, using the primary parameters P. At 230, the compressed values can be decompressed to find a single local spectrum at n.

At 232, to find local spectrum at another time index, the operations beginning at 228 are repeated. At 234, if there is another time series of the same data size for the same application to process, repeat the operations beginning at 214. At 236, if there is another application with different data size, then repeat the operations beginning at 202.

The terms used in the above process flow are discussed below. The basis produced in 208 is a collection of some ST and OTT values of the PCS's. For a particular application, sub-operations 240 shown in FIG. 2B are performed to prepare the basis values. This need be done once only, as the basis values can be saved and retrieved from the saved basis file for each time series in that application. There are a lot of redundancies in the basis values, so only generate and save the essential subset of them into the basis file.

To use the basis for an input time series, first expand the subset into a complete basis, and then “accumulate” the basis values to obtain some ST and OTT values of that time series. (Accumulation here means finding the linear combination of the basis values.) Those accumulated ST and OTT values are actually the compressed form of the ST of the time series. For Use Cases I and IA, the compressed ST for all time index n=0, 1, . . . , N−1 are obtained, whereas in Use Case II, only the compressed ST at a single time index n obtained, decompressing it afterwards to obtain the local spectrum there.

There are altogether eight user-adjustable parameters, named by Greek alphabets. They are ε, η, γ, μ, υ, λ, φ, β. The first seven are primary parameters and the last one secondary. They are all independent of the data size, and are usually fixed. Users can at all times simply use the default values suggested herein. Optionally, the users may adjust the parameters to make them work best for a particular application. The basis depends on the data size and the primary parameters, by the assumptions discussed below, a single basis file created in 208 should always work in that application. The secondary parameter is used in the accumulation task in Use Cases I, IA and II, and the users may want to tune it to suit an individual time series.

Preparation of Basis Values

Preparation of basis values is discussed with regard to FIG. 2B, and in particular with regard to operation 240. This is the major step, made up of a large number of sub-steps. It is based on two assumptions: (1) For each particular application, the data size N is fixed. This is usually true in practice. If the time series is indefinitely long, like the continuous recording of economic or climatic data, then it is possible to take a moving window of fixed size. (2) The primary parameters remain constant for all time series in that particular application, as they are defined and designed to be so.

Finding Support Intervals for Each Pure Complex Sinusoid

At 242, support intervals for each PCS are found. Many of the ST values for a given time series are relatively small in magnitude. By ignoring them, it is possible to speed up the process. For example, use parameter ε as the minimum magnitude of the ST values to keep. Then find the “support interval” for each PCS of frequency index q, i.e. the range of frequency index values for which the magnitude of the ST of that PCS is not less than ε. The lower bound l_{q} and upper bound u_{q} of this support interval can be found by applying (21). For each q, only consider the frequency band whose frequency index lies between l_{q} and u_{q}.

Finding the Range of Pure Complex Sinusoids Needed

At 244, a range of PCS's can be found. As users may only be interested in ST values for k=0, 1, . . . , N/2−1, only use those PCS's whose support interval overlaps with the interval [0, N/2−1]. Let's define qₘₐₓ as the largest values of q for which the lower bound l_{q} is below N/2. Then confine to those PCS's with q=0, 1, . . . , qₘₐₓ; the other q's do not contribute significantly to the results. qₘₐₓ is roughly proportional to N because I_{q} is proportional to q. In general, qₘₐₓ is somewhat greater than N/2.

Identifying the Low Set

At 246, the low set of PCS's can be identified. Use the fact that the ST of a PCS with frequency index q is concentrated around k=q, having smaller extent for smaller q. Hence it is economic to just copy the ST values of those PCS's with small q into the basis. This set of such PCS's is called the “Low Set”.

It is possible to specify some threshold copy frequency index a such that if the support interval of a PCS of some q contains α (which is true when l_{q}<α), then put that PCS into the Low Set for copying purposes.

It is also possible to minimize the sum of the extents of the Low Set and the High Set (defined below); this would give the most TRF information for a given basis size. Now, the former is α and the latter is roughly proportional to N/α, (by Section 5.5 as the smallest q in the High Set is close to α). By calculus, their sum is minimal when α is a multiple of \sqrt{N}. It has been confirmed from experiments that the best value of α to be used is somewhat proportional to \sqrt{N}, so declare a data-size-independent parameter η so that α=η\sqrt{N}.

Identifying the High Set

At 246, the high set of PCS's can be identified. It is possible to use OTT instead of TT for the High Set, because OTT does not have the wrapping effect and has a nicer clustering property: D_{q}²[n,m] (and also D_{q}³[n,m]) is concentrated around the horizontal line m=0, for given q and n. Contrary to the characteristics of ST discussed herein, the OTT of a PCS with frequency index q has smaller extent for larger q. Hence it is economic to use the OTT values of those PCS's with large q into the basis. The set of such PCS's is referred to as the “High Set”.

Likewise, it is possible to put those PCS's of some q whose support interval contains α (which is true when u_{q}>α) into the High Set for using their OTT.

It is clear that the High Set and Low Set are overlapping; there are many instances of q that are contained in both sets. This is intentional: the cropping of OTT described in the next section may cause some errors or ringing artifacts in the decompressed ST at low frequencies. Fortunately, the copied ST values at those places will replace the incorrect ST there.

Determining Crop Limits for Each Pure Complex Sinusoid in the High Set

At 248, the crop limits for each PCS in the high set can be determined. Because of the near-Gaussian and clustering property of OTT, it is possible to crop off those OTT with large values of |m| without much degradation in accuracy.

Let c_{q} be the crop limit for the PCS of some q, i.e. only those m satisfying |m≦c_{q} are considerably large for use. Due to the Gaussian property discussed above for OTT, it is known that c_{q} is inversely proportional to q. Let γ be a parameter such that c_{q}=γ N/q for all q. (If c_{q} exceeds N/2, then let it be N/2.)

For the given parameter γ, it is possible to determine the value of c_{q} for each q≦qₘₐₓ. The maximum of all these c_{q} is referred to as “maximum crop limit”, denoted by cₘₐₓ. It is used to identify the basis nodes, which is discussed below.

But when q is small, c_{q} will become large. This in turn will cause the maximum crop limit cₘₐₓ exceedingly large, and the basis nodes given by (30) too far apart, hence taxing on the accuracy. It is possible to employ a strategy to limit the size of c_{q}: Let q* be such that the lower bound of its support interval l_{q}* is equal to the copy frequency index α. For all q<q*, set c_{q} to be c_{q}*. In this way, cₘₐₓ will take a reasonable value of c_{q}*. This choice of q* is quite arbitrary, but proves to give good results.

Identifying Basis Nodes for Each Pure Complex Sinusoid in the High Set

At 252, a basis node for each PCS in the high set can be identified. Even though m is restricted to be within [−c_{q}, c_{q}], there will still be a lot of values of O_{q}²[n,m] (or O_{q}³[n,m]) for each q and n, since c_{q} is quite a large number for large N. It is possible to subsample them to keep the basis size low. As the OTT values are concentrated about the line m=0, with large values near it and tailing off into small values moving away from the line, there should be more subsampled points near the line. Therefore, a plausible subsampling method for m would be a geometric progression (GP).

The subsampled m's are referred to as the “basis nodes”. As discussed below, the OTT for all PCS's will be accumulated to form their linear combination, so ensure that the basis nodes are common to all PCS's. At the same time, it is desirable to satisfy our UIE requirement for compression: the number of encoded values should the same for all PCS's. Obviously, it is not possible to have both. Therefore, it is possible to make the order of the number b_{q} of basis nodes, O(b_{q}), independent of q. It can easily be proved that this holds if and only if b_{q} is a linear function of log q. It is possible to reason that using a GP for the common basis nodes can make b_{q} proportional to log q.

Let b be the maximum of b_{q} for all q≦qₘₐₓ, so it is the number of common basis nodes for all PCS's. Then the set B of common basis nodes will be given by:

B={m:m=0 or |m|=round(r^{j}), j=0,1, . . . , b−1}, (30)

where round( ) means the nearest integer of a real number. The radix r is such that r^{b-1}=cₘₐₓ.

Then for a PCS of some q≦qₘₐₓ, determine a subset B_{q} of B given by:

B_{q}={m ∈ B: |m|≦c_{q}}. (31)

Thus, only the OTT values of that PCS for those m in B_{q} need to be found.

How to set the value of b is discussed below. It has been discovered that b is proportional to log N. This may also be argued from b_{q} being proportional to log q and qₘₐₓ being proportional to N. So, define a parameter μ such that b=μ log N.

If b is chosen too small, r will be close to 1, say 1.2. Then round(r¹) will be 1 for j=0, 1, 2. To avoid repetition in set B, allow the first few numbers in B to take consecutive integer values 1, 2, 3, . . . , etc. until j is so large that the repetition does not occur.

Subsampling Along the Time Axis

At 254, subsample along the time axis. Here, by time axis, the axis for time index n is meant, not the m in TT and OTT, (which happens to be also in time unit). As discussed below, there are a lot of redundancies in ST and OTT. Subsampling will select the essential subsets to be put in the basis file. There are three ways to reduce the basis size:

Time Interval

A PCS of frequency index q consists of waves with wavelength N/q. Hence its ST, TT and OTT all have time resolution that varies with q, being smaller for lower frequencies. Therefore, it is not necessary to compute low-frequency ST and OTT for every time index n. It is possible to skip by some time interval i_{q}, taking every i_{q} th element along the time axis.

For a PCS of some q, the subsampling time interval width i_{q} is inversely proportional to q. So use parameter υ, defined as the number of intervals for the PCS with q=\sqrt{N}. \sqrt{N} is chosen as it is somewhat the geometric centre of the frequency domain; it has been used in as discussed below to define the bounds of Low and High Sets. That is, make i_{\sqrt{N}} equal

$$[ \frac{N}{υ} ] ,$$

where [ ] means integral part. By inverse proportion, the time interval width i_{q} for PCS of frequency index q is given by:

$${i}_{q} = [ \frac{N \sqrt{N}}{υ q} ] .$$

A large value for υ is generally chosen. Then, the expression for i_{q} would become 0 for most q except in the very low frequency band. When i_{q} is 0, take it to be 1, meaning that simply find the values at all n without skipping.

Some of the known ST approximation techniques also exploited the characteristics of the small frequency resolutions of ST at high frequencies. In the methods discussed herein, a less aggressive approach is adopted by setting a fairly large υ, so the time interval is much shorter than in the know ST approximations, guaranteeing more accurate results.

Some moderate interval subsampling is justified, especially for those applications where the time series is analyzed by averaging ST over some time interval.

Symmetry

By symmetry property of both ST and OTT discussed above, it is possible to compute only the ST and OTT values for n≦N/2, the other half being obtained by conjugate symmetry.

Periodicity

Although both ST and OTT of a PCS exhibit periodicity, as discussed above, it is possible to only make use of the latter for the High Set, as the period of the former is too large to be useful for the Low Set. (q and k are small there, and so is q−k.)

By (26), OTT is periodic in n with period N/q for some q in the High Set, so in theory it is possible to only need to find the OTT values for n≦N/q, copying them for the ensuing range of n. But N/q is not an integer unless q is a factor of N. For most cases of q, the sequence of OTT never repeats itself after some discrete time interval.

To make use of this non-integral period, the OTT not just for the first period with n=0, 1, . . . , [N q], but for a longer “initial interval” n=0, 1, . . . , j_{q}. j_{q} is called the “initial interval limit” needs to be computed. Then the OTT values in the ensuing periods can be copied from the OTT values in the initial interval. By the symmetry property discussed below, it is possible to extrapolate the initial values up to N/2.

The “copying” operation is not simple. Suppose that it is necessary to find the OTT value at some time index n between j_{q}+1 and N/2. The smallest time index v₀ within the initial interval can be determined such that n and v₀ differ by an integral multiple of the period. Specifically,

$${v}_{0} = n - \frac{N}{q} [ \frac{nq}{N} ] \qquad ( 32 )$$

Then, all real numbers ν=ν₀, ν₀+N/q, ν₀+2N/q, . . . , can be scanned over until j_{q} to see which ν is closest to an integer, i.e. the rounding error |ν−round(ν)| is smallest. Choose the OTT at that round(ν) as the OTT for n. This minimum-rounding-error will be denoted by e_{q,n}, and that round(ν) denoted by ν_{q,n}.

Although the above process is time-consuming, it is not an issue because basis values are prepared only once. It may also be possible to speed up finding ν_{q,n} in the preparation stage by first running the process for the first n=j_{q}+1. Next, noting that when n is incremented by 1, the scanning set is shifted by 1 so it is very likely that ν_{q,n}+1=V_{q,n}+1, (unless the new vo introduced into the set has a rounding error less than those old members of the set, but this may beignoree as the improvement should be small). Then, continue adding 1 to ν_{q,n} until it reaches j_{q}′; then run the above process for the next n.

j_{q} is now discussed. It should be large enough to reduce error, but not too large to undermine the use of the periodicity. The following sophisticated algorithm attempts to find the best j_{q} for each q in the High Set, based on some parameter λ>1:
(a) If q<2\sqrt{N}, then for each integer j=N/q, N/q+1, N/q+2, . . . ,^{λ}N/q (satisfying j≦N/2), use the initial interval from 0 to j and find the root-mean-square (rms) of the minimum-rounding-error e_{q,n} incurred when using this initial interval to find the OTT values for all the ensuing time indexes n. Now, choose the j that makes this rms smallest and use it as j_{q}. (Use norm-2 rms to emphasize the error.)
(b) Otherwise, find gcd(N, q), the greatest common divider of N and q. If gcd(N, q)>1 and ^{λ} gcd(N, q)>q, then use N/gcd(N, q)+1 as j_{q}.
(c) Otherwise, if ^{λ}N/q≦N/2, use ceiling(^{λ}N/q) as j_{q}.
(d) Otherwise, use N/2 as j_{q}.

The optimization in step (a) above ensures that the initial interval limit chosen can produce the smallest rms error in the copied OTT values. It has been found from experiments that (a) is unnecessary when q≧2\sqrt{N}.

If q is large, the time-consuming step (a) is not of much use as the range of j is short, so simply use the ceiling of ^{λ×} period as the initial interval limit, unless q happens to share a common factor with N. ^{λ} can therefore be understood as the maximum number of periods in the initial interval.

To explain step (b), note that N/gcd(N, q) is a multiple of the period N/q since gcd(N, q) is a factor of q. Moreover, N/gcd(N, q) is an integer since gcd(N, q) is a factor of N too. So, N/gcd(N, q)+1 can legitimately serve as the initial interval limit. If ^{λ} gcd(N, q)>q, then N/gcd(N, q) will be less than ^{λ} N/q, so it is better than the one using step (c).

Now, for each PCS of q in the High Set, use (32) and the method there to find the best time index v_{q,n} within the initial interval for copying into each ensuing n.

To avoid doing the above procedure again for every time series in the application, it is possible to save into the basis file the set of j_{q} for all q in the High Set, as well as the set of ν_{q,n} for all q in the High Set and all n that lie after the initial interval. They will be retrieved from the basis file along with the basis values. But for very large N, this would make the basis file extremely large. In this case, it is then possible to resort to finding on the fly during the expansion phase discussed below, which should be quite fast employing the speedup idea given above. Note that this is applicable to Use Cases I and IA but not Use Case II.

Note that it is assumed that the time interval i_{q} of discussed above is 1. If it is greater than 1, then the above paragraphs remain valid, if the time series is treated as containing N/i_{q} data with period N/i_{q} q.

Computing Basis Values for each Pure Complex Sinusoid in High and Low Sets

At 258, the basis value for each PCS in the high and low sets can be computed. Equipped with the cropping and subsampling schemes discussed above, it would now be straightforward to form the essential basis for the High Set and Low Set.

For the High Set, there is the option of either using O² or O³. The former is accurate at very high frequencies close to 1/2. The latter nearly halves the size of the basis, as O³[n, m] is real for all n and m, so it is not necessary to store their imaginary parts. The times to prepare the basis files, and to extract and accumulate the basis values are all reduced. It is possible to use a Boolean parameter φ for the user to choose between using O² (φ=FALSE) and using O³ (φ=TRUE). This choice does not affect the Low Set.

The graphs of O² and O³ in FIGS. 1(a)-(g) may lead one to think that O² is more concentrated than O³, and so it is possible to use a smaller crop limit parameter γ for O², but they actually have roughly the same extent. The grey scales in FIG. 1(d) are different from those in FIG. 1(g). So the same crop limit is used for both.

For each PCS of q in the High Set, go over all time index n from 0 to N/2 (due to the symmetry) or from 0 to j_{g} whichever is shorter, at time interval i_{q}. For that n, perform the IFT for φ_{q}²[n, m] as in (22) if φ is FALSE or a similar IFT for O_{q}³[n, m] if φ is TRUE. From the IFT, it is possible to get the O² or O³ values at all m. But it is only necessary to get those O² or O³ values at the basis nodes of B identified above, and save them into the basis file.

Next, for each PCS of q in the Low Set, go over all time index n from 0 to N/2, at time interval i_{q}. For that n, use (16) to get the ST values and put them into the basis file.

As discussed above, the PCS of the same q may appear in both the high and low set. This overlap is necessary to ensure completeness and continuity in the result.

The basis is not huge in size and can likely be held in memory. If memory space is an issue, it is possible to compute the basis values for each q and immediately save them into the basis file. Afterwards, the memory can be reused for the next q.

Generating Compressed ST Values

To generate the compressed ST values for all time index n=0, 1, . . . , N−1 and frequency index k=0, 1, . . . , N/2−1, it is not necessary to first compute all the ST values, as explained in above. Instead, retrieve the basis values from the basis file, expand them to cover the entire time range, and then accumulate them to form the compressed values. Before taking these steps, perform pre-processing on the given time series as discussed below.

Pre-Processing to Find Prominent Frequencies

From (20) and (24), the ST and OTT values for the time series is a linear combination of those of the PCS's, weighted by the corresponding “Fourier coefficients” H[q]. So, find these Fourier coefficients by applying FFT on the given time series. Now, note that in most cases, H[q] is significant only for a subset of frequency index q, so just accumulate those “prominent” PCS's with large H[q] into the linear combination.

Next, determine how many of the prominent Fourier coefficients to select. One way is to set a fixed threshold, say 0.01, and ignore all those q whose H[q] falls below the threshold. This approach is good when the time series being processed are all similar in nature and their frequency contents are being compared.

For widely varying time series, use a robust way that is unaffected by noise or outliers such as like the percentile. For example, sort the set of Fourier coefficients {H[q]1≦q≦qₘₐₓ} in ascending order, and its βth percentile P_{β} as the threshold. Hence, form the set S of prominent frequency indexes:

S={q:H[q]≧P_{β}}. (33)

Consequently, the most prominent (100-β)% of the Fourier coefficients are used. This parameter does not affect the creation of the basis and so is regarded as a secondary parameter. The user may adjust it for an individual time series.

As S depends on the distribution of frequencies in a time series, this method is “adaptive” in the sense that the best way is chosen to compress the time series. This is superior to other techniques that apply a rigid process regardless of the spectral characteristics of the time series.

This strategy has an important advantage besides reducing accumulation time. In many practical applications, like segmentation and classification, it is only necessary to look at the prominent frequencies, as the less prominent ones may be due to noise or minor artifacts. This is discussed in further detail below.

Restricting S for an Application

When only interested in some frequency subset K, then set S can further be made smaller:

S={q:H[q}≧P_{β}and [l_{q}, u_{q}]∩K≠Ø}. (34)

For example, using the midrange frequency band K={k:k₁≦k≦k₂ }, assuming that effects by global trends or by noise are not important, which are reflected in frequencies lower than k₁, or in frequencies higher than k₂ respectively. Then, S={q:H[q}≧P_{β}and l_{q}≧k₁and u_{q}≦k₂}.

Rather than using β as discussed where there is no clue as to which frequencies are ignored, it is more controllable for the user to set the band limits K. Then, S={q:l_{q}≧k₁and u_{q}≧k₂}.

Expanding the Basis into Entire Time Range

Example operations 260 for expanding and accumulating basis values for the entire time range are discussed below. At 262, it is possible first to get all the basis values for each PCS in the intersection of the High Set and S. But the values saved in the basis file only covers the initial interval from n=0 to j_{q}, and at time intervals of i_{q}. So, it is then possible to expand them to cover the entire time range for use in the next section.

First, copy the OTT values inside the initial interval onto the ensuing time indexes n, up to N/2. For each w, the position ν_{q,n} in the initial interval to copy from is already saved in the basis file. If ν_{q,n} is not included in the basis file, they are found on the fly as discussed above.

After extending the initial interval values into the whole range up to N/2+i_{q}, fill in the skipped OTT values if the time interval i_{q} is not 1.It is possible to simply use fast linear interpolation with good accuracy because the time interval is mostly small. (+i_{q} is needed because to find OTT for n around N/2, an interpolation interval that extends beyond N/2 is used.)

Finally, obtain the OTT values for n>N/2 by finding the complex conjugate of the corresponding value at N−n.

The basis values for PCS's in the intersection of the Low Set and S, are expanded in the similar fashion, except that the initial interval copying is not needed. Just linearly interpolate over each time interval.

Accumulating the Basis Values for an Input Time Series

At 264, it is now possible to accumulate the expanded High- and Low-Set basis values only for those frequency indexes in the set S. The linear combination so formed for all the n will together form the compressed ST values of the given time series, and this job is done. When using the O³ option with φ=TRUE, the compressed form has half the size as the normal one.

Again, if memory is an issue, just load the basis values from the file only for those PCS's belonging to the set S, one by one. For each PCS in S, expand and accumulating the basis values into the partial sum of the linear combination. The memory can then be released before loading the basis values of the next PCS in S.

The strategy is taken that in the compressed form, all the compressed data for each time index n exist, so that the TFR at each n individually can be analyzed. The linear interpolation over the time intervals for the Low Set discussed above is done purposefully.

Generating Local Spectrum at Desired Time

Example operations 270 for generating local spectrum at desired time are discussed below.

Pre-processing to Find Prominent Frequencies

As discussed above, it is possible to perform pre-processing to find prominent frequencies. It needs be done only once for a given time series. It can be reused for as many local spectra as needed. It is also possible to use the band limits discussed above.

Getting the Basis Values for the Specific Time

At 272, find the basis values at time n. The operation is similar to operations discussed above for generating basis values for the entire time series, except only expanding for a single time index n, not for the whole time range. Hence, the steps can be simplified. For instance, if it lies on the initial interval, or if the margins of time intervals, or if n≦N/2, then the extension, interpolation or conjugates, respectively, are not performed. The position ν_{q,n} in the initial interval to copy from is already saved in the basis file. If the position is not included in the basis file, find them on the fly. The speedup idea discussed above is of no use here as ν_{q,n} for a single n is needed.

Accumulating the Basis Values

At 274, accumulate the basis values, the operations of which are similar to those discussed above with regard to the entire time series, except that it is only performed for a single time index n. For convenience in finding local spectra at several time indexes, place in memory all the basis values for all those PCS's in S.

Decompressing the Basis Value

Example operations 280 for decompressing to find ST at each time n are discussed below. The basis value obtained above for a particular n is the compressed form of ST. To decompress it into the uncompressed ST values, decompress the High Set and Low Set separately.

Decompressing for the High Set

At 282, the basis values for the High Set is the OTT values at selected basis nodes of Bare found as discussed above. It is possible to fill the missing ones between the nodes. The simplest and fastest way is by linear interpolation between adjacent nodes. Again, in the O³ option (φ=TRUE), it is only necessary to do it for the real parts.

This may cause a slight increase in low frequency contents because of the interpolated straight lines, but the error is minimal. The error would be significant when the OTT values are large; luckily they are large only near the diagonal m=n and the nodes are very close there so the needed interpolation is small, if at all. The nodes are far apart when they are away from the diagonal; luckily the OTT values there are small.

Next, perform the inverse of the displacement of (11) on the complete set of OTT to get back the corresponding TT values. Note that in the O³ option , only perform it for the real parts. Finally, perform the FFT on the TT to generate the ST values.

There is an abrupt truncation of OTT at the crop limits discussed above, causing a very small sinc ringing effect in its FFT. Optionally, use a tailing technique like linear extrapolation to avert it, but the benefits are outweighed the overhead of extrapolation.

Referring to FIGS. 1(a)-(g), on TT and OTT, note that there are horizontal or vertical stripes in TT diagrams. They become −45° stripes in OTT diagrams due to the displacement. This feature is more pronounced in T³ and O³. It may be possible to produce better results by doing interpolation of OTT at −45° along the slant line m+n=0 instead of vertically along the m axis. This is especially valuable for low frequencies where the nodes are widely separated. Unfortunately, some horizontal time interval subsampling was performed at low frequencies. And, there are not enough contiguous points for this kind of interpolation.

Copying for the Low Set

The ST values formed as discussed above cover the upper frequency band with good values for k greater than the threshold copy frequency index a. The results below a are poorer. At 284, simply cover up the poor results by inserting the basis values for the Low Set into this lower frequency band. In this way, obtain a complete, accurate local spectrum covering the upper (k>a) and lower (k <a) parts of the frequency range from 0 to N/2−1.

Generating S-Transform Values for Entire Time Series

To generate ST values over the entire time series, i.e. Use Case IA, first obtain the compressed values for the time series as discussed above. Then perform the decompression steps for each time unit n in the time series as discussed above. If N is too large for all the ST values to be held in memory, it is possible to either save them in auxiliary storage as they are being generated, or discard an ST value immediately after it has been used.

Experimental Results

Parameters

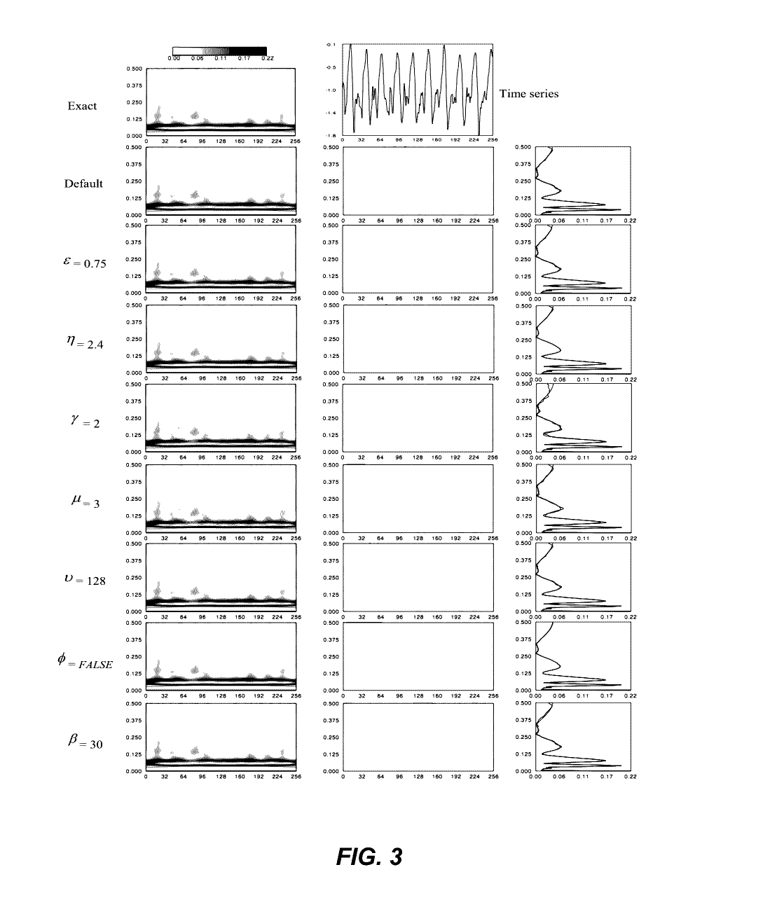

Experiments have been performed with different parameter settings to find out how they may affect the speed, compression ratio and accuracy of the methods discussed herein. For example, FIG. 3 illustrates exact and decompressed compressed ST values according to experimental results. As shown in FIG. 3, the top left plot is the exact ST values. The remaining plots on the left-most column are decompressed ST values, with n and frequency f along the horizontal and vertical axes. The differences with the exact plot are shown in the middle column. The right-most column illustrates graphs of magnitudes of local spectrum at n=60, for the exact and decompressed ST. Both curves are in black. The exact local spectrum curve appears in all of the graphs. The rows correspond to the settings contained in Table 3 below.

ε: (ST parameter discussed above) It determines the size of the support interval for each PCS, and depends on the data size N. It has been discovered that using 0.05 gives good results for all N. Increasing it will make the support intervals smaller, so there are fewer PCS's involved in the computation. As the result, the process runs faster with lower accuracy.

η: (Low-high margin parameter discussed above) Increasing it will move the threshold copy frequency index a downwards, giving exact values for the ST just below it. In FIG. 3, improvement is seen in low frequencies going from the default value of 0.6 to 2.4. The basis file size and hence the expansion and accumulation times will increase a lot. The preparation and local spectrum times remain the same.

γ: (Cropping parameter discussed above) This parameter acts as a tradeoff between speed and accuracy. By lowering it, the ST values at low frequency band will become poor. There will be some ripples in the ST diagram at low frequencies just above the threshold a, especially for those time series with significant high-pitch components.

μ: (High node parameter discussed above) Though this parameter directly dictates the size of the basis file and of the compressed form, its effect on accuracy is less apparent than that of γ. Nevertheless, high values do improve accuracies especially at the peaks and troughs.

ν: (Time interval parameter discussed above) This mainly affects the basis file size and accuracy. Lowering it decreases the size but increases the time to expand the basis, and introduces artifactual patterns at low frequencies. Using large values for it to improve accuracy is preferred.

λ: (Periodicity parameter discussed above) Larger value of λ will make the initial interval longer and the basis file larger, with diminishing return on accuracy, and without reducing the time taken to expand the basis.

φ: (OTT parameter discussed above) Setting it to TRUE (O³ option) almost halves the basis size and reduces the process time of the FALSE option, at a mild expense of poorer accuracy in ST at high frequencies close to ½. Preferably, always keep this option unless more regular high frequency values are desired.

β: (Prominent FT parameter discussed above) This does not affect the basis formation, and can easily be adjusted by the user. Decreasing it lowers the threshold and puts more Fourier coefficients into play, improving the accuracy and consuming more time. The effects depending very much on the degree of uniformity in the distribution of frequencies in the input time series.

Table 1 below shows the default values of the parameters.

TABLE 1

| ε | η | γ | μ | υ | λ | φ | β |
|---|---|---|---|---|---|---|---|
| 0.05 | 0.6 | 8 | 4 | 4096 | 16 | TRUE | 0 |

Speed and Size

Tables 2 and 3 below show the times taken to perform the main steps in the process, the size of the basis and of the compressed ST values, for different data sizes N. The time taken to find a single local spectrum at time t fluctuates with t, so it is possible to take an average over all t for the columns “Local Spectrum” and “Compressed Local Spectrum”. Four-byte floats for all real values, and eight bytes for complex values are used.

The time series being used to form this table is the vertical position of an IPHONE strapped onto the back of a person walking on a treadmill at the speed of 4.5 mph, recorded by the accelerometer inside the IPHONE.

In Table 2, the default values suggested in Table 1 for the parameters in all trials are used.

TABLE 2

| | Processing Time in seconds | | | | | | | |
|---|---|---|---|---|---|---|---|---|
| | | | | Compressed | | Size in MB | | |
| | | | | Entire | Local | | | Compressed |
| Data | Prepare | Retrieve | Pre- | ST Values | Spectrum | Exact ST | Basis | Entire |
| Size | Basis | Basis | process | (Use Case I) | (Use Case II) | Values | File | ST Values |
| 256 | 0.216 | 0.0004 | 0.00018 | 0.0152 | 0.00016 | 0.25 | 2.0 | 0.1475 |
| 512 | 1.14 | 0.0008 | 0.0002 | 0.0625 | 0.00032 | 1.00 | 5.8 | 0.3418 |
| 1024 | 5.84 | 0.001 | 0.0003 | 0.257 | 0.00067 | 4.00 | 15.5 | 0.7852 |
| 2048 | 28.3 | 0.002 | 0.0004 | 1.05 | 0.0014 | 16.01 | 41.2 | 1.820 |
| 4096 | 132 | 0.004 | 0.0008 | 4.25 | 0.0029 | 64.03 | 102 | 4.234 |
| 8192 | 605 | 0.008 | 0.0015 | 19.76 | 0.0063 | 256.06 | 232 | 9.969 |
| 16384 | 2503 | 0.018 | 0.0037 | 84.51 | 0.0129 | 1024.1 | 541 | 23.81 |
| 32768 | 10269 | 0.032 | [symbol] | 352.8 | 0.0246 | 4096.3 | 667 | 57.63 |
| 65536 | 44580 | 0.053 | [symbol] | 1422.9 | 0.0497 | 15385 | 1249 | 141.3 |

It is inevitable that the times expended in each step depend on the input data; simple time series with little variation take shorter times to process, while those spanning a wide frequency band would take longer times. The walking example belongs to the latter, so it takes longer to process than the average case. Similarly, the size of the compressed values depend on the particular example.

Using the same treadmill walking example above, the time series are different due to different data sizes. Moreover, it is hard, if not impossible, to determine an exact complexity for compression time, basis size and compressed size, as they involve various processes conditionally. Nevertheless some numerical analysis of the numbers were performed in the table to estimate the complexities. They are reported in the following paragraphs, with plausible explanations:

From Table 2, it can be seen that the times taken for preparation is approximately O(N²), because there are O(N) PCS's and each PCS takes O(N) to compute its basis values. The retrieval time is negligible, being dependent on file access and transmission rate and the position of the file on the media. The pre-processing is made up of an FFT on the original data and a quick sort on the FFT, each taking O(N log N) time. The quick sort may take O(N²) in the worst case; the unexpectedly long preprocessing times for large N, shown in bold italic in Table 2, are due to a bad case performance in quick sort.

It takes approximately O(N²) to generate compressed values, because it is done by running over a fraction of the N PCS's and performing linear-time expansion and accumulation for each PCS. The time taken to generate the uncompressed ST values is only slightly greater, because the decompression by FFT is very fast.

The time for finding a single compressed local spectrum, which involves expansion and accumulation, is O(/V) as the two processes are linear. To generate the local spectrum, decompression by FFT is needed, so the time is somewhere between O(N) and O(N log N).

The size of the Basis File is O(N log N), since it contains O(N) PCS's, each having O(log N) numbers. But if ν_{q,n} values discussed above are included into the basis file, it will get close to O(N²) for large N, making the file huge. So when N is large, they should preferably not be included, causing a drop in the trend of file size increase, shown in bold in the table.

For the compressed entire ST values, its size is somewhat greater than O(N log N). There are N time units, each encoded by O(log N) nodes and some low-frequency ST values. This is high compression compared to the original size 8N(N/2−1) bytes of entire ST for n=0, 1, . . . , N−1 and k=0,1, . . . , N12 −1.

In Table 3 below, the crucial parameters ε, η, γ, μφ, β are adjusted for the treadmill example with data size of 4096. The first row uses the default values, while each of the other rows has only the indicated parameter changed, the rest being defaults.

TABLE 3

| | Processing Time in seconds | | | | |
|---|---|---|---|---|---|
| | | Compressed | | Size in MB | |
| | | Entire | Local | | Compressed |
| Parameter | Prepare | ST Values | Spectrum | Basis | Entire |
| Setting | Basis | (Use Case I) | (Use Case II) | File | ST Values |
| Default | 132 | 4.25 | 0.0029 | 102 | 4.234 |
| ε = 0.75 | 116 | 3.65 | 0.0025 | 88 | 4.234 |
| η = 2.4 | 106 | 5.69 | 0.0033 | 233 | 7.859 |
| γ = 2 | 132 | 2.07 | 0.0019 | 79 | 4.234 |
| μ = 3 | 132 | 3.56 | 0.0025 | 83 | 3.484 |
| υ = 256 | 76 | 4.43 | 0.0032 | 47 | 4.234 |
| φ = FALSE | 132 | 5.98 | 0.0036 | 186.7 | 4.234 |
| β = 30 | 132 | 3.30 | 0.0022 | 102 | 4.234 |

Accuracy

As shown in FIG. 3, the effects of the settings of the more crucial parameters on the accuracy, for data size N=256 are demonstrated. To do this, the local spectra for all times with n=0, 1, . . . , N−1 are found by running the steps discussed above repeatedly. The decompressed compressed ST results. It is compared with the exact ST values found by (4), using the diff plot and graphs.

The treadmill example discussed above with the window size of 256, running on IMAC at 2.8 GHz is used. The results for those parameters that affects the accuracy considerably: ε, η, γ, μ, φ, β are only compared.

Based on these results, a proposed strategy for improving accuracy depends on the objective: To achieve low-frequency accuracy, try larger η like 1.2, and to get accuracy just below f=0.5, set φ to FALSE. If the time series have complicated spectral decomposition, then choose β=0 to involve every Fourier coefficients; for simple cases, use larger β like 30 to only use the most prominent 70%.

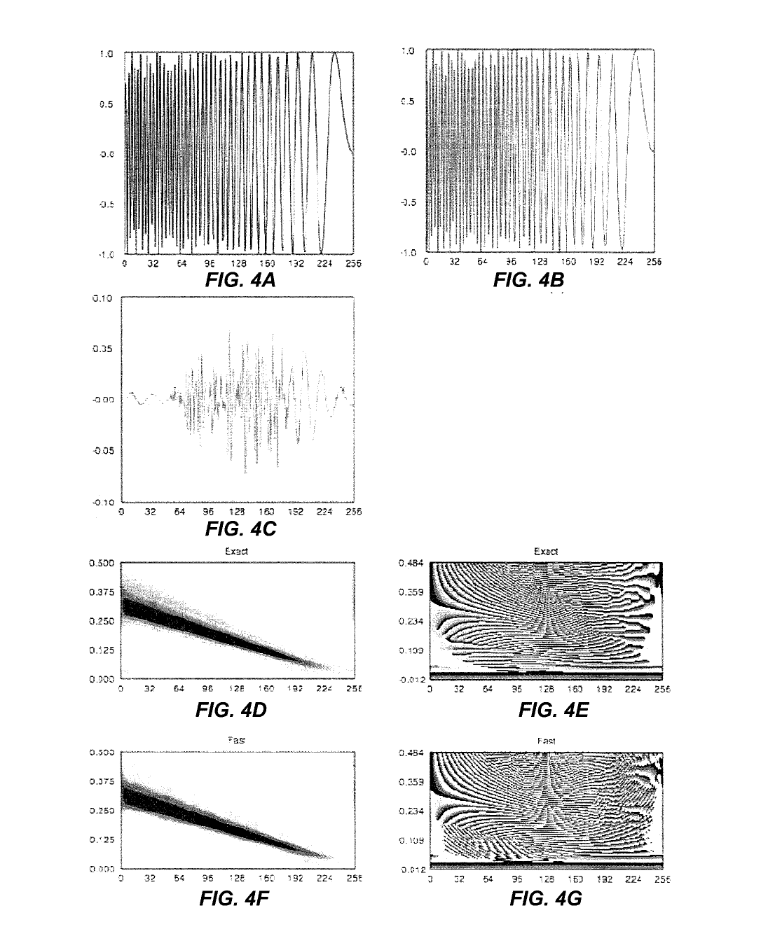

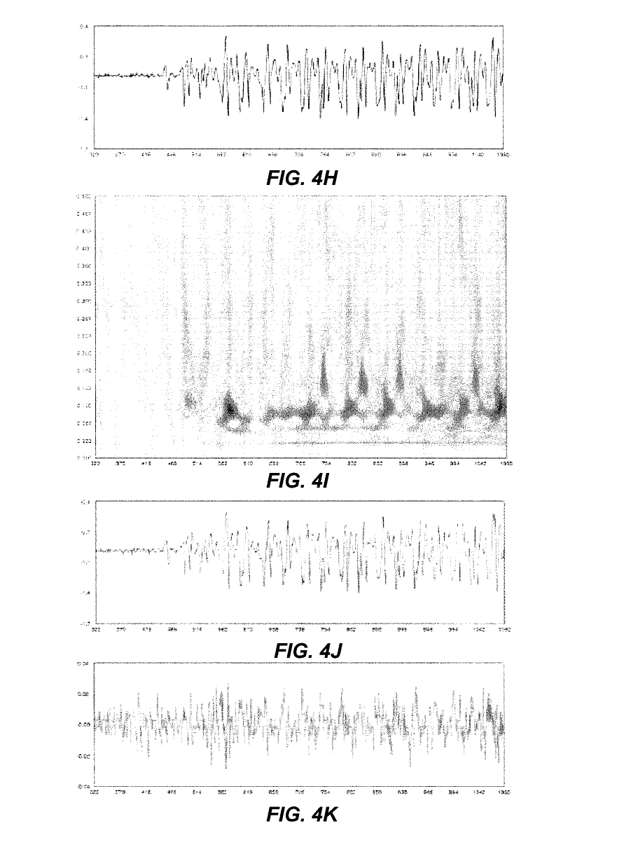

Referring now to FIGS. 4(a)-(g), additional illustrations of accuracy for magnitudes and phases are shown. FIG. (4) is a graph of an original chirp signal. FIG. 4(b) is a graph of the original chirp signal of FIG. 4(a) and the signal generated from compressed values by inverse ST. FIG. 4(c) is a graph of the error between the original and recreated signals of FIG. 4(b) magnified 10×. FIGS. 4(d) and (e) are graphs of the exact ST magnitudes and phases, respectively. FIGS. 4(f) and (g) are graphs of the ST magnitudes and phases by FTFT-1D as discussed herein, respectively. Thus, FIGS. 4(a)-(g) demonstrate that FTFT-1D as discussed herein provides tradeoffs between efficiency and accuracy because the figures show that FTFT-1D gives ST magnitudes very accurately, but ST phases less so. This is sufficient because in most applications the user is only interested in the magnitudes.

Referring now to FIGS. 4(h)-(k), additional illustrations for accuracy are shown. FIG. 4(h) is a graph of an original signal (i.e., part of a 4096-long signal). FIG. 4(i) is a graph of the ST by FTFT-1D of the signal in FIG. 4(h). FIG. 4(j) is a graph of the signal of FIG. 4(h) and the signal generated from compressed values by inverse ST. FIG. 4(k) is a graph of an error signal between the signals of FIG. 4(j) magnified 16×.

Accuracy Measurement by Inverse S-Transform

By Inverse S-Transform, the original time series from the ST values are obtained. This can be done by virtue of the theorem that the mean of ST voice at a frequency is equal to the FT at that frequency:

$$H [ k ] = \frac{1}{N} {\sum }_{n = 0}^{N - 1} S [ n , k ] , \qquad ( 35 )$$

so the time series can be recovered by IFT.

FIGS. 4(a)-(g) show that if Inverse S-Transform is applied to the ST values generated by FTFT-1D methods provided herein, then the time series values obtained are almost identical to the original time series, with very small errors. This again confirms that FTFT-1D is highly accurate.

Conclusion—FTFT-1D

As discussed herein, FTFT-1D methods provide a fast and direct technique to generate the compressed form of ST values reducing the size from O(N²) to O(N log N), which is good for analysis because the time-frequency information is uniformly encoded. It also presents the instantaneous real-time computation of local spectra for real-time visualization and processing. Both are accurate, robust, adaptive, and using little memory, especially good for long time series.

The methods do not strain memory requirements much, and are robust with the same parameter settings that work for all cases. It is adaptive, maximizing its efficacy according to the distribution of frequencies in the data. It employs a number of techniques to increase its speed, including the preparation of some non-redundant basis values, saved in a basis file, that needs be done only once for each particular applications Unlike the subset approaches, it can determine the ST value for any frequency accurately.

The methods rely on special compression techniques that achieves Uniform Information Encoding (UIE): less important information is compressed more so that the amount of useful information per byte is uniform in the compressed data. The actual ST values are non-uniform, in the sense that they tend to have smaller time resolution at lower frequencies and smaller frequency resolution at high frequencies. Hence, in some applications like feature extraction and segmentation, it might be better to use for analysis the UIE-compressed than the original ST values.

FTFT-2D Pixel

Methods

Transforms

Transforms are defined above with regard to FTFT-1D methods provided herein. It should be understood that a number of these transforms are again provided below with regard to discussion of FTFT-2D methods.

Discrete S-Transform

The discrete ST of a time series h[n] of size Nis a TFR given by the frequency-domain formula (36):

$$S [ n , k ] = \{ \begin{matrix}{\sum }_{κ = 0}^{N - 1} H [ κ + k ] {e}^{2 {π}^{2} {κ}^{2} / {k}^{2}} {e}^{i2πκ n / N} i f k \neq 0 \\ \frac{1}{N} {\sum }_{j = 0}^{N - 1} h [ j ] if k = 0\end{matrix} , \qquad ( 36 )$$

where n and k are the time and frequency indexes (k=Nf, where f is the frequency). H[k] is the Fourier Transform (FT) of h[n] . As discussed above, square brackets are used herein to represent discrete functions of integers.

Discrete TT-Transform

The TT-transform (TT) is the Inverse Fourier Transform (IFT) of ST. The TT is shown in (37):

$$T [ n , m ] = {\sum }_{k = 0}^{N - 1} S [ n , k ] {e}^{i2π km / N} , \qquad ( 37 )$$

where each of n, m is the time index going from 0 to N−1.

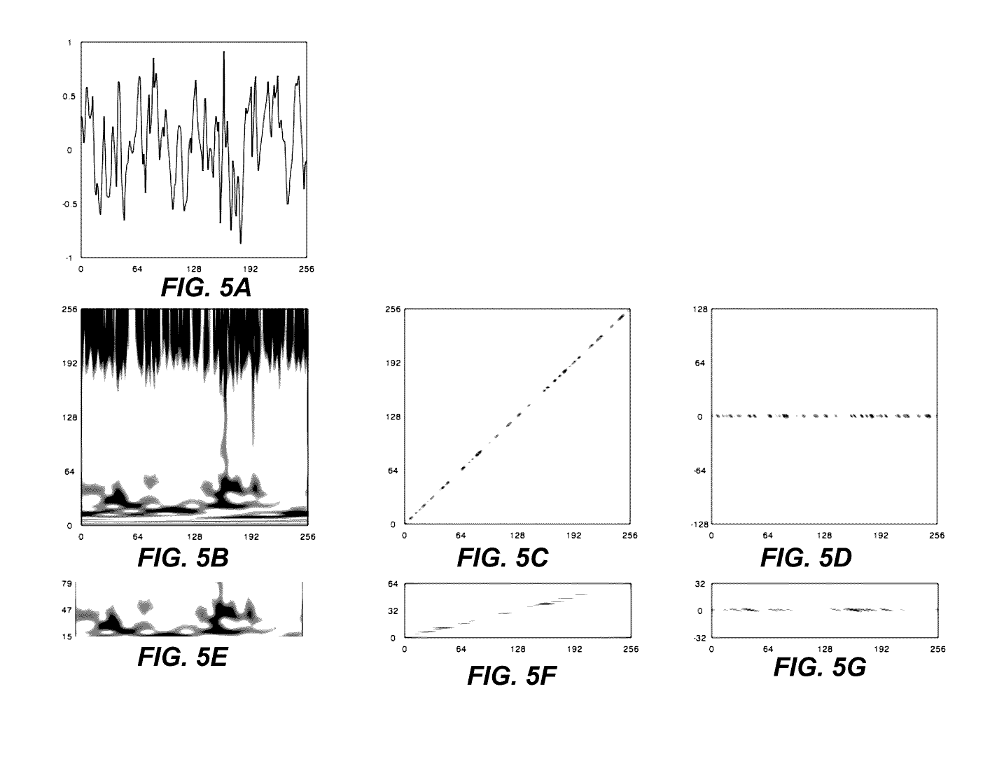

Referring now to FIGS. 5(a)-(g), diagrams illustrating the various ST, TT and Offset TT-Transform (OTT) values for a random time series or signal h[n] are shown. FIG. 5(a) illustrates the random time series or signal h[n]. FIG. 5(b) illustrates magnitude of the ST of the signal, with frequency index k along the vertical axis. (White=0, Black=0.17). FIGS. 5(c) and (d) illustrate magnitudes of TT and OTT, with m along the vertical axis. (White=0, Black=38.16). FIG. 5(e) illustrates a portion of FIG. 5(b) for frequency index taking 64 values from 15-78. (White=0, Black=0.17). FIGS. 5(f) and (g) illustrate magnitudes of BTT and OBTT. (White=0, Black=5.11).

FIG. 5(c) illustrates that the TT values are concentrated along the diagonal m=n, attenuating moving away from it. These characteristics are discussed in detail below. There is also the wrapping effect, as manifested near the top left and bottom right corners. This comes from TT [n, m+N]=TT [n, m]. The wrapping imposes some burden and overhead in the implementation of the methods discussed herein. To eliminate the wrapping and to offset the vertical shift of distance n at time index n, the Offset TT-transform (OTT) is introduced. They are defined by:

O[n,m]=T[n,(m+n+N)modN], (38)

where m goes from −N/2 to N/2−1. Then these OTT will cluster around the horizontal line m=0 as shown in FIG. 5(d).

Let B be the frequency band between frequency indexes a and b inclusive, given by the set B={a, a+1, a+2, . . . , b}. It has size N′=b−a+1. Then the Banded TT-Transform (BTT) of a time series with respect to B is obtained by first finding the ST of the time series, forming a subset of ST within B, and translating it by −a so that its frequency index now goes from 0 to N′. Then BTT is the IFT (of size N′) of this new ST:

$${T}_{B} [ n , m ] = {\sum }_{k = 0}^{{N}^{′} - 1} S [ n , k + a ] {e}^{i2π km / {N}^{′}} , \qquad ( 39 )$$

where m goes from 0 to N′−1. FIG. 5(f) shows that it has similar property as TT. Like OTT, the Offset Banded TT-Transform (OBTT) is defined by:

$${O}_{B} [ n , m ] = {T}_{B} [ n , ( m + \frac{{nN}^{′}}{N} + {N}^{′} ) {mod N}^{′} ] , \qquad ( 40 )$$

where m goes from −N′/2 to N′/2−1. FIG. 5(g) shows that it has similar property as OTT.

Pure Complex Sinusoid

A discrete Pure Complex Sinusoid (PCS) of size N and frequency index q (with q=0, 1, . . . , N−1) is defined as a complete time series u_{q}[n]=e^{i2πqn/N}, for n=0, 1, . . . , N−1.

The formula for IFT can be written in terms of PCS's:

$$h [ n ] = {\sum }_{q = 0}^{N - 1} H [ q ] {u}_{q} [ n ] \qquad ( 41 )$$

The FT of u_{q}[n] is obviously equal to: (Z is the set of integers)

$${U}_{q} [ k ] = \{ \begin{matrix}1 & if k = q + jN for some j ∈ Z \\ 0 & otherwise\end{matrix} \qquad ( 42 )$$

S-Transform of Pure Complex Sinusoid

The discrete ST of a PCS of frequency index q, written as S_{q}[n, k], can be computed by (36):

$${S}_{q} [ n , k ] = {\sum }_{κ = 0}^{N - 1} {U}_{q} [ κ + k ] {e}^{- 2 {π}^{2} {κ}^{2} / {k}^{2}} {e}^{i2πκ n / N} . \qquad ( 43 )$$

By (42),

$${S}_{q} [ n , k ] = \{ \begin{matrix}{e}^{- 2 {{π}^{2} ( q - k )}^{2} / {k}^{2}} {e}^{i2π ( q - k ) n / N} & if q \geq k \\ { }^{{e}^{- 2 {{π}^{2} ( q - k + N )}^{2} / {k}^{2}} {e}^{i2π ( q - k ) n / N}} & if q < k\end{matrix} \qquad ( 44 )$$

The second alternative sets K×q−k+N to make sure that K lies within the summation range.

Let f _{q}[k] be the magnitude of S_{q}[n , k] . For a fixed q, f _{q}[k] i4s clearly bell-shaped, resembling a Gaussian with standard deviation (“SD”) SD=q/2π. It can easily be proved that given a small positive number ε, the support interval for ε, defined as {k:f f_{q}[k]≧ε}, is bounded below by l_{q} and above by u_{q}, where

l_{q}=q/(l+d) and u_{q}=q/(l−d), (45)

with d=\sqrt{−logε/2π²}. So, the width of this support interval is proportional to q.

ST is linear, in the sense that given a number of time series, the ST of their linear combination is equal to the linear combination of their ST. The linearity applied to (41) gives:

$$S [ n , k ] = ST of h [ n ] = ST of {\sum }_{q = 0}^{N - 1} H [ q ] {u}_{q} [ n ] = {\sum }_{q = 0}^{N - 1} H [ q ] ( ST of {u}_{q} [ n ] ) = {\sum }_{q = 0}^{N - 1} H [ q ] {S}_{q} [ n , k ] , \qquad ( 46 )$$

showing that the set of S _{q}[n, k] with q=0, 1, . . . , N−1 is a linear basis for any ST.

TT—Transform of Pure Complex Sinusoid

The TT and OTT of a PCS of frequency index q are denoted by; T₁[n, m] and O_{q}[n, m]. By (37) and (44), it can be proven that

T_{q}[n,m]=e^{i2πqn/N}(IFT of f_{q}[k] evaluated at m−n), (47)

and O_{q}[n,m]=e^{i2πqn/N}(IFT of f_{q}[k] evaluated at m) (48)

For fixed q and fixed n, the magnitude of T_{q}[n, m], treated as a function of m, is near-Gaussian in shape, centered at m=n with SD=N/q. To prove it, f_{q}[k] is near-Gaussian with SD q/2π near k=q. Now, the IFT of a Gaussian is also a Gaussian with SD=N/2π (divided by the SD of the original Gaussian. Therefore, the magnitude of T_{q}[n, m] is near-Gaussian with SD=N/q, and is centered about m=n since the IFT is evaluated at m n. It follows that O_{q}[n, m] is also near-Gaussian functions of m clustering around the horizontal line m=0 with SD=N/q.

Since ST and IFT are linear and TT is their composition, TT is also linear. So by (41):

$$T [ n , m ] = TT of h [ n ] = TT of {\sum }_{q = 0}^{N - 1} H [ q ] {u}_{q} [ n ] = {\sum }_{q = 0}^{N - 1} H [ q ] ( TT of {u}_{q} [ n ] ) = {\sum }_{q = 0}^{N - 1} H [ q ] {T}_{q} [ n , m ] \qquad ( 49 )$$

showing that the set of T_{q}[n, m] with q=0, 1, . . . , N−1 is a basis for T[n,m]. Now, each T_{q}[n, m] is near-Gaussian centered around the diagonal, tailing off moving away from the diagonal. Therefore, T[n, m] of a general time series, being their linear combination, should have this property.

Banded TT—Transform of Pure Complex Sinusoid

The BTT of a PCS of frequency index q with frequency band B from a to b is:

$${T}_{B ; q} [ n , m ] = {\sum }_{k = 0}^{{N}^{′} - 1} {S}_{q} [ n , k + a ] {e}^{i2π km / {N}^{′}} \qquad ( 50 )$$

It can be proved that:

$${T}_{B ; q} [ n , m ] = {e}^{i2π ( q - a ) n / N} ( IFT of g [ k ] evaluated at m - \frac{{nN}^{′}}{N} ) \qquad ( 51 )$$

Here, g[k]=e^{-2π}^{₂}^{(q-k-a)}^{₂}^{/(k+a)}^{₂}. It can be shown that g[k] is approximately to g*[k]=e^{-2π}^{₂}^{(q-k-a)}^{₂}^{/q}^{₂}. Indeed they are alike when k is near q−a, and are both small when k is far from q−a. Now, g*[k] is Gaussian with SD=q/2π about q+a. Hence, g[k] is near-Gaussian. But it is truncated to lie within the band B, so its IFT is near-Gaussian with SD=N′/2π divided by (q/2π)=N′/q. Therefore the magnitude of T_{B;q}[n, m] is near-Gaussian with SD=N′/q and is centered around the line m=nN′/N as it is evaluated at m−nN′/N. It follows that the OBTT of the PCS, O_{q;B}[n, m], is also near-Gaussian functions of m clustering around the horizontal line m=0 with SD=N′/q.

The BTT of a general time series is a linear combination of the BTT of PCS's for different q:

$${T}_{B} [ n , m ] = {\sum }_{q = 0}^{N - 1} H [ q ] {T}_{B ; q} [ n , m ] \qquad ( 52 )$$

As each T_{B;q}[n, m] is near-Gaussian around m=nN′/N, T_{B}[n, m] should have the same property.

Discrete 2D S-Transforms

The Discrete 2D S-Transform (2D ST) of an Nₓ ×N_{y} date set or image h[x, y] is a space-frequency representation]. It can be expressed as a nesting of two 1D ST:

$$S [ {n}_{x} , {n}_{y} , {k}_{x} , {k}_{y} ] = {\sum }_{{κ}_{x} = 0}^{{N}_{x} - 1} {A}_{y} [ {n}_{y} , {κ}_{x} + {k}_{x} , {k}_{y} ] {e}^{- 2 {π}^{2} {κ}_{x}^{2} / {k}_{x}^{2}} {e}^{{i2πκ}_{x} {n}_{x} / {N}_{x}} , \\ with {A}_{y} [ {n}_{y} , {k}_{x} , {k}_{y} ] = {\sum }_{{κ}_{y} = 0}^{{N}_{y} - 1} H [ {k}_{x} , {κ}_{y} + {k}_{y} ] {e}^{- 2 {π}^{2} {κ}_{y}^{2} / {k}_{y}^{2}} {e}^{{i2πκ}_{y} {n}_{y} / {N}_{y}} \qquad ( 53 )$$

Here, H[kₓ, k_{y}] is the 2D Ft. So, S[nₓ,n_{y},kₓ,k_{y}] measures the content of the 2D frequency index [kₓ, k_{y}] at the pixel [nₓ, n_{y}]. By Nyquist Theorem, a user may only be interested in finding 2D ST for frequencies fₓ and f_{y} from 0 to ½, i.e. for frequency indexes kₓ=0, 1, . . . , Nₓ/2−1, and k_{y}=0, 1, . . . , N_{y}/2−1.

The above equations work when kₓ, k_{y} are positive. If kₓ is positive and kₓ is zero,:

$$S [ {n}_{x} , {n}_{y} , {k}_{x} , 0 ] = {\sum }_{{κ}_{x} = 0}^{{N}_{x} - 1} {A}_{y} [ {κ}_{x} + {k}_{x} ] {e}^{- 2 {π}^{2} {κ}_{x}^{2} / {k}_{x}^{2}} {e}^{{i2πκ}_{x} {n}_{x} / {N}_{x}} , \\ where {A}_{y} [ {k}_{x} ] = \frac{1}{{N}_{x} {N}_{y}} {\sum }_{{n}_{x} = 0}^{{N}_{x} - 1} {\sum }_{{n}_{y} = 0}^{{N}_{y} - 1} h [ {n}_{x} + {n}_{y} ] {e}^{- {i2πk}_{x} {n}_{x} / N} \qquad ( 54 )$$

For kₓ zero and k_{y} positive, S[nₓ, n_{y}, 0, k_{y}] like (54) is given, with subscripts x, y interchanged. If both kₓ and k_{y} are zero, the zero voice is simply the overall mean of h:

$$S [ {n}_{x} , {n}_{y} , 0 , 0 ] = \frac{1}{{N}_{x} {N}_{y}} {\sum }_{{n}_{x} = 0}^{{N}_{x} - 1} {\sum }_{{n}_{y} = 0}^{{N}_{y} - 1} h [ {n}_{x} , {n}_{y} ] . \qquad ( 55 )$$

It can be seen that S[nₓ, n_{y}, kₓ, 0] is independent of nₓ, S[nₓ,n_{y},0,k_{y}] is independent of n_{y}, whereas S[nₓ,n_{y}, 0,0] is constant for all nₓ, n_{y}.

Although FT can be found by Fast FT (FFT), these equations are good only when all the 2D ST for all pixels need to be found: It still takes O(Nₓ² N_{y}²log NₓN_{y}) to find them and too much to store all of them. FTFT-2D methods discussed herein avoid using these equations directly.

Local Spectrum and Texture Curve

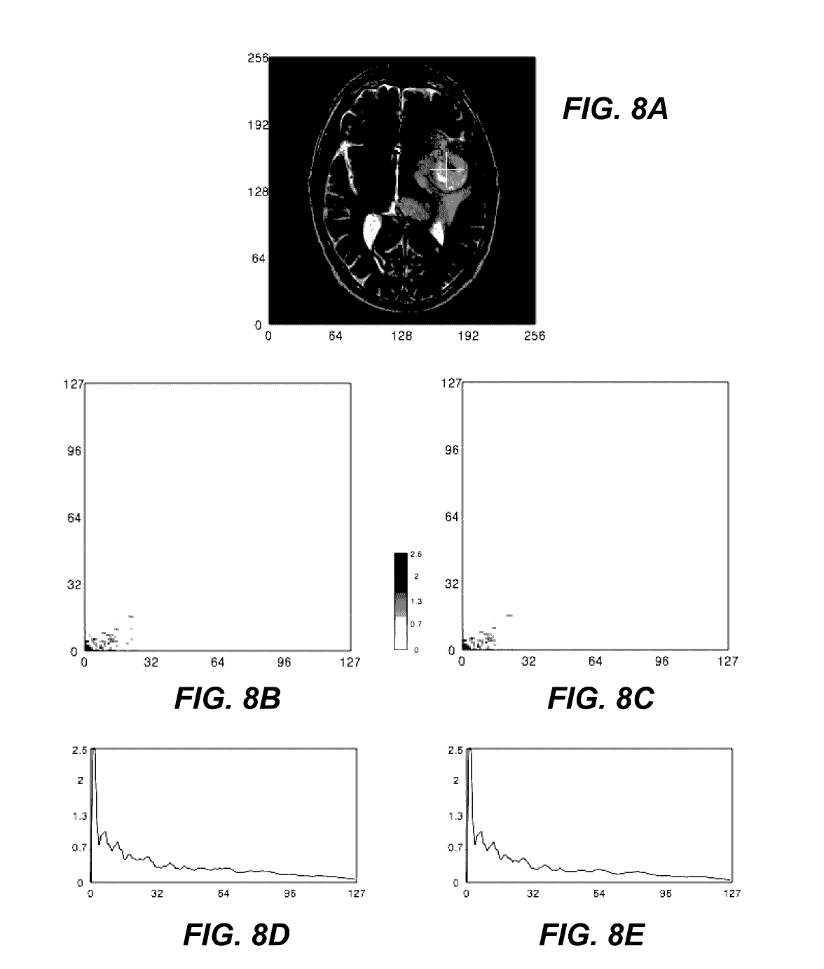

For a given pixel [nₓ, n_{y}] in the image, equations (53) to (55) give the complex values of 2D ST. In practice, users may only be interested in their magnitude (modulus), called local spectrum, at the pixel. It is a discrete real function of kₓ, k_{y} in the 2D k-space, so it consists of NₓN_{y}/4 real values. The local spectrum can be plotted in the k-space using some gray scale, as shown in FIG. 8(b), which is discussed in detail below.

In some applications with Nₓ=N_{y} (=N), it is possible to average the radial components of the magnitudes in polar coordinate system:

$${R}_{r} [ {n}_{x} , {n}_{y} , r ] = \frac{{Σ}_{round ( \sqrt{{k}_{x}^{2} + {k}_{y}^{2}} ) = r} \vert S [ {n}_{x} , {n}_{y} , {k}_{x} , {k}_{y} ] \vert}{{Σ}_{round ( \sqrt{{k}_{x}^{2} + {k}_{y}^{2}} ) = r} 1} \\ for r = 0 , 1 , … , N / 2 ; \qquad ( 56 )$$

Here, the summation is over all the points (kₓ, k_{y}) in the k-space with distance r from the origin, i.e. within the circular arc of radius r in the quadrant of FIG. 8(b), which is discussed in detail below. In the averaging, the norm-1 is employed, which is more robust as it is less affected by large 2D ST values. For each pixel (nₓ, n_{y}), the graph of Sₓ[nₓ, n_{y}, r] against r is called the texture curve. It is shown in FIG. 8(d), which is discussed in detail below.

2D Pure Complex Sinusoids

A 2D discrete Pure Complex Sinusoid (2D PCS) of x- and y-frequency indexes qₓ and q_{y} (with qₓ=0, 1, . . . , Nₓ1 and q_{y}=0, 1, . . . , N_{y}1) is defined as a 2D Nₓ×N_{y} data set:

u_{q}_{ₓ}_{q}_{_{y}}[nₓn_{y}]=e^{i2πq}^{ₓ}ⁿ^{ₓ}^{/N}^{ₓ}e^{i2πq}^{_{y}}ⁿ^{_{y}}^{/N}^{_{y}}, (57)

for nₓ=0, 1, . . . , Nₓ−1 and n_{y}=0, 1, . . . , N_{y}1. It is clearly a product of 1D PCS in x and 1D PCS in y:

u_{q}_{ₓ}_{q}_{_{y}}[nₓ, n_{y}]=u_{q}_{ₓ}[nₓ]u_{q}_{_{y}}[n_{y}] (58)

From the formula for 2D IFT:

$$h [ {n}_{x} , {n}_{y} ] = {\sum }_{{k}_{x} = 0}^{{N}_{x} - 1} {\sum }_{{k}_{y} = 0}^{{N}_{y} - 1} H [ {k}_{x} , {k}_{y} ] {e}^{i2π ( {k}_{x} {n}_{x} / {N}_{x} + {k}_{y} {n}_{y} / {N}_{y} )} , \qquad ( 59 )$$

and from (57):

$$h [ {n}_{x} , {n}_{y} ] = {\sum }_{{q}_{x} = 0}^{{N}_{x} - 1} {\sum }_{{q}_{y} = 0}^{{N}_{y} - 1} H [ {q}_{x} , {q}_{y} ] {u}_{{q}_{x} , {q}_{y}} [ {n}_{x} , {n}_{y} ] \qquad ( 60 )$$

Finding Local Spectrum at a Pixel

Process Flow

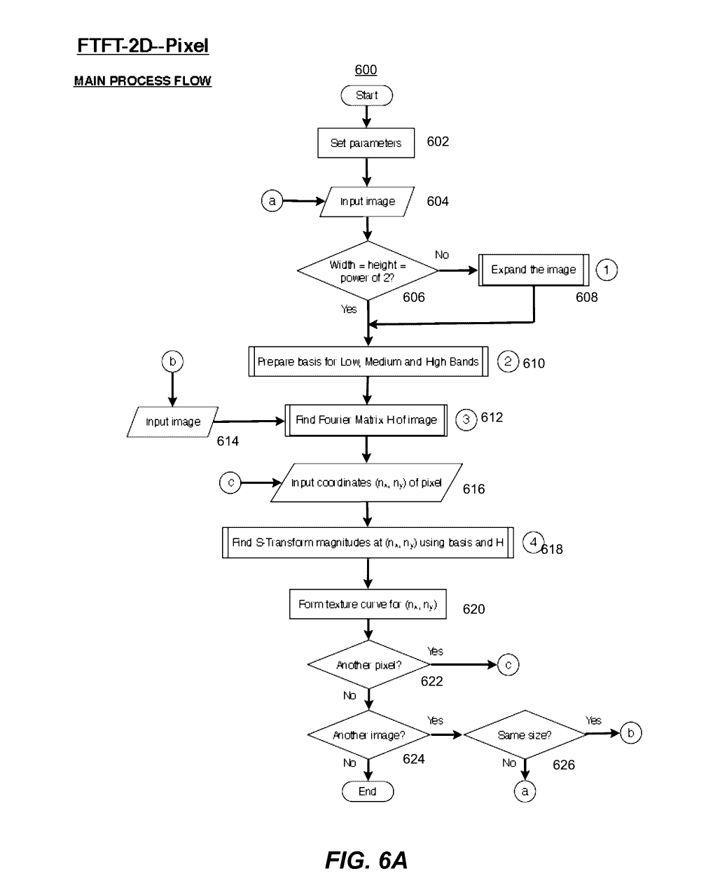

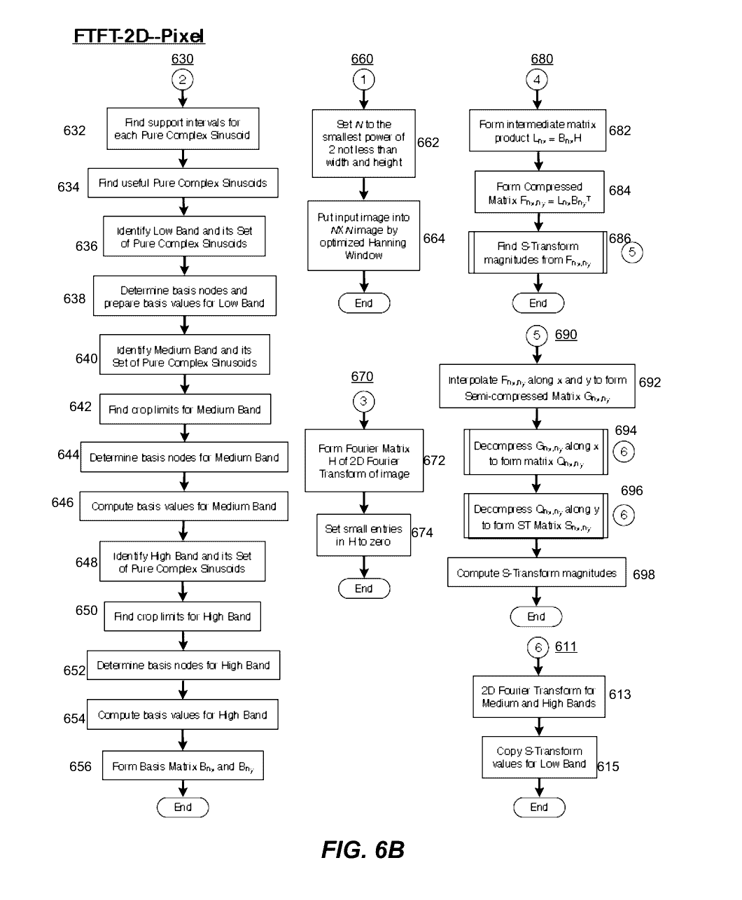

Referring now to FIGS. 6A-6B, flow diagrams illustrating example operations 600, 610, 620, 630, 660, 670, 680, 690 for obtaining 2D ST magnitudes at each pixel in an image are shown (i.e., FTFT-2D Pixel methods for ST).

At 602, parameters are set, if the parameters are to be different than defaults. At 604, a monochromic Nₓ×N_{y} image is input. At 606, a determination is made as to whether Nₓ=N_{y}=power of 2 (i.e., if Nₓ=N_{y}=2^{M} for some integer M, then set N=2^{M}). If yes, operations proceed to 610, which is discussed below. If no, at 608, the image is expanded. For example, operations 660 in FIG. 6B illustrate sub-operations for expanding the image. At 662, the smallest integer M such that Nₓ≦2^{M} and N_{y}≦2^{M} is found and N=2^{M} is set. Then, at 664, the image is put into an N×N image by optimized Hanning window.

At 610, basis is prepared. For example, Low, Medium and High Bands and the corresponding PCS Sets can be identified, and the basis nodes can be determined, and the basis values can be prepared for each band. Then, at 612, the image is pre-processed to find the Fourier Matrix H. At 616, the coordinates (nₓ, n_{y}) of the pixel whose local spectrum is to be found are input. At 618, the ST magnitudes at (nₓ, n_{y}) can be found using the basis values and Fourier Matrix H. For example, the ST magnitudes can be found according to sub-operations 680 and 690 are shown in FIG. 6B. At 682, Intermediate Matrix Lₙ_{ₓ}=Bₙ_{ₓ}H is formed, where Bₙ_{ₓ} is the matrix of basis values for nₓ is formed. At 684, Compressed Matrix Fₙ,n_{y}=Lₙ_{ₓ} Bₙ_{_{y}}^{T} is formed, where Bₙ_{_{Y}} is the matrix of basis values for n_{y} (and Bn_{y}^{T} is a transpose of matrix of basis values for n_{y}). At 686, it is possible to find ST magnitudes from Compressed Matrix Fₙ_{ₓ}, n_{y}.

For example, at 692, Interpolate Fₙ_{ₓ}, n_{y} along the x direction and then interpolate the result along the y direction to obtain Semi-compressed Matrix Gₙ_{ₓ}, n_{y}. At 694, Decompress Gₙ_{ₓ}, n_{y} along the x direction and then, at 696, decompress the result along the y direction to obtain Local Spectrum Matrix Sₙ_{ₓ}, n_{y}. At 698, it is then possible to compute ST magnitudes.

Returning to FIG. 6A, at 620, a texture curve for (nₓ, n_{y}) can be formed. At 622, if another pixel is to be processed, return to 616. At 624 and 626, if another image is to be processed, return to either 604 (when the image size N is different) or 614 (when the image size Nis the same).

Some of the above operations are discussed in more detail below. Note that the basis preparation (i.e., step 610), which is complicated and time consuming need be done once for all images of the same size. Also, the preprocessing need be done only once for all pixels in the same images.

Optimized Hanning Window

Preferably, the input image is square so that it is possible to form its Texture Curve, which is discussed below. Moreover, if it is not square, basis values can be prepared twice, for Nₓ and for N_{y}. Preferably, the image size is a power of 2, because FFT, which is used throughout the algorithm, is efficient for powers of 2.

If these two preferences are not both satisfied, then it is possible to form a blank square image of constant intensity h0 and size N (step 608) and place the input image centrally in it. To eliminate the ringing artifacts caused by the sudden change in intensity across the edges, the intensities can be modified near those edges by an optimized form of Hanning Window.

First use a parameter α between 0 and 1 to specify the extent of windowing. The new intensity at each pixel [nₓ, n_{y}] is computed as:

h * [nₓ,n_{y}]=hₒ+(h[nₓ, n_{y}]−hₒ)wₓ[nₓ]w_{y}[n_{y}], (61)

where wₓ[nₓ] and w_{y}[n_{y}] are Hanning Window along x and y directions:

$$( 62 ) \\ {w}_{x} [ {n}_{x} ] = \{ \begin{matrix}( 1 - cos ( 2 π {n}_{x} / α {N}_{x} ) ) / 2 & if {N}_{x} < N and {n}_{x} < α {N}_{x} / 2 \\ ( 1 - cos ( 2 π ( {N}_{x} - {n}_{x} ) / α {N}_{x} ) ) / 2 & if {N}_{x} < N and {n}_{x} > {N}_{x} - α {N}_{x} / 2 \\ 1 & otherwise\end{matrix} \} \qquad$$

(Similarly for w_{y}[n_{y}].) So, if α=0.5, only half of the input image along each direction (i.e. a quarter on each side) will be modified. The condition Nₓ<N is because windowing along x is not needed if Nₓ=N.

The windowing is optimized by choosing h0 to minimize the squared difference between the original input image and the modified one, i.e.

$${\sum }_{[ {n}_{x} , {n}_{y} ] ∈ I} {( {h}^{*} [ {n}_{x} , {n}_{y} ] - h [ {n}_{x} , {n}_{y} ] )}^{2} .$$

By partial differentiation with respect to h_{0,} obtain:

$${h}_{o} = {\sum }_{[ {n}_{x} , {n}_{y} ] ∈ I} ( h [ {n}_{x} , {n}_{y} ] {( {w}_{x} [ {n}_{x} ] {w}_{y} [ {n}_{y} ] - 1 )}^{2} / {\sum }_{[ {n}_{x} , {n}_{y} ] ∈ I} {( {w}_{x} [ {n}_{x} ] {w}_{y} [ {n}_{y} ] - 1 )}^{2} . \qquad ( 63 )$$

By this step, it can be assumed that Nₓ=N_{y}=N, and that N is a power of 2.

Determining Basis Nodes and Preparing Basis Values

Example operations 630 for determining basis nodes and preparing basis values are shown in FIG. 6B. First prepare the basis for 1D frequency space. The basis depends on N but not on the image. Then input an image and use the basis to compute the ST for each pixel in that image.

The 1D frequency space will be divided into Low, Medium and High Bands: L, M, H. These bands may be disjoint or overlapping, but their union must cover the range of frequency index k from 0 to N/2−1. A slight overlap may help cover the poor values at the end of one band by the better values at the end of the adjacent one. Preferably, make Low and Medium Bands overlapping, and Medium and High ones disjoint.

Corresponding to each band, we can find the PCS Sets Q^{L}, Q^{M}, Q^{H} of those values of q whose PCS contributes to that band. Three integer parameters μ^{L}, μ^{M}, μ^{H} can be specified, and the numbers m^{L}=μ^{L}, m^{M}=2^{μ}^{_{M}}+1, m^{H}=2^{μ}^{_{H}}+1 can be used as the node counts for each band. So, m^{M} and m^{H} are odd. Next, the nodes are determined and their basis values are prepared using the corresponding PCS Set. They together will form a 1D basis. The total size of the basis, M, is the sum of the node counts in each band: M=m^{L}+m^{M}+m^{H}.

Finding Support Intervals for each Pure Complex Sinusoid

At 632, support intervals for each PCS can be found. Many of the S_{q}[n, k] values are relatively small in magnitude. By ignoring them, it is possible to speed up the process. Use parameter as the minimum magnitude to keep. For each q, only consider those frequency indexes lying between l_{q} and u_{q} given by (45).

Finding Useful Pure Complex Sinusoids

At 634, useful PCSs are found. As users are interested in ST values for k=0, 1, . . . , N/2−1, it is only necessary to have to use those PCS's whose support interval overlaps with the interval [0, N/2−1]. Define qₘₐₓ the largest values of q for which the lower bound l_{q} is below N/2. Then confine to those PCS's with q=0, 1, . . . , qₘₐₓ; the other q's do not contribute significantly to the results. The number of useful PCS's is denoted as P=qₘₐₓ+1.

Low Band

At 636, the low band is identified, as well as its set of PCSs. First, identify the range of frequency index k from 0 to ν^{L} as the Low Band. Its PCS Set is the set of q such that the support interval of q intersects with the Low Band:

Q^{L}={q : [l_{q},u_{q}]∩[0,ν^{L}]≠Ø}={q : l_{q}≦ν^{L}}. (64)

At 638, determine basis nodes and prepare basis nodes for the Low Band. For the Low Band, simply use the discrete 1D ST values because as discussed above, ST has narrow support interval for small q (with SD=q/2π), and hence only a small number of basis values are needed there. If the node count m^{L} is equal to ν^{L}+1, then simply put the jth node at frequency index kⱼ=j. Otherwise, subsample the ST values along the frequency axis. It has been found that the parabolic subsampling works better: the jth node is at frequency index kⱼ=cf+j, where c is such that the last node is at frequency index ν^{L}.

In both cases, let K={k_{J}: j=0, 1, . . . , m^{L}−1}. For each q in Q^{L}, it is only necessary to find the 1D ST values for those kⱼ in K lying between l_{q} and u_{q}.

Medium Band

At 640, identify the medium band, as well as its set of PSCs. The Medium Band has frequencies just above the Low Band. Set P^{M} and ν^{M} as the lower and upper limits of the Medium Band. Its PCS Set is:

Q^{M}={q : [l_{q},u_{q}]∩[ρ^{M}, ν^{M}]≠Ø}={q : l_{q}≦ν^{M} and u_{q}>ρ^{M}} (65)

For this Band, use the OBTT, O_{M;q}[n, m]. As discussed above, let a=ρ^{M}, b=ν^{M} and N′=ν^{M}−ρ^{M}+1. For FFT, its range N′ is better a power of 2.

At 642, find crop limits for the Medium Band. Because of the near-Gaussian and clustering properties of OBTT, it is possible to crop off those OBTT with large values of |m|. Let c_{q} be the crop limit for the PCS of some q, i.e. only those m satisfying |m|≦c_{q} are considerably large for use. As discussed above, c_{q} is inversely proportional to q. Let γ^{M} be the cropping parameter such that c_{q}=γ^{M}N′/q for all q. (If c_{q} exceeds N′/2, then we let it be N′/2.)

For the given parameter γ^{M}, it is possible to determine the value of c_{q} for each q≦qₘₐₓ. The maximum of all these can be called c_{q} as “maximum crop limit”, denoted by Cₘₐₓ.

At 644, determine basis nodes for the Medium Band. Even though m is restricted to be within [−c_{q}, c_{q}], there may still be many values of O_{M;q}[n, m] for each q and n. Sometimes it is desirable to subsample them to keep the basis size low. As the OBTT values are concentrated about the line m=0, there should be more subsampled points near the line. Therefore, a plausible subsampling method for m would be a geometric progression (GP).

The node count for the Medium Band, m^{M}, is common to all PCS's. So the common set C of the m^{M} values of m for the nodes is given by:

C={m : m=0or |m|=round(r^{j}), j=0,1, . . . , m^{M}−1}, (66)

where round( )means the nearest integer of a real number. The radix r is such that r^{m}^{_{M}}⁻¹=cₘₐₓ.

Then for a PCS of some q≦qₘₐₓ, determine a subset C_{q} of C given by:

C_{q}={m∈C : |m|≦c_{q}}. (67)

Then, finding only the OBTT values of that PCS for those m in C_{q} is needed.

If m^{M} is chosen too small, r will be close to 1, say 1.2. Then round(r^{j}) will be 1 for j=0, 1, 2. To avoid repetition in set C, allow the first few numbers in C to take consecutive integer values 1, 2, 3, . . . , etc. until j is so large that the repetition does not occur.

Finally, at 646, the basis values for the Medium Band are O_{M;q}[n, m] over all nodes m in C.

High Band

At 648, identify the High Band, as well as its set of PCSs. For the High Band, compute the OTT, O_{q}[n, m], because as discussed above, TT has narrow support interval for large q (with SD=N/q), and hence only a small number of basis values are needed there. For example, it is possible to only set its lower limit P^{H}, as its upper limit must be N/2−1. Usually, let P^{H}=ν^{M}+1. Its PCS Set is:

$${Q}^{H} = \{ q \text{:} [ {l}_{q} , {u}_{q} ] ⋂ [ {ρ}^{H} , \frac{N}{2} - 1 ] \neq Ø \} = \{ q \text{:} {u}_{q} > {ρ}^{H} \} \qquad ( 68 )$$

Next, and similarly as discussed above for the Medium Band, in 650-654, find crop limits for the High Band, determine basis nodes for the High Band and compute basis values for the High Band. Cropping and subsampling for the High Band can be performed similarly as for the Medium Band discussed above. The only differences are that OTT is used instead of OBTT, as the IFT for the entire frequency range is being found, and that γ^{H} and m^{H} are used, which play the similar roles as γ^{M} and m^{M}. Then, at 656, form Basis Matrix Bₙ_{ₓ} and Bₙ_{_{y}}.

Preprocessing to Find Fourier Matrix for the Image

Example operations 670 for finding a Fourier Matrix for the image shown in FIG. 6B. After preparing the 1D basis values in memory, an image can be input as discussed above. Preprocessing is performed on it. For example, at 672, form the Fourier Matrix H by 2D FFT of the image. This matrix will be used for finding ST at any pixel in the image.

The complex elements H[qₓ, q_{y}] in H measures the content of 2D frequency (qₓ, q_{y}) in the image. At 674, to speed up the matrix multiplication , specify a threshold β so that only those prominent H[qₓ, q_{y}] whose magnitude greater than or equal to β will take part in the multiplication. In other words, set small entries in H to zero. This parameter does not affect the creation of the basis.

Generating Compressed Local Spectrum Values for a Pixel

Compressed values can be computed by matrix multiplications as shown below.

Given a time series h[n], define a 1D Hybrid Transform (1D HT) ^{F}ₕ[n,m] by concatenating the basis values for the Low, Medium and High Bands in tandem along m:

$${F}_{h} [ n , m ] = \{ \begin{matrix}( subsampled ) ST of h in Low Band if m = 0 , 1 , … , {m}^{L} - 1 \\ \begin{matrix}( subsampled cropped ) OBTT of h in Medium \\ Band if m = {m}^{L} , … , {m}^{L} + {m}^{M} - 1\end{matrix} \\ \begin{matrix}( subsampled cropped ) OTT of h in High Band \\ if m = {m}^{L} + {m}^{M} , … , {m}^{L} + {m}^{M} + {m}^{H} - 1\end{matrix}\end{matrix} \qquad ( 69 )$$

where n=0, 1, . . . , N−1 and m=0, 1, . . . , M−1. The m in (69) is not the same as the m discussed above.

In particular, if h[n] is u_{q}[n], a PCS of some q, then Fₕ[n, m] becomes Fᵤ_{_{q}}[n, m]. For a fixed time n, Fᵤ_{_{q}}[n, m] can be written as Bₙ[m, q]. As m takes different M values and q takes different P values, the set of Bₙ[m, q] can be taken as an M×P matrix Bₙ, which will be called the basis matrix as its elements are the basis values discussed above.

Fₕ[n, m] is intrinsically linear in h: if h₁, h₂, . . . are time series and if a₁, a₂, . . . are constants, then:

Fₐ_{₁}ₕ_{₁}₊ₐ_{₂}ₕ_{₂}_{+. . .} [n, m]=a₁Fₕ_{₁}[n, m]+a₂Fₕ_{₂}[n, m]+. . . (70)

This is because its constituents ST, OBTT and OTT are linear, and the cropping and subsampling operations are also linear.

Now, operations are performed to go from 1 dimension to 2 dimension: Given Nₓ×N_{y} data set or image h[x, y], the 2D HT of h can be defined by nesting:

Fₕ[nₓ,n_{y},mₓ,m_{y}]=1D HT along x of (1HTalong y of h), (71)

where nₓ is fixed during 1D HT along y, and n_{y} and m_{y} are fixed during 1D HT along x.

In particular, if h[nₓ,n_{y}] is a 2D PCS, u_{q}_{ₓ}_{g}_{_{y}}[nₓ,n_{y}], for some qₓ, q_{y}, then its 2D HT can be written as a product of two 1D HT:

Fᵤ_{_{qx,qy}}[nₓ,n_{y},mₓ,m_{y}]=Fᵤ_{_{qx}}[nₓ,mₓ]Fᵤ_{_{qy}}[n_{y},m_{y}]. (72)

This is obvious because by (58), u_{q}_{_{x,qy}}[nₓ, n_{y}] is separable, so it is possible to separate the nested summation into a product of two separate summations in x and y.

The linearity (70) for 1D HT can be extended into 2D HT since nesting preserves linearity:

Fₐ_{₁}ₕ_{₁}₊ₐ_{₂}ₕ_{₂}_{+. . .} [nₓ,n_{y},mₓ,m_{y}]=aₗFₕ_{₁}[nₓ,n_{y},mₓ,m_{y}]+a₂Fₕ_{₂}[nₓ,n_{y},mₓ,m_{y}]+ (73)

Now, by (60), h is a linear combination of u_{qxqy}[nₓ,n_{y}]. So from (72) and (73):

$$\begin{matrix}{F}_{h} [ {n}_{x} , {n}_{y} , {m}_{x} , {m}_{y} ] = {\sum }_{{q}_{x} = 0}^{{N}_{x} - 1} {\sum }_{{q}_{y} = 0}^{{N}_{y} - 1} H [ {q}_{x} , {q}_{y} ] {F}_{{u}_{{q}_{x} , {q}_{y}}} [ {n}_{x} , {n}_{y} , {m}_{x} , {m}_{y} ] \\ = {\sum }_{{q}_{x} = 0}^{{N}_{x} - 1} {\sum }_{{q}_{y} = 0}^{{N}_{y} - 1} H [ {q}_{x} , {q}_{y} ] {F}_{{u}_{{q}_{x}}} [ {n}_{x} , {m}_{x} ] {F}_{{u}_{{q}_{y}}} [ {n}_{y} , {m}_{y} ] .\end{matrix} \qquad ( 74 )$$

Using the B notation introduced above, (74) can be rewritten as:

$$\begin{matrix}{F}_{h} [ {n}_{x} , {n}_{y} , {m}_{x} , {m}_{y} ] = {\sum }_{{q}_{x} = 0}^{{N}_{x} - 1} {\sum }_{{q}_{y} = 0}^{{N}_{y} - 1} H [ {q}_{x} , {q}_{y} ] {B}_{{n}_{x}} [ {m}_{x} , {q}_{x} ] {B}_{{n}_{y}} [ {m}_{y} , {q}_{y} ] \\ = {\sum }_{{q}_{x} = 0}^{{N}_{x} - 1} {\sum }_{{q}_{y} = 0}^{{N}_{y} - 1} {B}_{{n}_{x}} [ {m}_{x} , {q}_{x} ] H [ {q}_{x} , {q}_{y} ] {B}_{{n}_{y}} [ {m}_{y} , {q}_{y} ]\end{matrix} \qquad ( 75 )$$

Let Fₙ_{ₓ}_{,n}_{_{y}} be the M×M Compressed Matrix of the left-hand-side of (75), with mₓ and m_{y} taking M values. Let H be the P ×P Fourier Matrix of H[qₓ,q_{y}], with qₓ and q_{y} taking P useful values determined as discussed below. Let Bₙ_{ₓ} be the M×P Basis Matrix of Bₙ_{ₓ}[mₓ, qₓ], and Bₙ_{_{y}} be the M×P basis matrix of Bₙ_{_{y}}[m_{y},q_{y}]. Then, (75) can be expressed in matrix form:

F_{nx,ny}=Bₙ_{ₓ}HBₙ_{_{y}}^{T}. (76)

All matrices are complex-valued. From (69), the mth row in the matrix corresponds to only one band (Low, Medium or High Band), and only several PCS's (of frequencies q) are in the corresponding PCS Sets Q^{L}, Q^{M}, Q^{H}. So, there are only a few non-zero elements in each row, making the Basis Matrix sparse. Moreover, those elements are row-contiguous in the sense that they cluster together in a row.

(76) is done as two matrix multiplications as discussed below. It is possible to make use of the row-contiguous sparsity of Bₙ_{ₓ} to speed up the multiplication.

Forming Intermediate Matrix

First find the Intermediate Matrix Lₙ_{ₓ}=Bₙ_{ₓ}H. The fastest way is to iterate over the rows qₓ in H:

Initialize all elements of Lₙ_{ₓ} to 0
For each qₓ from 0 to qₘₐₓ

for each q_{y} from 0 to qₘₐₓ
if (qₓ, q_{y}) is prominent, then

for each Low, Medium or High Band

if qₓ is in the corresponding PCS Set, then

for each basis node mₓ in that Band

accumulate the product of Bₙ_{ₓ}[mₓ,qₓ] and

H[qₓ,q_{y}] into Lₙ_{ₓ}[mₓ,q_{y}]

The (mₓ, q_{y})th element of Lₙ_{ₓ} is denoted as Lₙ_{ₓ}[mₓ,q_{y}].

Forming Compressed Matrix

Then multiply Lₙ_{ₓ} to Bₙ_{_{y}}^{T} to form the Compressed Matrix Fₙ_{ₓ}, n_{y}. Again the fastest way is to iterate over the columns q_{y} in Lₙ_{ₓ}:

Initialize all elements of Fₙ_{ₓ}_{,n}_{_{y}} to 0

for each q_{y} from 0 to qₘₐₓ

for each Low, Medium or High Band

if q_{y} is in the corresponding PCS Set, then

for each basis node m_{y} in that Band

for each basis node mₓ in all the Bands

accumulate the product of Lₙ_{ₓ}[mₓ,q_{y}] and

Bₙ_{_{y}}[m_{y},q_{y}] into Fₙ_{ₓ}_{,n}_{_{y}}[mₓ,m_{y}]

The (mₓ, m_{y})th element of Fₙ_{ₓ},nₙ _{_{y}} is denoted as Fₙ_{_{x,ny}}[mₓ, m_{y}].

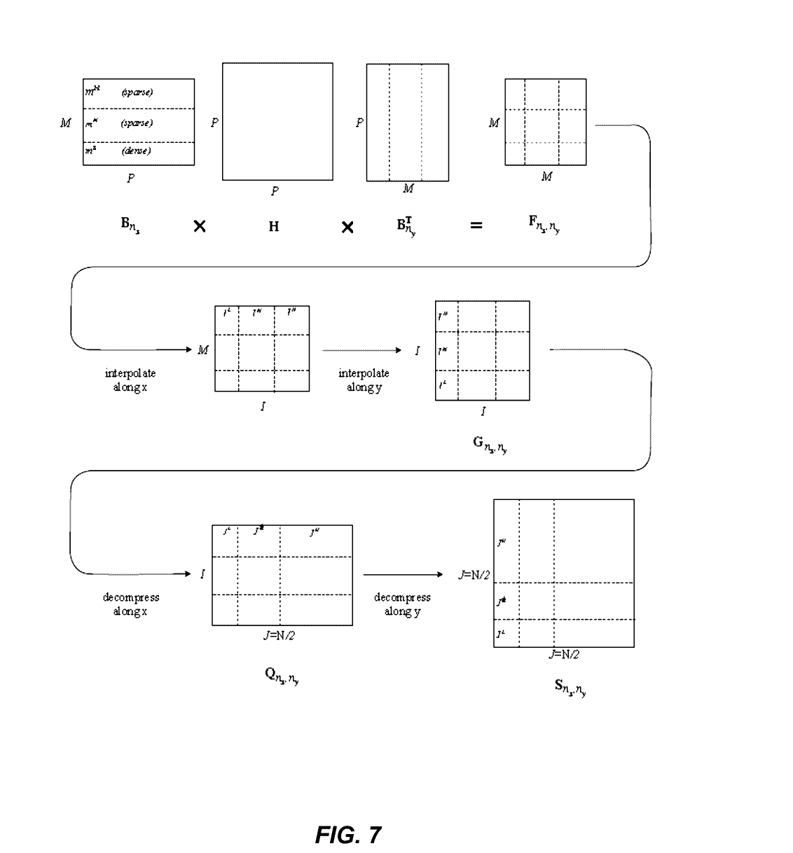

Referring now to FIG. 7, a flow diagram of the FTFT-2D Pixel algorithm is shown. As shown, the first row in FIG. 7 shows the Compressed Matrix Fₙ_{_{x,ny}} as a product of 3 matrices (Bₙ_{ₓ}, H, Bₙ_{_{y}}^{T}). The second and third rows illustrate the interpolation and decompression, which are discussed below. In FIG. 7, in the default setting, m^{L}=19, m^{M}=27, m^{H}=23, so M=69 and P=177. After interpolation, I^{L}=19, I^{M}=29, I^{H}=27, so the total is I=75. After decompression, J^{L}=19, J^{M}=29, J^{H}=80, so the total is J=N/2=128.

Generating Local Spectrum for an Image

As discussed above, the compressed form Fₙ_{ₓ}n_{y} of the local spectrum is produced at each pixel [nₓ, n_{y}] of the image. By (71) and (69), its elements are formed by nesting two 1D HT operations, which in turn contains some cropping followed by subsampling. So, it is possible undo these operations in reverse order to produce the matrix Sₙ_{_{x,ny}} of ST values S[nₓ, n_{y}, kₓ, k_{y}] at that pixel. These two steps are described below. (The steps do not find ST values for kₓ=0 or k_{y}=0. They can be found directly by (54) and (55).)

Interpolation to Form Semi-compressed Local Spectrum Values

It is possible to undo the subsampling in the nesting manner: First undo along x direction, and then undo the result along the y direction.

The subsampling is undone by filling in the missing points by simple linear interpolation, assuming that the variation is linear along the gap. Optionally, it is possible to use more sophisticated methods, like sinc interpolation to give slightly better results, but the benefits are outweighed by the extra processing time.

The result is an I×I Semi-compressed Matrix Gₙ_{_{x, ny}}, where I=I^{L}+I^{M}+I^{H} and I^{L}, I^{M}, I^{H} are the number of values in each band after expanding the subsamples.

For Medium and High Bands, interpolate separately the real and imaginary parts of OBTT or OTT. For the Low Band, only interpolate the magnitude of ST, because the real and imaginary parts oscillate along the frequency axis. If μ^{L} is equal to ν^{L}+1, the interpolation is not needed.

Decompressing to Form Local Spectrum

Example operations 611 for decompressing to form local spectrum are shown in FIG. 6B. Then, decompress Gₙ_{ₓ}, n_{y} along the x direction to form a matrix Rₙ_{ₓ}, n_{y} and then decompress this matrix along the y direction to obtain matrix Qₙ_{ₓ}, n_{y} of local spectrum, i.e. ST values, at P.

To do this, note that the interpolated values for Medium and High Bands are the OBTT and OTT values respectively, with some cropping. First undo the offsetting to get back the BTT or TT values, which are the IFT of the ST or a band limited ST. So, to get back the ST values, perform 2D FT for the Medium and High Bands at 613. Since (71) is formed from the semi-compressed values by nesting the OBTT or OTT operation, perform FFT in the nesting manner: First apply FFT along x direction, and then apply FFT to the result along the y direction. For the Low Band, at 615, simply copy the magnitudes obtained in the above section.

Results

There are 11 parameters. The default parameter setting that provides good combination of accuracy and speed for image sizes N=256 and N=512 (which are most common in medical images) are shown in Table 4. The values of ε, γ^{M}, μ^{M}, γ^{H}, μ^{H} and β are independent of N, while those of ν^{L}, μ^{M}, ν^{M} and η^{H} are proportional to N. They work well for all medical images we tested.

TABLE 4

| N | ε | ν^{L} | μ^{L} | ρ^{M} | ν^{M} | γ^{M} | μ^{M} | ρ^{H} | γ^{H} | μ^{H} | β |
|---|---|---|---|---|---|---|---|---|---|---|---|
| 256 | 0.05 | 18 | 18 | 15 | 46 | 5 | 13 | 47 | 6 | 22 | 0.002 |
| 512 | 0.05 | 36 | 36 | 30 | 93 | 5 | 13 | 94 | 6 | 22 | 0.002 |

Table 5 shows the times in seconds taken in different processes for image sizes 256 and 512:

TABLE 5

| | | | Computation | Computation |
|---|---|---|---|---|
| | Preparation | Preprocessing | of local | of local |
| Image | of basis for | of image for | spectrum | spectrum by |
| Size N | FTFT-2D | FTFT-2D | by FTFT-2D | exact formula |
| 256 | 0.279 | 0.008 | 0.012 | 0.206 |
| 512 | 2.151 | 0.035 | 0.037 | 1.608 |

The preparation of basis takes longer time but it is only done once for images of the same N. The preprocessing of an image is instantaneous. The time to find the local spectrum at a pixel by FTFT-2D is much shorter than that by the original frequency-domain formula.

Going from N=256 to N=512, the local spectrum computation time by the formula increases 8-fold, but that by FTFT-2D only increases 3-fold. This shows the efficiency of the algorithm.

Referring now to FIGS. 8(a)-(e), graphs illustrating results of ST by FTFT-2D Pixel methods provided herein as compared to exact ST are shown. As shown in FIGS. 8(a)-(e), the FTFT-2D Pixel methods discussed herein generate ST magnitudes that are good approximations to the true values obtained from the exact frequency-domain formula (53). For example, FIG. 8(a) illustrates a 256×256 MRI image of a diseased brain, with a white cross at pixel P(171,147). FIG. 8(b) illustrates local spectrum at P obtained by exact ST, with x and y frequency indexes on the axes. The scale is shown between FIGS. 8(b) and (c). FIG. 8(c) illustrates local spectrum obtained by FTFT-2D Pixel methods. Additionally, FIGS. 8(d) and (e) illustrate texture curves at P obtained by exact ST and FTFT-2D Pixel methods, respectively. As shown in FIGS. 8(d) and (e), the texture curve is also accurate. Actually, the magnitudes by FTFT-2D are less noisy, which may be a plus.

Conclusions—FTFT-2D Pixel

As discussed above, a fast and accurate technique, called FTFT-2D Pixel, to generate 2D ST magnitudes at each pixel in an image is presented. It facilitates medical image analysis especially for virtual biopsy.

FTFT-2D ROI

In addition to the FTFT-2D Pixel methods discussed above, it is possible to compute the 2D ST magnitudes and their statistics for a region of interest (ROI) in an image or for the entire image (i.e., FTFT-2D ROI). In many applications, a user may not be interested in the spectral content at a single pixel, as it varies from one pixel to the next especially for high frequencies. Instead, the user may be more concerned with the spectral distribution and statistics over an ROI in the image. To obtain the spectral distribution and statistics over an ROI, the local spectrum is individually found for each pixel in the image and then accumulated to obtain the statistics.

As discussed herein, the ROI may be one of the following types. The ROI can be a discrete set of points. For example, a pathology is manifested as isolated pixels with abnormal texture scattered over a medical image. Additionally, the ROI can be a curve along the fracture in a bone or a boundary of an anatomical structure. The ROI can also be a standard shape. For example, the ROI can be an area of standard shape like rectangle or circle. As discussed below, matrices are first computed for the bounding a rectangle of the ROI. So, it will be most efficient if the ROI is itself rectangular. The ROI can also be an irregular shape. The most common form of ROI is a general irregular shape, such as a tumor seen in a medical image. It is possible to find the statistics for the interior of tumor, or the complete tumor including the border. Additionally, the ROI can have holes, such as the penumbra of a lesion or the thick border of a tumor. In addition, the entire image can be treated as a particular case of ROI, but in this cases, its statistics are seldom found as it may include the untextured region outside the human body. The ROI can be a union of disjoint regions, e.g. for diseases where the abnormalities appear in different parts of the body.

In addition, the ST statistical results for an ROI may include mean, standard deviation (SD), minimum and maximum of ST magnitudes evaluated over the pixels in the ROI, etc.

Also, for each radius in the frequency space, it is possible to determine the radial components of the magnitudes at each pixel in the ROI, and hence obtain the statistics (mean, SD, minimum and maximum of ST magnitudes, etc.) of the radial component for each radius. The graph of mean radial components against the frequency is called the mean texture curve of the ROI. It should be understood that radial components are discussed above. For example, it is possible to find the distribution of ST along a line that runs from the interior to the exterior of a pathology to see how the texture changes as it crosses the border.

Process Flow

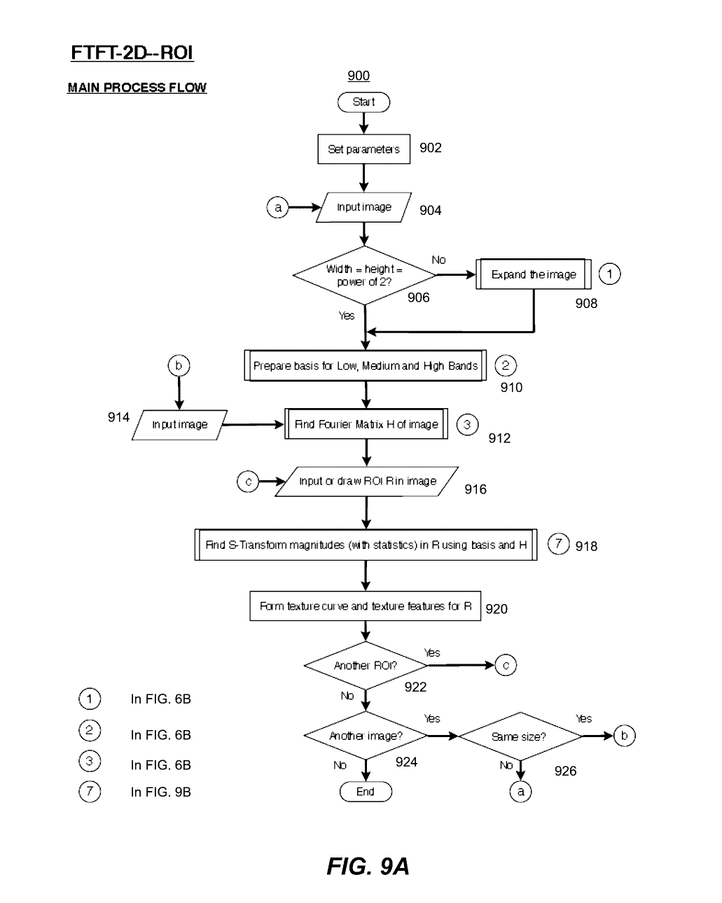

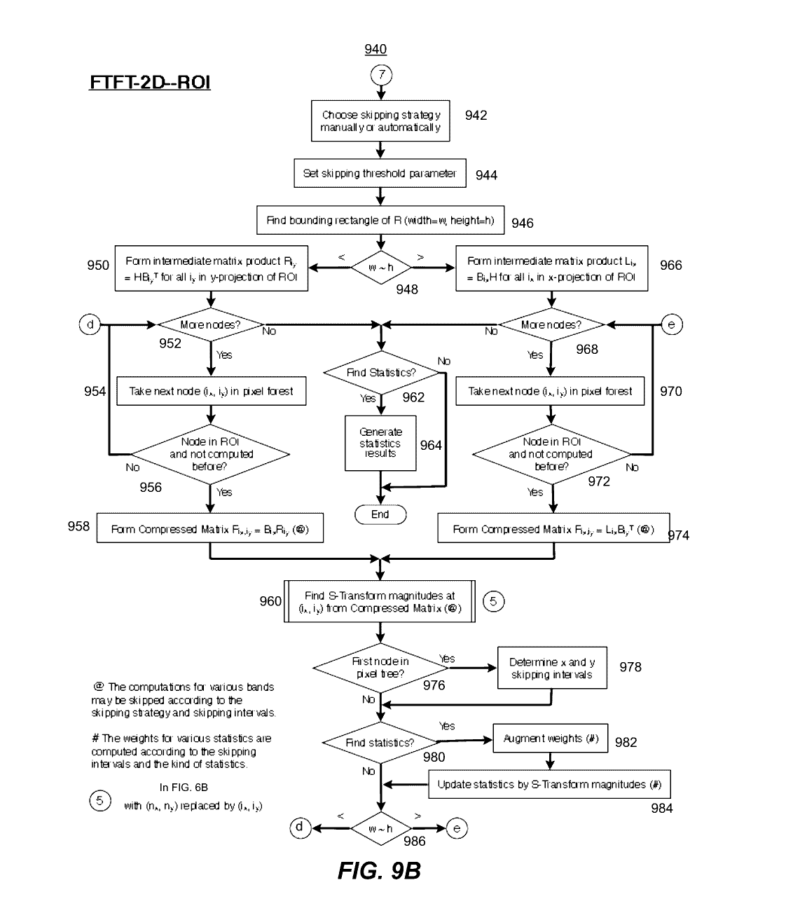

Referring now to FIGS. 9A-9B, flow diagrams illustrating example operations 900 and 940 for obtaining magnitudes and their statistics for a region of interest (ROI) in an image are shown (i.e., FTFT-2D ROI methods for ST).

At 902, parameters are set, if the parameters are to be different than defaults. At 904, a monochromic Nₓ×N_{y} image is input. At 906, a determination is made as to whether Nₓ=N_{y}=power of 2 (i.e., if Nₓ=N_{y}=2M for some integer M, then set N=2M). If yes, operations proceed to 910, which is discussed below. If no, at 908, the image is expanded. As discussed above, example operations 660 in FIG. 6B illustrate sub-operations for expanding the image.

At 910, basis is prepared. For example, Low, Medium and High Bands and the corresponding PCS Sets can be identified, and the basis nodes can be determined, and the basis values can be prepared for each band. . As discussed above, example operations 630 in FIG. 6B illustrate sub-operations for preparing basis. Then, at 912, the image is pre-processed to find the Fourier Matrix H. As discussed above, example operations 670 in FIG. 6B illustrate sub-operations for pre-processing to find the Fourier Matrix H. At 916, an ROI is input or drawn into the image. For example, the ROI can be input from a file or drawn manually. At 918, the ST magnitudes with statistics for the ROI can be found using the basis values and Fourier Matrix H.

Referring now to FIG. 9B, at example operations 940 illustrating sub-operations for finding the ST magnitudes with statistics for the ROI are shown. At 942, a skipping strategy is chosen. The skipping strategy can be chosen automatically or manually. Skipping strategies are discussed in detail below. At 944, the corresponding skipping threshold parameter is set. Then, at 946, the bounding rectangle of the ROI (i.e., width (w) and height (h)) are determined. At 948, a determination is made as to whether w is approximately equal to h. At 966, if the x-length of ROI is greater than its y-length, form intermediate matrix product Bᵢ_{ₓ}H for all iₓ in the x-projection of ROI. At 968, a determination is made as to whether more nodes exist. If no, skip to 962 and 964, where statistics are either found or generated. If yes, the Pixel Tree is traversed at 970. At 972 and 974, for each node (iₓ, iₜ), if it is in the ROI and not computed before, then multiply the matrix Bᵢ_{_{y}}^{T} of basis values for i_{y} to the intermediate matrix product on the right to form matrix Cᵢ_{ₓ}, i _{y} of compressed ST values for the pixel (iₓ, iₜ). It should be understood that computations for various bands can be skipped according to the skipping strategies and skipping intervals. Then, proceed to 960, which is discussed below.

Alternatively, at 9502, if the x-length projection of ROI is less than its y-length, form intermediate matrix product H Bᵢ_{_{y}}^{T} for all i_{y} in the y-projection of ROI. At 952, a determination is made as to whether more nodes exist. If no, skip to 962 and 964, where statistics are either found or generated. If yes, the Pixel Tree is traversed at 954. At 956 and 958, for each node (iₓ, iₜ), if it is in the ROI and not computed before, then multiply the matrix of basis values for i_{y} to the intermediate matrix product on the left to form matrix Cᵢ_{ₓ}i_{y} of compressed ST values for the pixel (iₓ, iₜ). It should be understood that computations for various bands can be skipped according to the skipping strategies and skipping intervals. Then, proceed to 960, which is discussed below.

Then, at 960, find ST magnitudes at pixel (ix, i_{y}) from the Compressed Matrix Cᵢ_{ₓ}, i_{y}. It should be understood that computations for various bands can be skipped according to the skipping strategies and skipping intervals. At 976, a determination is made as to whether the node is the first in the pixel tree. If yes, at 978, determine x and y skipping intervals and then proceed to 980. If no, proceed to 980. At 980, to find the statistics of the ROI, then for that node, augment the weights at 982 and update the statistics at 984. It should be understood that the weights for various statistics can be computed according to the skipping intervals and kind of statistics. At 986, a determination is made as to whether w is approximately equal to h. If w>h, return to 968. If w<h, return to 952.

Returning to FIG. 9A, at 920, a texture curve and texture features for the ROI can be formed. At 922, if another ROI is to be processed, return to 916. At 924 and 926, if another image is to be processed, return to either 904 (when the image size N is different) or 914 (when the image size N is the same).

Determining Bounding Rectangle

Let R be the set of pixels in an ROI, and let:

aₓ=min{x: (x,y)∈R}, a_{y}=min{y: (x,y)∈R}; (77)

bₓ=max{x: (x,y)∈R}, b_{y}=max{y: (x,y)∈R}. (78)

Then, the minimal bounding rectangle of an ROI is defined as the set of pixels: B=[aₓ, bₓ]×[a_{y}, b_{y}], where [a, b] represents the set of integers lying between a and b inclusive.

As discussed below, it is possible to form 2×2 squares at intervals of 2 along x and y directions if Skipping Strategy 1 or 2 are used. It is also possible to form 4×4 squares at intervals of 4 if Skipping Strategy 3 is used. The squares must start from the bottom left corner of the bounding rectangle, (or top left corner depending on the convention).

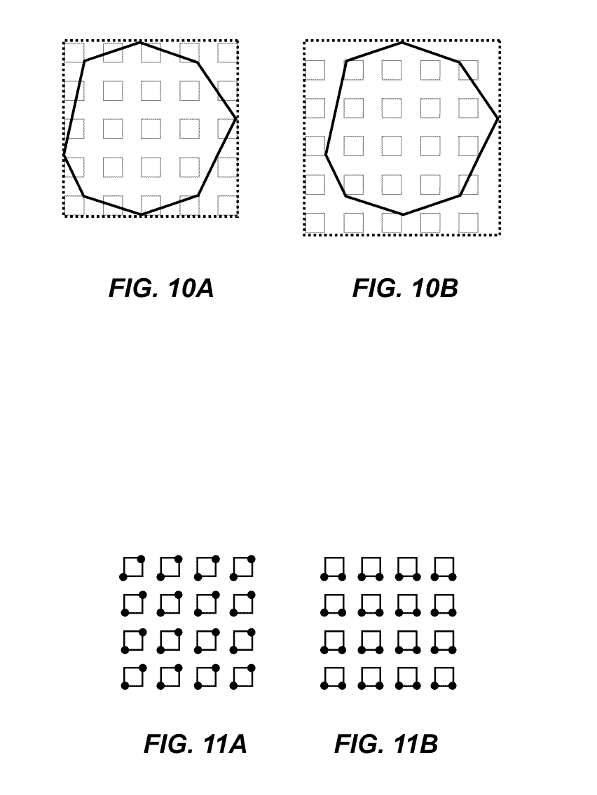

It may be useful to maximize the number of squares contained wholly in the ROI, by shifting the grid of squares. This can provided a greater chance of having more frequency-homogeneous squares. The border of the ROI usually have higher frequencies than the interior since the texture changes across the border. The maximization may prevent mixing the border and interior pixels in the same square, which is shown in FIGS. 10(a)-(b). FIGS. 10(a)-(b) are diagrams illustrating a general-shaped ROI for skipping strategies 1 and 2, which are discussed below. The bounding rectangles are dotted lines. The 2×2 squares are shown as 1×1 squares in grey. They all start from the bottom left corner. FIG. 10(a) illustrates the minimal bounding rectangle, with 9 enclosed squares. FIG. 10(b) illustrates an x-offset=−1 and a y-offset=−1 for the bounding rectangle to maximize the number of enclosed squares, which is now 13.

To this end, define the set T₀_{ₓ}, 0_{y} as:

Tₒ_{ₓ}_{, o}_{_{y}}={(iₓ,i_{y}): [symbol] aₓ−oₓ+ciₓ, a_{y}−o_{y}+ci_{y} [symbol] ⊂R, iₓ=0, 1, 2, . . . , i_{y}=0, 1, 2, . . . }, (79)

where [symbol] x,y [symbol] stands for the square of size c with (x, y) at the bottom-left corner. Here, c is 2 for Strategies 1 and 2, and is 4 for Strategy 3. Then choose the values of offsets oₓ and o_{y} between 0 and c−1 to make Tₒ_{_{x,oy}} have maximal cardinality.

Hence the bounding rectangle is translated by the negative of the offsets so that it starts at the corner (aₓ−oₓ, a_{y}−o_{y}), with squares marching from there.

Finding Local Spectra for all Pixels

To find the ST statistics of an ROI, the local spectrum at each pixel (iₓ, i_{y}) in the ROI need to be determined. As discussed above with regard to FIG. 7, first compute the compressed matrix at that pixel, Fᵢ_{_{x,jy}}, using (76:

Fᵢ_{_{x,iy}}=Bᵢ_{ₓ}HBᵢ_{_{y}}^{T}. (80)

(80) can be computed either using the left intermediate matrix product Lᵢ_{ₓ} (as discussed above with regard to FTFT-2D Pixel methods):

Lᵢ_{ₓ}=Bᵢ_{ₓ}H and Fᵢ_{_{x,iy}}=Lᵢ_{ₓ}Bᵢ_{_{y}}^{T}. (81) or using the right intermediate matrix product Rᵢ_{_{y}}:

Rᵢ_{_{y}}=HBᵢ_{_{y}}^{T} and F₁_{_{x, iy}}=Bᵢ_{ₓ}Rᵢ_{_{y}}. (82)

Let T₁ be the time to perform the first matrix multiplication in (81) or (82) to produce Lᵢ_{_{y}} or Rᵢ_{_{y}}, and T₂ be the time to perform the second matrix multiplication. Since H is P×P and the B's is M×P, with M less than P, T₁ is greater than T₂. This is verified in Tables 6 and 7 below.

Let prₓR={iₓ:(iₓ, i_{y})∈R} and pr_{y}R={i_{y}:(iₓ, i_{y})∈R} be the x- and y-projections of R. In most cases, prₓR=[aₓ, bₓ], and pr_{y}R=[a_{y}, b_{y}]. Let || denote set cardinality.

If (81) or (82) are executed individually for each pixel in R, the total time taken is |R|(T₁+T₂). There are faster ways to do that:

With (81), it is possible to find Lᵢ_{ₓ} for all iₓ in prₓR and store these values in memory. Then use them to find Fᵢ_{_{x,iy}} for all (iₓ, i_{y}) in R. Then the total time is only |prₓR|T₁+|R|T₂.

With (82), it is possible to find Rᵢ_{_{y}} for all i_{y} in pr_{y}R and store these values in memory. Then use them to find Fᵢ_{_{x,iy}} for all (iₓ, i_{y}) in R. Then the total time is only |pr_{y}R|T₁+|R|T₂.

The methods above are faster. So, choose (81) or (82) according as |prₓR| is less than or greater than |pr_{y}R|.

The first and second matrix multiplications for (81) are discussed above. Those for (82) are similar. Finally, as discussed above with regard to FTFT-2D Pixel methods, processes to obtain the local spectra for all the pixels in the ROI are disclosed.

Skipping Low Band or Low and Medium Bands

Since the ST values at Low or Medium Bands have low spatial resolution, it does not change much as we move from a pixel to the neighboring ones. Therefore, it is possible to skip computing them for a pixel if it has been done for an adjacent pixel. Skipping schemes are discussed in detail below.

The first step of getting the intermediate matrix product Lᵢ_{ₓ} or Rᵢ_{_{Y}} is done for all iₓ in prₓR or all i_{y} in pr_{y}R the usual way without any band skipping. This is because each i in the projection may correspond to some non-skipping pixel. Moreover, this first step takes very little time.

The second step of finding the final product can be made faster by skipping. Suppose that it is desirable to skip the Low Bands for a particular pixel, only finding the ST values there for Medium and High Bands. Then in the second step of (81), use the following modification:

Initialize those elements of Fᵢ_{ₓ}_{,i}_{_{y}} corresponding to the Medium or High
Band to 0
for each q_{y} from 0 to qₘₐₓ

for each Medium or High Band

if q_{y} is in the corresponding Medium or High Set, then

for each basis node m_{y} in that Band

1for each basis node mₓ in all the Medium and High
Bands

accumulate the product of L[mₓ,q_{y}] and

Bᵢ_{_{y}}[m_{y},q_{y}] into Fᵢ_{ₓ}_{,i}_{_{y}}[mₓ,m_{y}]

As compared to the algorithm for forming a compressed matrix discussed above, here it is possible to spare the time of accumulating for mx in the Low Bands. If (82) is used instead of (81), the method is similar. After the compressed matrix Fᵢ_{_{x,iy}} is found in this way, it can be used to generate the ST values using the interpolation and FT processes as discussed above. Now, since ST values are not needed for some Bands, it is possible to skip those parts of the processes for the unnecessary Bands.

To skip the Low and Medium Bands for a particular pixel, only find the ST values there for the High Band, then the process is similar.

Skipping Strategies

The example strategies focus on the examples of 256×256 images with one Low, one Medium and one High Band, where the ROI is a single region of standard or general shape. In particular, three Skipping Strategies to skip computing some ST values for adjacent pixels are provided.

To implement the skipping, computing and saving the ST values for those Bands at a pixel in memory can be performed, and then retrieving and copying them into the adjacent pixels instead of computing them again. This would cause headache in housekeeping the saved values and in releasing the memory for other data. Alternatively, a “pixel forest” structure is adopted so that where the forest is traversed by depth-first scheme, then the adjacent pixels can use the ST values for those Bands in the most recently traversed pixel. In this way, it is possible able to evade the housekeeping need.

For a neighborhood of pixels with similar ST values, the particular pixels skipped are not important. In the strategies, the pixels with smallest x and y coordinates in the neighborhoods are used as representatives. This would cause some bias in the representation, which should be fine.

Skipping Strategy 1

This strategy only has little skipping so it takes longest time but is most precise. It is suitable for ROI with complex and varying texture, such as the rectangular ROI 1700, which is shown in FIG. 17(a) below.

Here a forest of quad-trees is built with two levels, with occasional all-Band skipping. In graph theory, a forest means a set of disjoint trees. Here, at the top level, pixels are taken at every other x position and every other y position, i.e. belonging to the set:

{(aₓ−oₓ+2iₓ, a_{y}−o_{y}+2i_{y})∈R : iₓ=0, 1, 2, . . . , i_{y}=0, 1, 2, . . . },

where (aₓ, a_{y}) were defined in (77) and (oₓ, o_{y}) are those values that make |Tₒ_{_{x,oy}}| in (79) greatest. Each pixel (ix, i_{y}) at the top level has four children in the bottom level in diagonal order: (iₓ, i_{y}), (iₓ+1, i_{y}+1), (iₓ+1, i_{y}) and (iₓ, i_{y}+1), forming a 2×2 square.

The first two leaves of each tree are taken, corresponding to a pair of diagonally opposite pixels in the square, and their ST values are computed for all Bands.

Then the “upper-difference” is found, defined as the norm-1 (mean-absolute) difference between the ST values of these two pixels at each (kₓ, k_{y}) in the upper quadrant [N/4, N/2]×[N/4, N/2] of the 2-dimensional frequency index space. If this upper-difference is less than some threshold δ, then it is contended that the ST values are quite uniform over the square, so it is possible to skip computing All-Band ST values for the other two leaves in that tree. Otherwise, proceed to find the ST values for these leaves.

This kind of skipping will be called “Diagonal Skipping”. To reduce the time of finding the upper-difference, it is optionally possible to take (kₓ, k_{y}) at intervals of, for example, 6 for kₓ and for k_{y}. Then only 1/36 of the points in [N/4, N/2]×[N/4, N/2] are used.

The reason for arranging the four children diagonally can be seen in FIGS. 11(a)-(b), where skipping is performed for every square. The diagonal order provides uniformly spaced subsample of points (as black dots), while other orders give non-uniform subsamples. FIG. 11(a) illustrates subsampling of diagonally opposite vertices of the squares for 1 level, which provides for uniformly-spaced dots. FIG. 11(b) illustrates subsampling of opposite vertices of the squares for 1 level. Both FIGS. 11(a)-(b) illustrate the same subsampling ration of 2, but only FIG. 11(a) illustrates subsampling with uniformly-spaced dots.

Skipping Strategy 2

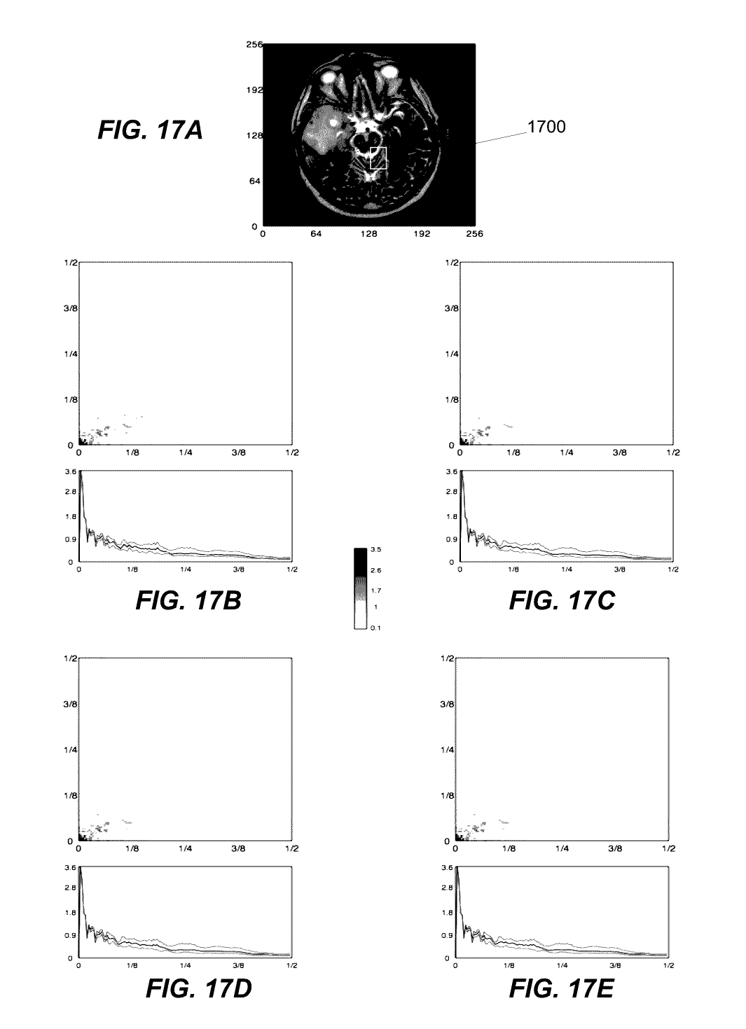

This strategy only finds the Low-Band ST values once for each 2×2 square, and performs occasional skipping for other Bands. So it is faster but slightly less precise than Strategy 1. It is suitable for ROI with fairly complex texture, somewhere between the textures of ROI's in FIGS. 16 and 17.

The forest in the same way as in Strategy 1, except that the diagonal order is not imposed. So, the children can be arranged in any order in the square, like: (iₓ, i_{y}), (iₓ, i_{y}+1), (iₓ+1, i_{y}) and (iₓ+1,+1).

It is possible to traverse each time starting from the root. When a node that corresponds to a pixel inside the ROI is reached that has not been computed before, compute its ST values in one of two ways: if that node is the first one dealt with in that tree, then find its ST values for all Bands; otherwise, only find its Medium- and High-Band ST values, as the Low-Band values are already in memory found for that first one.

Further skipping for the Medium and High Bands can be provided. For example, for the first node (pixel) computed in each tree, obtain the following two quantities:

^{H}

High-X-ST-magnitude=the mean of ST magnitudes over all (kₓ, k_{y}) in [ρ^{H}, N/2]×[0, N/2]; and

High-Y-ST-magnitude=the mean of ST magnitudes over all (kₓ, k_{y}) in [0, N/2]×[ρ^{H}, N/2].

Again to find these quantities more efficiently, it is possible to optionally take, for example, every 6th values of kₓ or k_{y}.

Now, if High-X-ST-magnitude is less than some threshold δ then the x-components of the high frequency ST values are quite small, implying that there is little change in texture along the x direction. So, it is possible to safely skip computing All-Band ST values for (iₓ+1, i_{y}) and (iₓ+1, i_{y}+1).

Similarly if High-Y-ST-magnitude is less than δ, it is possible to skip computing All-Band ST values for (iₓ, i_{y}+1) and (iₓ+1, i_{y}+1). And if both are less than δ, it is possible to not find ST values for the other pixels in the square.

This type of skipping is referred to as “Spectral Skipping”.

Skipping Strategy 3

This strategy only finds the Low-Band ST values once for each 4×4 square, and Medium-Band ST values once for each 2×2 square. It performs occasional skipping for other Bands. So it is faster but slightly less precise than the above strategies. It is suitable for ROI with fairly simple texture, such as the brain tumor example shown in FIG. 16.

Here a forest of quad-trees with three levels is built. At the top level, it is possible to take pixels at every fourth x position and every fourth y position, i.e. the set:

{(aₓ−oₓ+4iₓ, a_{y}−o_{y}+4i_{y})∈R: iₓ=0, 1, 2, . . . , i_{y}=0, 1, 2, . . . }.

Each node or pixel (iₓ, i_{y}) at the top level has four children in the middle level in any order, such as (iₓ, iₜ), (iₓ, i_{y}+2), (iₓ+2, i_{y}) and (iₓ+2, i_{y}+2). Each node (tₓ,j_{y}) in the middle level has four children in the bottom level: (tₓ,j_{y}), (tₓ,j_{y}+1), (tₓ+1, j_{y}) and (jₓ+1, j_{y}+1). So, each tree corresponds to a 4×4 square.

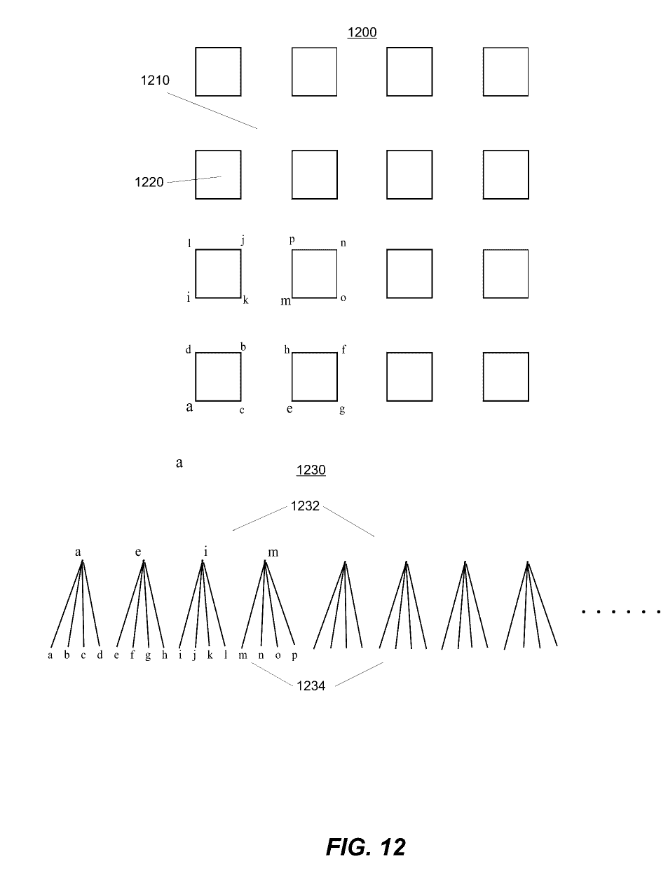

Referring now to FIG. 12, a diagram illustrating a hierarchical structure for this a skipping strategy (i.e., skipping strategy 3) is shown. For example, an 8×8 ROI 1200 divided into 4×4 squares (shown as 3×3 squares 1210), each of which is further divided into 2×2 squares (shown as 1×1 squares 1220) is shown. A forest 1230 having arcs 1232 corresponding to the 4×4 squares and arcs 234 corresponding to the 2×2 squares are also shown. It should be understood that only 2 of the 4 4×4 squares are shown in the forest 1230. It should also be understood that the vertices in the 2×2 squares can be traversed diagonally, which is necessary for the 1 level option but not necessary for options of 2 and 3 levels. Additionally, the top level consists of the large dots, the middle level consists of the large and middle-sized dots, and the bottom level consists of all the dots. The children of a large dot are the four vertices of the thick square containing that dot. The children of a middle-sized dot are the four vertices of the thin square containing that dot.

It is possible to traverse each time starting from the root by depth-first scheme. When a node that corresponds to a pixel inside the ROI is reached that has not been computed before, compute its ST values in one of three ways: if that node is the first one dealt with in that tree, then find its ST values for all Bands; otherwise if it is in the middle level, only find its Medium- and High-Band ST values, as the Low-Band values are already in memory found for that first one, otherwise it must be in the bottom level. Then only find its High-Band ST values, as the Low- and Medium-Band values are already in memory found for the previous ones. The memory holds the values for most recently visited node; thanks to the depth-first traversal, that node is the one to use as it is in the same square.

Like Skipping Strategy 2 above, it is possible to have Spectral Skipping for the Medium and/or High Bands: For the first node (pixel) computed in each tree, obtain four quantities: High-X-ST-magnitude and High-Y-ST-magnitude defined above, as well as two new ones:

Medium-X-ST-magnitude=the mean of ST magnitudes over all (kₓ, k_{y}) in [ρ^{M}, ν^{M}]×[0, N/2]; and

Medium-Y-ST-magnitude=the mean of ST magnitudes over all (kᵣ, k_{y}) in [0, N/2]×[ρ^{M},ν^{M}].

Likewise, it is possible to optionally find these quantities more efficiently. It is possible to optionally take, for example, every 3rd values of kₓ or k_{y} for [ρ^{M}, ν^{M}], and every 6th values of kₓ or k_{y} for [0, N/2].

Now, if High-X-ST-magnitude is less than some threshold ζ, then there is little change in texture along the x direction. So, it is possible to safely skip computing All-Band ST values for every second pixel in the x direction (i.e. pixels c, b, k, j; g, f, o, n in FIG. 12). If, furthermore, Medium-X-ST-magnitude is also less than ζ, then the texture change along x is even smaller, so it is possible to also skip the other pixels in x (i.e. also pixels e, h, m, p in FIG. 12).

Similarly for the y direction, and for the case when these quantities in both directions are small.

Automatic Selection of Skipping Strategy

The default Skipping Strategy for medical images can be Skipping Strategy 3, for example, assuming that the ROI for a pathology is quite large, like the interior of a tumor. On some occasions, when a small ROI (e.g. a tiny lesion), or thin (e.g. the ROI is the border around a tumor), the little or no skipping should be performed.

While the users are allowed to manually choose the skipping strategy, the FTFT-2D methods are capable to doing this for them, based on the size and breadth of the ROI. It first computes the number A of pixels in the ROI, and its average x- and y-breadths defined by: Lₓ=|R|/(b_{y}−a_{y}) and L_{y}=|R|(bₓ−aₓ), using the values found in (77) and (78).

If |R| is less than some threshold, for example, 150, or if Lₓ or L_{y} is less than some threshold, for example, 5, then, using Skipping Strategy 1 can be suggested. Else, if |R| is less than, for example, 600, or if Lₓ or L_{y} is less than, for example, 10, then using Skipping Strategy 2 can be suggested. It should be understood that the above criteria upon which suggestions are based are only provided as examples, and that other values can be used.

Optionally, it is possible to look at x- and y-breadths separately. For instance, an ROI is a thin strip parallel to the y-axis, then it may have fewer levels along the x-direction than along the y-direction. But this case is quite rare and may require more complicated logic.

Weighting of cells

As discussed above, it may be desirable to determine the ST statistics for a given ROI, primarily the mean and SD of ST magnitudes over all pixels in the ROI. If there is no skipping, it is possible to use the standard formulae to calculate them. These formulae work well even when computing the Low- or Medium-Band ST values are skipped for some nodes in Skipping Strategy 2 or 3, because these values have been computed previously and it is possible to simply take them from memory.

But there is an issue for Diagonal Skipping in Skipping Strategy 1 (where pixels are skipped in a 2×2 square if the first two diagonally opposite pixels are similar in ST) and for Spectral Skipping in Strategies 2 and 3 (where pixels in a square are skipped if the first pixel computed in that square has small high-frequency ST values). In these kinds of skipping, there is no copying from memory and special weights are used to ensure correct statistics.

Let C be the set of “computed pixels”, i.e. pixels in the ROI whose ST values have been found by computing and perhaps retrieving from memory. For each pixel (iₓ, i_{y}) in C, count the total number n(iₓ, i_{y}) of pixels (in the pixel's square and in ROI) represented by it. n(iₓ, i_{y}) is actually the number of skipped pixels plus one.

Then, the mean and variance of ST of the ROI at frequency index (kᵣ, k_{y}) are given by:

$$\begin{matrix} \overline{S} [ {n}_{x} , {n}_{y} , {k}_{x} , {k}_{y} ] = \frac{{\sum }_{( {i}_{x} , {i}_{y} ) ∈ C} S [ {i}_{x} , {i}_{y} , {k}_{x} , {k}_{y} ] n ( {i}_{x} , {i}_{y} )}{{\sum }_{( {i}_{x} , {i}_{y} ) ∈ C} n ( {i}_{x} , {i}_{y} )} , and & ( 83 ) \\ {σ}_{S}^{2} [ {n}_{x} , {n}_{y} , {k}_{x} , {k}_{y} ] = \frac{{\sum }_{( {i}_{x} , {i}_{y} ) ∈ C} {S [ {i}_{x} , {i}_{y} , {k}_{x} , {k}_{y} ]}^{2} \sqrt{n ( {i}_{x} , {i}_{y} )}}{{\sum }_{( {i}_{x} , {i}_{y} ) ∈ C} \sqrt{n ( {i}_{x} , {i}_{y} )}} - {( \frac{{\sum }_{( {i}_{x} , {i}_{y} ) ∈ C} S [ {i}_{x} , {i}_{y} , {k}_{x} , {k}_{y} ] \sqrt{n ( {i}_{x} , {i}_{y} )}}{{\sum }_{( {i}_{x} , {i}_{y} ) ∈ C} \sqrt{n ( {i}_{x} , {i}_{y} )}} )}^{2} . & ( 84 )\end{matrix}$$

The weights in (83) are simply the count n(iₓ, iₜ). Note that the denominators in (83) should be the total number of pixels in the ROI.

The count should not simply be used as the weights in (84), as this would pertain to the assumption that the skipped pixels take the same ST values as the representative. This would make the SD smaller than it should be. Actually there is some slight variation over those pixels. From experiments, it has been discovered that using the square-root of count as weight gives a more realistic result, closer to the one obtained without any skipping.

Pseudo-code of Finding ROI Statistics

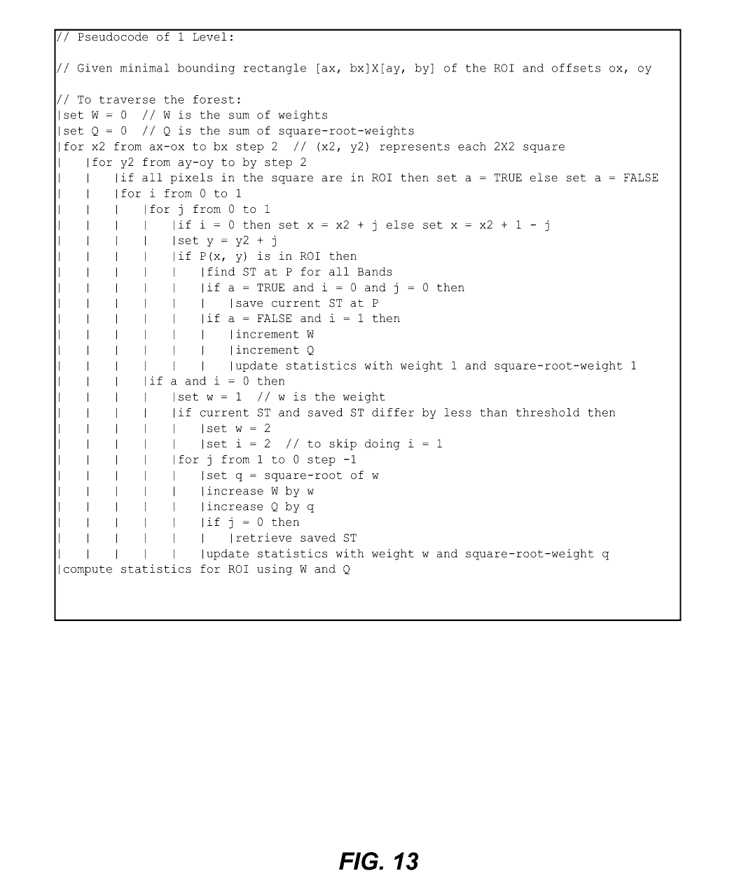

The computer implementation if the pixel forest structure with node traversing, skipping, weighting and statistics updating is quite complicated. FIGS. 13-15 illustrate the pseudo-codes of doing it. Note that the program logic is efficient with small memory requirement.

FIG. 13 illustrates pseudo-code for finding ROI statistics for 1 level. It is assumed that: (1) the basis has been prepared at the start of launching the tool, (2) the preprocessing of the given image has been performed after the image is input, (3) intermediate products for the ROI have been computed, and (4) minimal bounding rectangle and offsets have been determined.

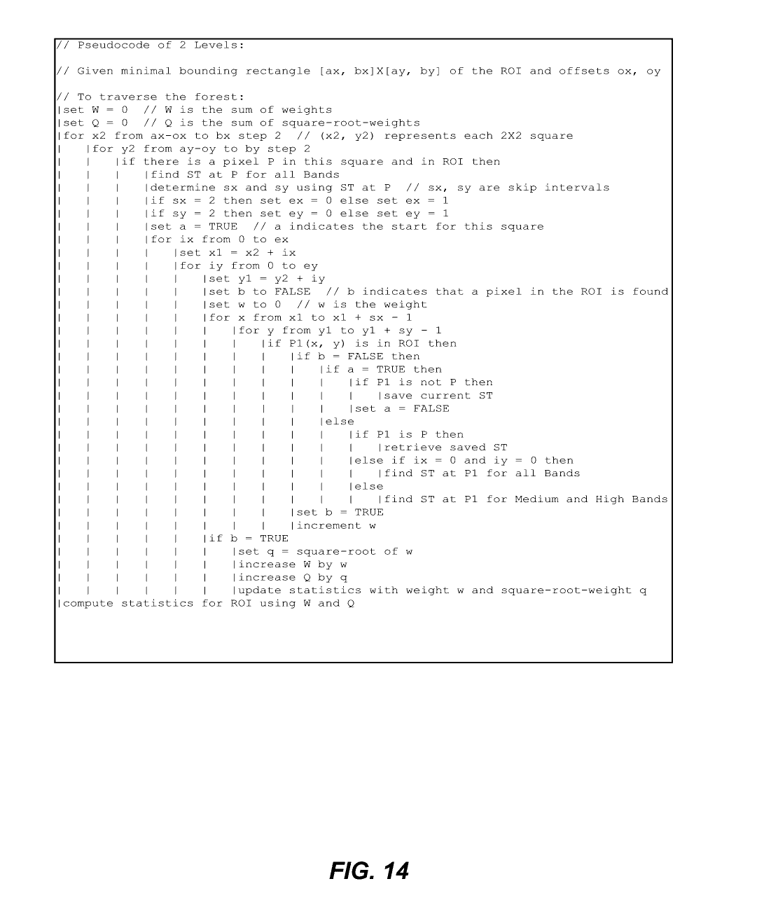

FIG. 14 illustrates pseudo-code for finding ROI statistics for 2 levels. It is assumed that: (1) the basis has been prepared at the start of launching the tool, (2) the preprocessing of the given image has been performed after the image is input, (3) intermediate products for the ROI have been computed, and (4) minimal bounding rectangle and offsets have been determined.

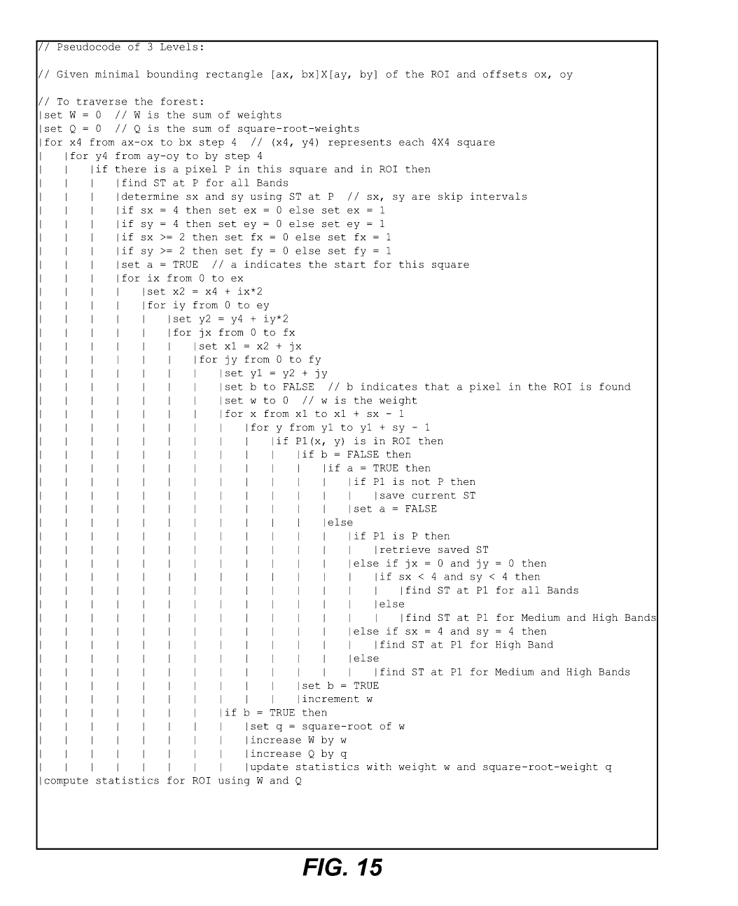

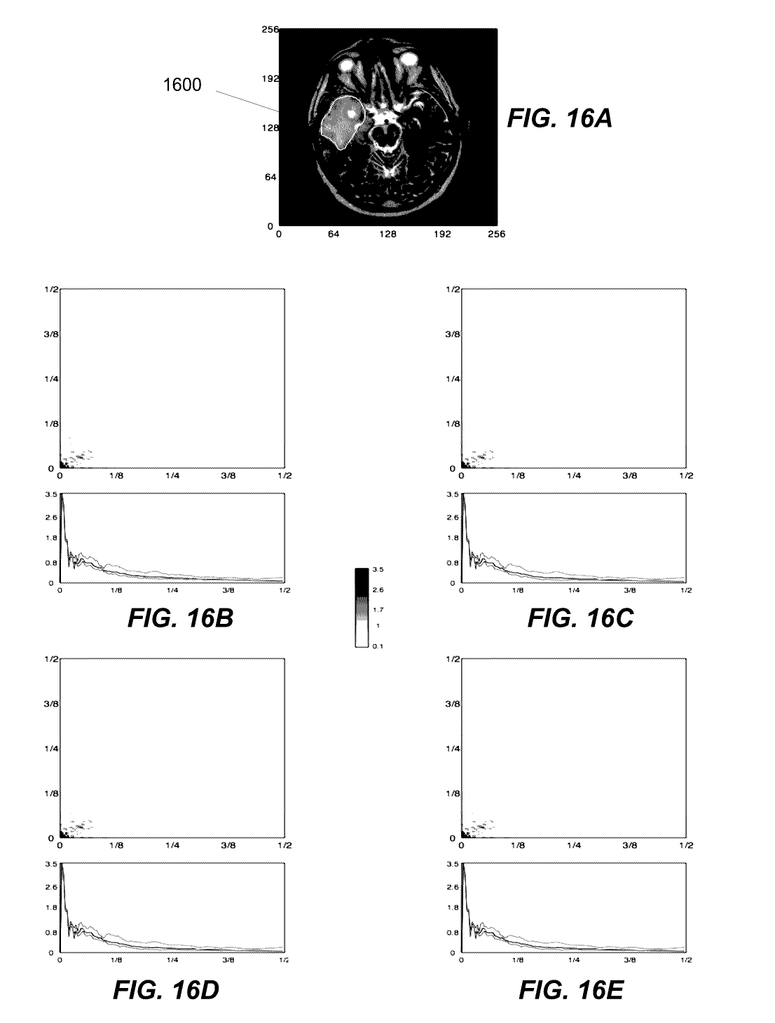

FIG. 15 illustrates pseudo-code for finding ROI statistics for 3 levels. It is assumed that: (1) the basis has been prepared at the start of launching the tool, (2) the preprocessing of the given image has been performed after the image is input, (3) intermediate products for the ROI have been computed, and (4) minimal bounding rectangle and offsets have been determined.

Experiments on Regions of Interest

Referring now to FIGS. 16 and 17, experimental results comparing exact ST and FTFT-2D ROI methods are shown. The same diseased brain MRI for is used for the two experiments, one with a large tumor ROI 1600 (occupying 2410 pixels) shown in FIG. 16 and one with a rectangular ROI 1700 having complex textures shown in FIG. 17.

The default values for the diagonal-difference threshold δ in Skipping Strategy 1 is set to be 0.05. The default values for the spectral thresholds and in Strategies 2 and 3 are 0.2 and 0.4 respectively.

In FIG. 16 for the tumor ROI, the parameter setting in Table 4 above is used, as well as for different Skipping Strategies. The same applies in FIG. 17 for the rectangular ROI. They are compared to the true ST results by the original formula.

FIG. 16(a) illustrates a 256×256 MRI image of a diseased brain, with an ROI 1600 drawn. FIG. 16(b) Top is a graph of Average local spectrum of the ROI obtained by the exact ST frequency-domain formula. FIG. 16(b) Bottom is a graph of Mean texture curve with radial statistics obtained by the exact ST frequency-domain formula. FIG. 16(c)-(e) Top are graphs of Mean local spectrum of the ROI obtained by FTFT-2D ROI with 1 level, 2 levels and 3 levels, respectively. FIG. 16(c)-(e) Bottom are graphs of Mean texture curve with radial statistics obtained by FTFT-2D ROI with 1 level, 2 levels and 3 levels, respectively.

FIG. 17(a) illustrates a 256×256 MRI image of a diseased brain, with an ROI 1700 drawn. FIG. 17(b) Top is a graph of Average local spectrum of the ROI obtained by the exact ST frequency-domain formula. FIG. 17(b) Bottom is a graph of Mean texture curve with radial statistics obtained by the exact ST frequency-domain formula. FIG. 17(c)-(e) Top are graphs of Mean local spectrum of the ROI obtained by FTFT-2D ROI with 1 level, 2 levels and 3 levels, respectively. FIG. 17(c)-(e) Bottom are graphs of Mean texture curve with radial statistics obtained by FTFT-2D ROI with 1 level, 2 levels and 3 levels, respectively.

In the mean texture curves of FIGS. 16(b)-(e) Bottom and 17(b)-(e) Bottom, the radial frequency is on the horizontal axis and radial ST magnitude on the vertical axis. The middle black graph is on the mean. The lower and upper left gray graphs are on mean SD and mean+SD respectively. The lower and upper dark gray graphs are on minimum and maximum SD values respectively.

The respective process times are listed in Table 6 below, which also includes the time for computing the whole image, treating it as the ROI.

Better than 99% overall accuracy is obtained, with about 440-fold and 240-fold speedup for the tumor (i.e., FIG. 16) and rectangular (i.e., FIG. 17) cases, respectively. Additionally, greater efficiency for the tumor as the texture inside is quite homogeneous, and the Spectral Skipping comes into play.

Skipping Strategies 1 and 2 produce more accurate results but take longer time to run, but it is really hard to see any difference in accuracies among the three strategies. The speed increases from Strategy 1 to 2 and from Strategy 2 to 3 are more remarkable.

It is observed that the SD found by FTFT-2D using the weighting method discussed above agree well with the true values, confirming that the square-root weighting reflects the distribution well. But the maximum ST over all pixels in the ROI is slightly underestimated by the skipping techniques, which is due to having missed/skipped some pixels.

TABLE 6

| Setting | Large brain tumor | Complex-textured rectangle | Whole Image |
|---|---|---|---|
| Exact | 851 | 218 | 23073 |
| 1 level | 12.29 | 3.375 | 309.56 |
| 2 levels | 6.22 | 1.761 | 177.18 |
| 3 levels | 1.92 | 0.904 | 50.56 |

(All times are in seconds)

Conclusion FTFT-2D ROI

As discussed above, a fast and accurate technique to calculate ST statistics of an ROI is provided. The method is also robust, adaptive, and uses little memory, and especially useful for large ROI's.

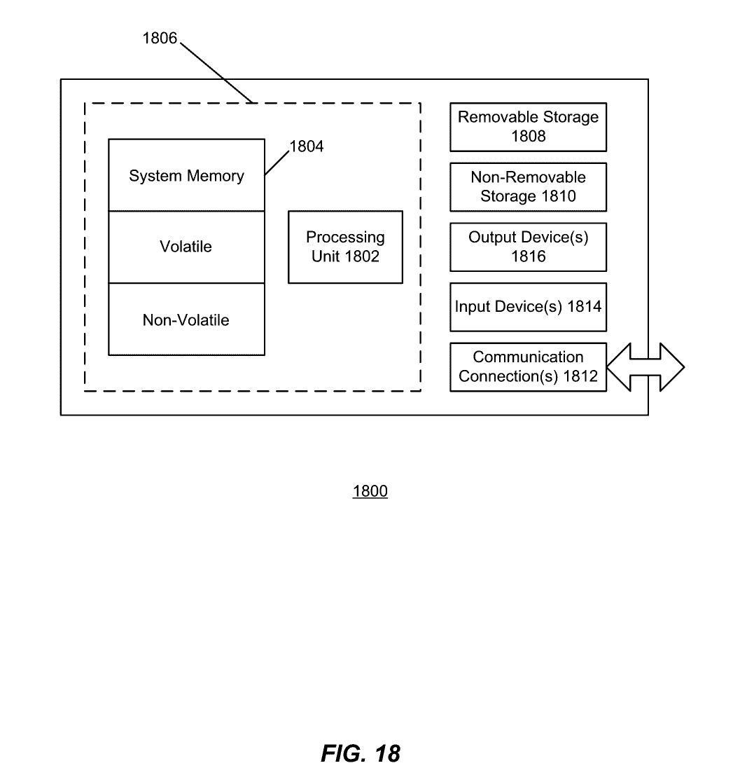

FIG. 18 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

In some implementations, the techniques disclosed herein may be applied to more efficiently process images and determine features from the images that are used for generating or evaluating models. In some implementations, image features derived according to the image processing procedures discussed herein may be used to determine particular pixels or regions of interest (e.g., a voxel) of an image that exhibit a particular condition. A computing system may evaluate multiple pixels or regions of interest of an image and select particular ones of the pixels or regions of interest that are determined to exhibit the particular condition, to the exclusion of pixels or regions of interest that are determined not to exhibit the particular condition. The selected pixels or regions of interest may then be highlighted, colorized, or otherwise emphasized in a modified image, to facilitate visualization of portions of a subject shown in the image represented by the pixels or regions of interest that exhibit the particular condition. These techniques may aid the ability of radiologists, for example, to identify and visualize areas of medical images that exhibit particular conditions, which would not be discernible with the naked eye.

With reference to FIG. 18, an exemplary system for implementing aspects described herein includes an image processing device, such as computing device 1800. In its most basic configuration, computing device 1800 typically includes at least one processing unit 1802 and memory 1804. Depending on the exact configuration and type of computing device, memory 1804 may be volatile (such as random access memory (RAM)), non-volatile (such as read-only memory (ROM), flash memory, etc.), or some combination of the two. This most basic configuration is illustrated in FIG. 18 by dashed line 1806.

Computing device 1800 may have additional features/functionality. For example, computing device 1800 may include additional storage (removable and/or non-removable) including, but not limited to, magnetic or optical disks or tape. Such additional storage is illustrated in FIG. 18 by removable storage 1808 and non-removable storage 1810.

Computing device 1800 typically includes a variety of computer readable media. Computer readable media can be any available media that can be accessed by device 1800 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1804, removable storage 1808, and non-removable storage 1810 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1800. Any such computer storage media may be part of computing device 1800.

Computing device 1800 may contain communications connection(s) 1812 that allow the device to communicate with other devices. Computing device 1800 may also have input device(s) 1814 such as a keyboard, mouse, pen, voice input device, touch input device, etc. Output device(s) 1816 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1-78. (canceled)

79. A computer-implemented method, comprising:
obtaining, by a system of one or more computers, a first digital image;
determining, by the system, values for a set of features of the first digital image;
generating, by the system, a sample of training data that associates the determined values for the set of features in the first digital image with an observed condition of a subject of the first digital image;
determining, by the system and based on the sample of training data and other samples of training data, a model that is configured to estimate a condition of a subject of a digital image; and
using the model to estimate a condition of a subject of a second digital image that is different from the first digital image.

80. The computer-implemented method of claim 79, wherein determining the values for the set of features of the first digital image comprises:
setting primary parameters;
setting a data size N;
determining basis values for the data size N;
inputting a time series of data size N;
determining a set of prominent frequency indexes;
expanding and accumulating the basis values for pure complex sinusoids (PCS) with frequencies in the set of prominent frequency indexes to form compressed ST values, using the primary parameters;
decompressing accumulated basis values for a high set; and

81. The computer-implemented method of claim 79, wherein determining the values for the set of features of the first digital image comprises:
setting parameters;
determining a low band, a medium band, and a high band of frequency components of the first digital image;
preparing basis values for each of the low band, the medium band, and the high band;
determining a two-dimensional Fourier Transform (FT) of the image as a matrix H;
receiving an input coordinate of a pixel in the first digital image; and
determining S-transform (ST) magnitudes at the input coordinate of the pixel using the matrix H and the basis values.

82. The computer-implemented method of claim 79, wherein determining the values for the set of features of the first digital image comprises:
setting parameters;
determining a low band, a medium band, and a high band of frequency components of the first digital image;
preparing basis values for each of the low band, the medium band and the high band;
determining a two-dimensional Fourier Transform (FT) of the image as a matrix H;
receiving an indication of the region of interest (ROI); and
determining the S-transform (ST) magnitudes and the statistics in the ROI using the matrix H and the basis values.

83. A computer-implemented method, comprising:
obtaining, by a system of one or more computers, a first digital image;
determining, by the system, values for a set of features of the first digital image;
providing, by the system, the determined values for the set of features of the first digital image to estimate a condition of a subject shown in the image; and
presenting, by the system, an indication of the estimated condition of the subject shown in the image.

84. The computer-implemented method of claim 83, wherein determining the values for the set of features of the first digital image comprises:
setting primary parameters;
setting a data size N;
determining basis values for the data size N;
inputting a time series of data size N;
determining a set of prominent frequency indexes;
expanding and accumulating the basis values for pure complex sinusoids (PCS) with frequencies in the set of prominent frequency indexes to form compressed ST values, using the primary parameters;
decompressing accumulated basis values for a high set; and
copying the ST values for a low set.

85. The computer-implemented method of claim 83, wherein determining the values for the set of features of the first digital image comprises:
setting parameters;
determining a low band, a medium band, and a high band of frequency components of the first digital image;
preparing basis values for each of the low band, the medium band, and the high band;
determining a two-dimensional Fourier Transform (FT) of the image as a matrix H;
receiving an input coordinate of a pixel in the first digital image; and
determining S-transform (ST) magnitudes at the input coordinate of the pixel using the matrix H and the basis values.

86. The computer-implemented method of claim 83, wherein determining the values for the set of features of the first digital image comprises:
setting parameters;
determining a low band, a medium band, and a high band of frequency components of the first digital image;
preparing basis values for each of the low band, the medium band and the high band;
determining a two-dimensional Fourier Transform (FT) of the image as a matrix H;
receiving an indication of the region of interest (ROI); and
determining the S-transform (ST) magnitudes and the statistics in the ROI using the matrix H and the basis values.

87. A computer-implemented method, comprising:
displaying, on a terminal of a computing system, a first digital image;
receiving, by the system, a selection of a pixel or a region of interest (ROI) in the first digital image;
determining, by the system, one or more values that characterize the selected pixel or ROI; and
providing, by the system, an indication of the determined values that characterize the selected pixel or ROI.

88. The computer-implemented method of claim 87, wherein determining the one or more values that characterize the selected pixel or ROI comprises:
setting primary parameters;
setting a data size N;
determining basis values for the data size N;
inputting a time series of data size N;
determining a set of prominent frequency indexes;
expanding and accumulating the basis values for pure complex sinusoids (PCS) with frequencies in the set of prominent frequency indexes to form compressed ST values, using the primary parameters;
decompressing accumulated basis values for a high set; and
copying the ST values for a low set.

89. The computer-implemented method of claim 87, wherein determining the one or more values that characterize the selected pixel or ROI comprises:
setting parameters;
determining a low band, a medium band, and a high band of frequency components of the first digital image;
preparing basis values for each of the low band, the medium band, and the high band;
determining a two-dimensional Fourier Transform (FT) of the image as a matrix H;
receiving an input coordinate of a pixel in the first digital image; and
determining S-transform (ST) magnitudes at the input coordinate of the pixel using the matrix H and the basis values.

90. The computer-implemented method of claim 87, wherein determining the one or more values that characterize the selected pixel or ROI comprises:
setting parameters;
determining a low band, a medium band, and a high band of frequency components of the first digital image;
preparing basis values for each of the low band, the medium band and the high band;
determining a two-dimensional Fourier Transform (FT) of the image as a matrix H;
receiving an indication of the region of interest (ROI); and
determining the S-transform (ST) magnitudes and the statistics in the ROI using the matrix H and the basis values.
